(19) United States
(12) Patent Application Publication
(10) Pub. No.: US 2020/0340881 A1
(43) Pub. Date: Oct. 29, 2020

(54) GAS LEAK DETECTION DEVICE, WORKPIECE INSPECTION DEVICE AND LEAK INSPECTION METHOD

(71) Applicant: YAMAHA FINE TECHNOLOGIES CO., LTD., Hamamatsu-shi (JP)

(72) Inventor: Atsuo HATTORI, Iwata-shi (JP)

(21) Appl. No.: 16/923,285

(22) Filed: Jul. 8, 2020

Related U.S. Application Data
(63) Continuation of application No. PCT/JP2018/048347, filed on Dec. 27, 2018.

(30) Foreign Application Priority Data
Jan. 11, 2018 (JP) 2018-002539
Jan. 11, 2018 (JP) 2018-002540

(51) Int. Cl. G01M 3/20

(52) U.S. Cl. CPC G01M 3/20

(57) ABSTRACT

A workpiece inspection device includes an inspection chamber that is filled with an inspection gas different from atmospheric air and accommodates a workpiece, an inspection unit that inspects the workpiece accommodated in the inspection chamber, and a gas leak suppression structure that suppresses a leak of the inspection gas in the inspection chamber that occurs when the workpiece is inserted into and removed from the inspection chamber.

### CROSS-REFERENCE TO RELATED APPLICATIONS

The present application is a continuation application of International Application No. PCT/JP2018/048347, filed Dec. 27, 2018, which claims priority to Japanese Patent Application No. 2018-002539, filed Jan. 11, 2018, and Japanese Patent Application No. 2018-002540, filed Jan. 11, 2018. The contents of these applications are incorporated herein by reference.

### BACKGROUND OF THE INVENTION

### Field of the Invention

The present invention relates to a gas leak detection device, a workpiece inspection device, and a leak inspection method.

### Description of Related Art

A leakage detection device that detects a gas leak from a detection target object is disclosed in, for example, Published Japanese Translation No. 2004-527743 of the PCT International Publication. The detection target object is, for example, an object in which air (gas) is accommodated like a food container or a tire used for a vehicle. In the case of the leakage detection device, an accommodating object is filled with a tracer gas and a sensor is brought close to the accommodating object such that the sensor detects the tracer gas. A gas leak in the detection target object is detected based on the concentration of the tracer gas detected by the sensor at this time.

### SUMMARY OF THE INVENTION

In the leakage detection device described in Published Japanese Translation No. 2004-527743, a gas leak from the accommodating object is detected with the sensor moving along an outer surface of the detection target object filled with the tracer gas. The tracer gas discharged from the detection target object mixes with the atmospheric air when the tracer gas is released to the outside of the detection target object. As a result, the concentration of the tracer gas is lowered. Therefore, there is a problem that the sensitivity is low even when the concentration of the tracer gas is to be measured by the sensor.

An example of an object of the present invention is to provide a gas leak detection device with which it is possible to increase the sensitivity when a gas leak from a detection target object is to be detected.

According to a first aspect of the present invention, a gas leak detection device includes a chamber that accommodates a detection target object and in which a gas is introduced into a space between the detection target object and the chamber and a gas sensor device that is disposed inside the detection target object and detects the gas.

According to a second aspect of the present invention, a workpiece inspection device includes an inspection chamber that is filled with an inspection gas different from atmospheric air and accommodates a workpiece, an inspection unit that inspects the workpiece accommodated in the inspection chamber, and a gas leak suppression structure that suppresses a leak of the inspection gas in the inspection chamber that occurs when the workpiece is inserted into and removed from the inspection chamber.

According to a third aspect of the present invention, a leak inspection method of inspecting the gas leak detection device described above by means of the workpiece inspection device described above, the method includes disposing the gas leak detection device in the inspection chamber and inspecting the gas leak detection device disposed in the inspection chamber by means of the inspection unit.

With the gas leak detection device according to the aspect of the present invention, it is possible to increase the sensitivity when a gas leak from a detection target object is to be detected.

With the workpiece inspection device according to the aspect of the present invention, it is possible to achieve an increase in workpiece inspection speed, an increase in workpiece inspection sensitivity, and a decrease in workpiece inspection cost.

### BRIEF DESCRIPTION OF THE DRAWINGS

FIG. 1 is a side sectional view of a gas leak detection device according to Embodiment A1.

FIG. 2A is a side sectional view of a gas leak detection device according to Embodiment A2.

FIG. 2B is a side sectional view of the gas leak detection device according to Embodiment A2.

FIG. 3A is a plan sectional view of a gas leak detection device according to Embodiment A3.

FIG. 3B is a plan sectional view of the gas leak detection device according to Embodiment A3.

FIG. 4A is a side sectional view of a gas leak detection device according to Embodiment A4.

FIG. 4B is a side sectional view of the gas leak detection device according to Embodiment A4.

FIG. 4C is a sectional view of the gas leak detection device taken along the line C-C in FIG. 4B.

FIG. 5A is a side sectional view of a gas leak detection device according to Embodiment A5.

FIG. 5B is a side sectional view of the gas leak detection device according to Embodiment A5.

FIG. 6A is a side sectional view of a gas leak detection device according to Embodiment A6.

FIG. 6B is a side sectional view of the gas leak detection device according to Embodiment A6.

FIG. 7A is a side sectional view of a gas leak detection device according to Embodiment A7.

FIG. 7B is a side sectional view of the gas leak detection device according to Embodiment A7.

FIG. 8 is a longitudinal sectional view showing a workpiece inspection device according to Embodiment B1 of the present invention.

FIG. 9 is a plan view of a workpiece in FIG. 8 as seen in an axial direction thereof

FIG. 10 is a longitudinal sectional view showing an inspection unit attached to the workpiece in FIGS. 8 and 9.

FIG. 11 is a longitudinal sectional view showing one step in a workpiece inspection method in the workpiece inspection device in FIG. 1.

FIG. 12 is a longitudinal sectional view showing one step in the workpiece inspection method subsequent to FIG. 11.

FIG. 13 is a longitudinal sectional view showing one step in the workpiece inspection method subsequent to FIG. 12.

FIG. 14 is a longitudinal sectional view showing one step in the workpiece inspection method subsequent to FIG. 13.

FIG. 15 is a longitudinal sectional view showing one step in the workpiece inspection method subsequent to FIG. 14.

FIG. 16 is a longitudinal sectional view showing one step in the workpiece inspection method subsequent to FIG. 15.

FIG. 17 is a longitudinal sectional view showing a workpiece inspection device according to Embodiment B2 of the present invention.

FIG. 18 is a cross sectional view showing the workpiece inspection device according to Embodiment B2 of the present invention.

FIG. 19 is a cross sectional view showing a process in which a workpiece passes through an opening of a preparation chamber in the workpiece inspection device in FIGS. 17 and 18.

FIG. 20 is a longitudinal sectional view showing a portion of the process in which the workpiece passes through the opening of the preparation chamber in the workpiece inspection device in FIGS. 17 and 18.

FIG. 21 is a sectional view showing a process in which a workpiece passes through an entrance of an inspection chamber in a workpiece inspection device according to Embodiment B3 of the present invention.

FIG. 22 is a sectional view showing a workpiece inspection device according to Embodiment B4 of the present invention.

FIG. 23 is a sectional view showing one step in a workpiece inspection method in the workpiece inspection device in FIG. 22.

FIG. 24 is a longitudinal sectional view showing one step in the workpiece inspection method subsequent to FIG. 23.

FIG. 25 is a sectional view showing a workpiece inspection device according to Embodiment B5 of the present invention.

FIG. 26 is a sectional view showing a workpiece inspection device according to Embodiment B6 of the present invention.

FIG. 27 is a sectional view showing a workpiece inspection device according to Embodiment B7 of the present invention.

FIG. 28 is a sectional view showing one step in a workpiece inspection method in the workpiece inspection device in FIG. 27.

FIG. 29 is a longitudinal sectional view showing one step of an operation subsequent to FIG. 28.

FIG. 30 is a sectional view showing a workpiece inspection device according to Embodiment B8 of the present invention.

FIG. 31 is a sectional view showing a workpiece inspection device according to Embodiment B9 of the present invention.

### EMBODIMENTS FOR CARRYING OUT THE INVENTION

Hereinafter, gas leak detection devices according to some embodiments of the present invention will be described. In each of the following embodiments, an example of a case where a specific gas (tracer gas) as a detection target is a mixed gas containing hydrogen will be described. The tracer gas as the detection target may be a gas other than the mixed gas containing hydrogen. In addition, in each of the embodiments, common elements, members, and the like are given the same reference numerals and description thereof may be omitted or simplified.

### Embodiment A1

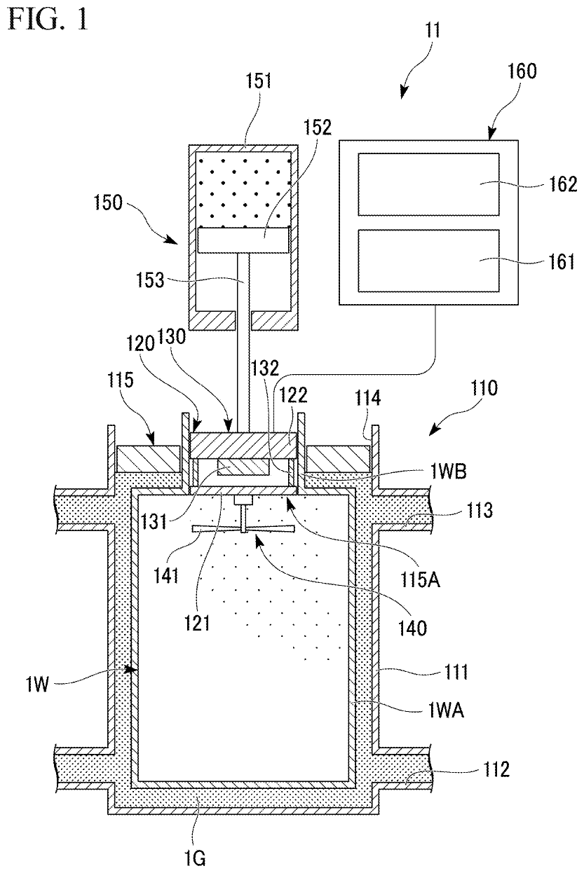

Embodiment A1 of the present invention will be described. FIG. 1 is a side sectional view of a gas leak detection device according to Embodiment A1. As shown in FIG. 1, a gas leak detection device 11 according to the present embodiment is provided with a chamber 110, a lid member 120, a gas sensor device 130, a circulation device 140, a drive device 150, and a control device 160. The gas leak detection device 11 detects a gas leak into a workpiece and is used in inspection for treating a workpiece into which a gas has leaked as a defective product. As shown in FIG. 1, a workpiece 1W, which is a detection target in the present embodiment, is provided with a substantially columnar workpiece main body portion 1WA, and a cap attachment portion 1WB provided at an upper end of the workpiece main body portion 1WA.

The chamber 110 is provided with an accommodation portion 111. A plurality of intake ports 112 are provided in a lower portion of the accommodation portion 111. A plurality of exhaust ports 113 are provided in an upper portion of the accommodation portion 111. A workpiece introduction port 114 is formed in an upper end of the chamber 110. A closing member 115 is attached to the workpiece introduction port 114. The chamber 110 is formed of, for example, metal or resin. Therefore, the chamber 110 has a certain shape.

The accommodation portion 111 can accommodate the workpiece 1W, which is an accommodated object. In the present embodiment, for example, as shown in FIG. 1, the workpiece 1W is a container that accommodates a beverage. The internal shape of the accommodation portion 111 is slightly larger than the workpiece 1W.

In the present embodiment, both of the workpiece main body portion 1WA and the accommodation portion 111 have columnar shapes. The workpiece main body portion 1WA and the accommodation portion 111 may have other pillar-like shapes such as a prism-like shape or an oval cylinder-like shape. The workpiece main body portion 1WA and the accommodation portion 111 may have shapes other than pillar-like shapes, for example, a spherical shape or a quadrangular shape. The workpiece main body portion 1WA and the accommodation portion 111 may have different shapes. For example, the workpiece main body portion 1WA may have a columnar shape, and the accommodation portion 111 may have a prism-like shape. A constant distance may be maintained between the workpiece main body portion 1WA and the accommodation portion 111 by means of a spacer (not shown) or the like.

An upper opening 115A is formed in the central position of the closing member 115 in plan view. The cap attachment portion 1WB is fitted into the upper opening 115A. A sealing member is provided between an outer surface of the closing member 115 and an inner surface of the accommodation portion 111. In addition, a sealing member is provided between an inner surface of the upper opening 115A of the closing member 115 and an outer surface of the cap attachment portion 1WB. The sealing members are, for example, O-rings. Therefore, at the workpiece introduction port 114 in the accommodation portion 111, a space between the inside and the outside of the accommodation portion 111 is made airtight by means of the closing member 115.

A tracer gas 1G is introduced into the accommodation portion 111 via the intake ports 112. The accommodation portion 111 of the chamber 110 is filled with the tracer gas 1G introduced via the intake ports 112. The tracer gas 1G introduced into the accommodation portion 111 is discharged via the exhaust ports 113. A pipe is connected to each of the intake ports 112 and the exhaust ports 113. Each pipe is provided with a valve. When the valves provided in the pipes connected to the intake ports 112 are opened, the tracer gas 1G is introduced into the accommodation portion 111. When the valves provided in the pipes connected to the exhaust ports 113 are opened, a gas in the accommodation portion 111 is discharged to the outside of the accommodation portion 111.

When the workpiece 1W is accommodated in the accommodation portion 111, the tracer gas 1G introduced via the intake ports 112 is introduced into a space between the accommodation portion 111 and the workpiece 1W. At this time, the tracer gas 1G flows into the inside of the workpiece 1W also in a case where there is a hole or the like in the workpiece 1W and a gas leak occurs. As the tracer gas 1G, a mixed gas of 5% hydrogen and 95% nitrogen can be used. The concentration of the hydrogen is not limited to 5% and may be low to such an extent that the mixed gas becomes not flammable. A dilution gas is not limited to nitrogen and may be an easily available gas such as air.

The lid member 120 is provided with a first lid portion 121 and a second lid portion 122. The first lid portion 121 and second lid portion 122 are stacked on each other. That is, the lid member 120 has a two-layer structure including the first lid portion 121 and second lid portion 122. The first lid portion 121 is disposed below the second lid portion 122. The circulation device (circulation unit) 140 is attached to a lower surface of the first lid portion 121. The first lid portion 121 supports the circulation device 140. The gas sensor device 130 is attached to a lower surface of the second lid portion 122. The second lid portion 122 supports the gas sensor device 130.

The first lid portion 121 and the second lid portion 122 have a disk shape in plan view. The shapes of the first lid portion 121 and the second lid portion 122 in plan view are substantially the same as an opening in the cap attachment portion 1WB of the workpiece 1W. Both of the first lid portion 121 and the second lid portion 122 can be disposed inside the cap attachment portion 1WB of the workpiece 1W. When sealing members (not shown) provided on outer surfaces of the first lid portion 121 and the second lid portion 122 abut onto an inner surface of the cap attachment portion 1WB, the cap attachment portion 1WB is sealed up and the inside of the workpiece 1W becomes a sealed space.

The gas sensor device 130 is provided with a gas sensor 131 and a filter 132 provided on a substrate. The gas sensor 131 is fixed to the lower surface of the second lid portion 122.

The gas sensor 131 is a so-called contact combustion type gas sensor, and is provided with a heater, a temperature measuring element (thermoelectric element, resistor, and like), a catalyst, and the like. The gas sensor 131 detects the tracer gas 1G flowing into the workpiece 1W. As the gas sensor 131, another gas sensor may be used instead of the contact combustion type gas sensor. As the gas sensor 131, for example, a heat conduction type may be used and a semiconductor type gas sensor, an electrochemical type gas sensor, a non-dispersive infrared (NDIR) absorption type gas sensor, or the like may be used. The gas sensor 131 is connected to the control device 160 via an electrode (not shown) and a cable (not shown).

The filter 132 is provided between the first lid portion 121 and the second lid portion 122 of the lid member 120. The gas sensor 131 is disposed in a space surrounded by the first lid portion 121, the second lid portion 122, and the filter 132. The filter 132 is formed of a material through which the tracer gas 1G can pass, for example, wire mesh, sintered metal, porous ceramic, or the like. When the tracer gas 1G flowing into the workpiece 1W reaches the gas sensor 131, the tracer gas 1G passes through the filter 132. The filter 132 allows the tracer gas 1G to pass therethrough and the filter 132 captures and removes foreign matters such as dust and dirt. In addition, the filter 132 functions as a connection portion that connects the first lid portion 121 and the second lid portion 122 to each other. A connecting member may be separately provided instead of the filter 132. An element such as an electrode may have a connection function.

The circulation device 140 is provided with a fan 141, which is driven by a motor (not shown), and circulates a gas in a space inside the workpiece 1W. As the fan 141, a propeller fan, a sirocco fan, a turbo fan, a mixed flow fan, a line flow fan, or the like can be used. In addition, as the fan 141, a piezoelectric micro blower obtained by combining an actuator formed of piezoelectricity and a membrane with each other may be used. The circulation device 140 is connected to the control device 160 via an electrode (not shown) that penetrates the first lid portion 121 and the second lid portion 122.

The drive device (drive unit) 150 is an actuator provided with an air cylinder 151, a piston 152, and a cylinder rod 153. An air pump (not shown) causes drive air to flow into the air cylinder 151. In addition, the air pump (not shown) causes the drive air to be discharged from the air cylinder 151. The cylinder rod 153 is attached to the piston 152 and penetrates a cylinder opening at a lower end of the air cylinder 151.

The lid member 120 is attached to a tip end (lower end) of the cylinder rod 153. The piston 152 and the cylinder rod 153 move upward and downward due to the discharge and inflow of the drive air in the air cylinder 151 and the lid member 120 also moves upward and downward in accordance with the upward and downward movement of the piston 152 and the cylinder rod 153. By means of the upward and downward movement of the lid member 120, it is possible to switch a structure closing an opening in the cap attachment portion 1WB of the workpiece 1W between the first lid portion 121 and the second lid portion 122.

The control device 160 is provided with a control circuit 161 and an input and output interface 162. The control device 160 is connected to each of the gas sensor device 130, the circulation device 140, and the drive device 150. The control device 160 receives an instruction from a user via the input and output interface 162. In response to the received instruction, the control device 160 transmits a control signal to each device. In addition, the control circuit 161 detects whether or not there is a gas leak in the workpiece 1W based on the concentration of the tracer gas 1G transmitted from the gas sensor 131.

Next, a procedure for performing gas leak detection with respect to the workpiece 1W in the gas leak detection device 11 according to the present embodiment will be described. First, the workpiece 1W is inserted into the chamber 110 via the upper opening 115A of the chamber 110 and the upper opening 115A is closed by means of the closing member 115. In this manner, a space between an inner side of the chamber 110 and an outer side of the workpiece 1W is made airtight. At this time, since both of the workpiece main body portion 1WA and the accommodation portion 111 have the columnar shapes, the volume of a space between the workpiece main body portion 1WA and the accommodation portion 111 can be made small.

When the upper opening 115A is closed, the cap attachment portion 1WB of the workpiece 1W is sealed up by means of the lid member 120. The cap attachment portion 1WB is sealed up by means the first lid portion 121 of the lid member 120. Therefore, the circulation device 140 is exposed inside the workpiece main body portion 1WA and the gas sensor device 130 is disposed outside the workpiece main body portion 1WA.

Next, the valves provided in the pipes connected to the intake ports 112 of the chamber 110 and the valves provided in the pipes connected to the exhaust ports 113 are opened such that the tracer gas 1G is introduced into the space between the workpiece main body portion 1WA and the accommodation portion 111 and air or the tracer gas 1G of a low concentration in the chamber 110 is discharged. In this manner, the space between the inner side of the chamber 110 and the outer side of the workpiece 1W is filled with the tracer gas 1G. In a state of being filled with the tracer gas 1G, a gas leak in a direction to the inside of the workpiece 1W from the chamber 110 occurs and the tracer gas 1G flows into the workpiece 1W when there is a hole or the like in the workpiece 1W. Note that, the intake ports 112 of the chamber 110 are provided on a lower side and the exhaust ports 113 are provided on an upper side such that the intake ports 112 and the exhaust ports 113 are disposed at positions separated from each other in the chamber 110. Therefore, the tracer gas 1G introduced via the intake ports 112 is not likely to reach the exhaust ports and thus the chamber 110 can be easily filled with the tracer gas 1G.

Next, the lid member 120 is lowered in a direction toward the inside of the workpiece main body portion 1WA by means of the drive device 150. Thereafter, a lid portion closing the opening in the cap attachment portion 1WB is switched from the first lid portion 121 to the second lid portion 122. At this time, the gas sensor device 130 and the circulation device 140 are exposed in the workpiece main body portion 1WA of the workpiece 1W. Since the drive device 150 is used when the lid member 120 is to be lowered, it is possible to easily adjust an amount by which the gas sensor device 130 enters the workpiece 1W (depth of entry).

The operation of the circulation device 140 may be continued or stopped while the lid portion closing the opening of the cap attachment portion 1WB of the workpiece 1W is being switched from the first lid portion 121 to the second lid portion 122. In the present embodiment, since the cap attachment portion WB is closed by the second lid portion 122 at all times, a gas in the workpiece 1W can be prevented from flowing to the outside of the cap attachment portion 1WB even when circulation of a gas in the workpiece main body portion 1WA is continued.

Next, the gas in the workpiece 1W is stirred and circulated by means of rotation of the fan 141 of the circulation device 140. Here, in a case where the tracer gas 1G flows into the inside of the workpiece 1W, the tracer gas 1G in the workpiece 1W is stirred and the concentration of the tracer gas 1G inside the workpiece main body portion 1WA becomes approximately uniform.

Next, with the fan 141 of the circulation device 140 being rotated, the heater of the gas sensor 131 in the gas sensor device 130 is heated to measure the concentration of the tracer gas 1G in the workpiece main body portion 1WA. Here, when the concentration of the tracer gas 1G measured by the gas sensor 131 is equal to or higher than a specified value, it is determined that a gas leak into the workpiece 1W, which is the detection target, has occurred. When the concentration of the tracer gas 1G measured by the gas sensor 131 is lower than the specified value, it is determined that no gas leak into the workpiece 1W, which is the detection target, has occurred. In this manner, gas leak detection with respect to the workpiece 1W is performed.

When the gas leak detection is finished, the valves provided in the pipes connected to the exhaust ports 113 of the chamber 110 are opened and the valves provided in the pipes connected to the intake ports 112 are closed. In this manner, the tracer gas 1G in the space between the workpiece main body portion 1WA and the accommodation portion 111 is discharged to the outside of the chamber 110 via the exhaust ports 113 and atmospheric air is introduced via the intake ports 112. When the tracer gas 1G is collected at the time of discharge, the tracer gas 1G can be reused. Then, the lid member 120 is removed from the workpiece 1W, the closing member 115 is removed from the chamber 110, and the workpiece 1W is extracted from the accommodation portion 111.

As described above, in the gas leak detection device 11 in the present embodiment, the gas sensor device 130 is disposed inside the workpiece 1W and detects the concentration of the tracer gas 1G. The inside of the workpiece 1W is a closed space and thus a decrease in concentration of the tracer gas 1G attributable to dilution with atmospheric air is not likely to occur. On the contrary, when the tracer gas 1G flows into the workpiece 1W, the concentration thereof increases with time. Therefore, the tracer gas 1G can be detected under a situation where the concentration thereof in the gas is high in comparison with a case where a gas leak from an accommodated object to the outside is detected with a sensor moving along an outer surface of a detection target object. Therefore, it is possible to increase the detection sensitivity when the tracer gas 1G is to be detected by means of the gas sensor device 130.

In addition, in the gas leak detection device 11 in the present embodiment, the tracer gas 1G is introduced into the accommodation portion 111 provided with the intake ports 112 and the exhaust ports 113 so as to detect a gas leak into the workpiece 1W. In the case of a method of detecting a gas leak to the outside by filling a detection target object with the tracer gas 1G, it takes time to introduce and discharge the tracer gas 1G because there is a limit on the size or the number of opening portions in the detection target object. However, in the case of the gas leak detection device 11 in the present embodiment, the degree of freedom for the areas, the number, and the positions of the intake ports and the exhaust ports in the chamber 110 is large. Therefore, an intake and exhaust time can be reduced and a time taken to inspect the workpiece W can be reduced (inspection speed can be increased).

Furthermore, since both of the workpiece main body portion 1WA and the accommodation portion 111 have the same shape (similar shape), that is, a columnar shape, the volume of the space between the workpiece main body portion 1WA and the accommodation portion 111 is small. As described above, since the shape of the accommodation portion 111 can be designed in accordance with the shape of the workpiece 1W, the amount of the tracer gas 1G used in the inspection can be reduced. Reducing the amount of the tracer gas 1G to be used contributes to an increase in inspection speed, an increase in inspection reproducibility, and a decrease in cost.

In addition, in the case of the gas leak detection device 11 in the present embodiment, a gas in the workpiece 1W is circulated by the circulation device 140 when the gas leak detection is performed. Therefore, when the tracer gas 1G flows into the workpiece 1W, the inside of the workpiece 1W can be stirred to make the concentration thereof uniform. Therefore, an increase in inspection speed can be achieved and an improvement in measurement reproducibility can be achieved with the detection accuracy improved.

### Embodiment A2

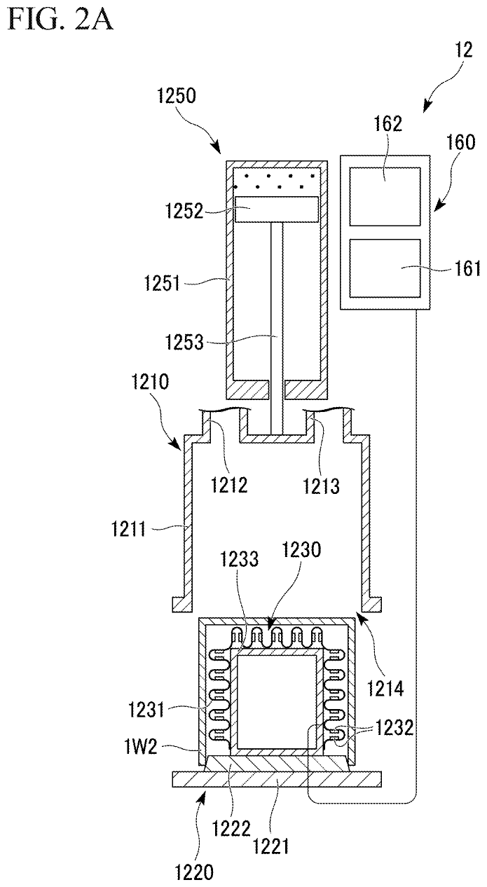

Embodiment A2 of the present invention will be described. Both of FIGS. 2A and 2B are side sectional views of a gas leak detection device according to Embodiment A2. As shown in FIGS. 2A and 2B, a gas leak detection device 12 according to the present embodiment is provided with a chamber 1210, a lid member 1220, a gas sensor array 1230, a drive device 1250, and the control device 160.

As shown in FIGS. 2A and 2B, the chamber 1210 is provided with a substantially columnar accommodation portion 1211. An upper portion of the accommodation portion 1211 is provided with an intake port 1212 and an exhaust port 1213. The intake port 1212 and the exhaust port 1213 are disposed at positions separated from each other. A pipe provided with a valve is connected to each of the intake port 1212 and the exhaust port 1213.

The chamber 1210 is formed of, for example, metal, resin, or the like, and has a certain shape. A workpiece introduction port 1214 is formed in a lower portion of the chamber 1210. The workpiece introduction port 1214 is formed over substantially the entire lower surface of the chamber 1210.

The lid member 1220 is disposed below the chamber 1210. The lid member 1220 is provided with a lid body 1221 and an elastic sealing member 1222 attached to the lid body 1221. The shape of the lid body 1221 is slightly larger than the chamber 1210 in plan view. The elastic sealing member 1222 has a planar shape. The shape of the elastic sealing member 1222 is substantially the same as the shape of the chamber 1210 in plan view. The elastic sealing member 1222 is a plate-shaped member formed of, for example, an elastic body.

A second workpiece 1W2, which is a detection target in the present embodiment, is a substantially cylindrical workpiece that includes a lower surface provided with an opening. The shape of the opening in the lower surface of the second workpiece 1W2 is substantially the same as the shape of the elastic sealing member 1222 in plan view. Therefore, the second workpiece 1W2 can be fitted onto the elastic sealing member 1222. When the second workpiece 1W2 is fitted onto the elastic sealing member 1222, a space inside the second workpiece 1W2 is made airtight.

The gas sensor array 1230 is attached to an upper surface of the elastic sealing member 1222. The gas sensor array 1230 is disposed inside the second workpiece 1W2 when the second workpiece 1W2 is fitted onto the elastic sealing member 1222. The gas sensor array 1230 is provided with a plurality of gas sensor devices 1232. The gas sensor devices 1232 are attached onto a flexible base substrate 1231. The intervals between adjacent gas sensor devices 1232 are substantially the same. The base substrate 1231 is formed of a flexible printed board. The base substrate 1231 allows the tracer gas 1G to pass therethrough and the base substrate 1231 captures and removes foreign substances such as dust and dirt. The base substrate 1231 is fixed to a hollow pedestal 1233 attached to the elastic sealing member 1222. That is, the gas sensor array 1230 is indirectly attached to the lid member 1220 via the hollow pedestal 1233 and the elastic sealing member 1222. The plurality of gas sensor devices 1232 are connected to the control device 160.

The drive device 1250 is an actuator provided with an air cylinder 1251, a piston 1252, and a cylinder rod 1253 that are the same as those in Embodiment A1 described above. The chamber 1210 is attached to a tip end (lower end) of the cylinder rod 1253. When the cylinder rod 1253 is moved upward and downward, the chamber 1210 moves upward and downward.

When the chamber 1210 is lowered, the second workpiece 1W2 is introduced into the accommodation portion 1211 via the workpiece introduction port 1214 formed in the lower surface of the chamber 1210. When the chamber 1210 is lowered and comes into close contact with the lid body 1221 of the lid member 1220, the inside of the accommodation portion 1211 is made airtight. At this time, a sealing member (not shown) is interposed between the chamber 1210 and the lid body 1221 such that the inside of the chamber 1210, more specifically, a space between an inner side of the accommodation portion 1211 and an outer side of the second workpiece 1W2 is made airtight.

The control device 160 is provided with the control circuit 161 and the input and output interface 162. The control device 160 detects a gas leak in the second workpiece 1W2 by means of the gas sensor devices 1232 and controls each device.

Next, a procedure for performing gas leak detection with respect to the second workpiece 1W2 in the gas leak detection device 12 according to the present embodiment will be described. First, as shown in FIG. 2A, the second workpiece 1W2 is fitted onto the elastic sealing member 1222 of the lid member 1220 with the chamber 1210 raised such that the second workpiece 1W2 is placed on the lid member 1220. When the second workpiece 1W2 is fitted onto the elastic sealing member 1222, the space inside the second workpiece 1W2 is made airtight.

Next, the chamber 1210 is lowered by means of the drive device 1250 and the second workpiece 1W2 is accommodated into the chamber 1210 as shown in FIG. 2B. At this time, the chamber 1210 is brought into close contact with the lid body 1221 of the lid member 1220 such that the inside of the chamber 1210 (space inside chamber 1210 and outside second workpiece 1W2) is made airtight.

Next, a valve provided in a pipe connected to the intake port 1212 of the chamber 1210 and a valve provided in a pipe connected to the exhaust port 1213 are opened. When the valves are opened, the tracer gas 1G is introduced into a space between the second workpiece 1W2 and the accommodation portion 1211 and air or the tracer gas 1G of a low concentration in the accommodation portion 1211 is discharged. In this manner, the space between the inner side of the accommodation portion 1211 and the outer side of the second workpiece 1W2 is filled with the tracer gas 1G.

Next, the concentration of the tracer gas 1G inside the second workpiece 1W2 is measured in the same manner as in Embodiment A1 to perform gas leak detection with respect to the second workpiece 1W2.

When the gas leak detection is finished, the tracer gas 1G in the space between the second workpiece 1W2 and the accommodation portion 1211 is discharged to the outside of the chamber 1210 via the exhaust port 1213 and the second workpiece 1W2 is extracted.

As described above, in the gas leak detection device 12 in the present embodiment, the gas sensor devices 1232 are disposed inside the second workpiece 1W2 such that the gas sensor devices 1232 measure the concentration of the tracer gas 1G. In addition, the tracer gas 1G is discharged and introduced via the intake ports and the exhaust ports provided in the accommodation portion 1211. Therefore, as with Embodiment A1, it is possible to increase the detection sensitivity, increase the inspection speed, and improve the reproducibility.

In addition, in the gas leak detection device 12 in the present embodiment, the chamber 1210 is moved such that the second workpiece 1W2 is accommodated in the accommodation portion 1211. Therefore, for example, during a process of transporting a large number of second workpieces 1W2 by means of a conveyor or the like, the chamber 1210 can be moved toward the second workpieces 1W2 in an one-by-one manner such that a gas leak inspection is performed. Therefore, it is possible to contribute to reduction of an installation space for the gas leak detection device 12 and to labor saving. Instead of the chamber 1210, the second workpiece 1W2 may be moved when the second workpiece 1W2 is to be accommodated in the accommodation portion 1211. The chamber 1210 and the second workpiece 1W2 may be moved together.

In addition, the gas leak detection device 12 in the present embodiment detects a gas leak by means of the plurality of gas sensor devices 1232. Therefore, by determining which gas sensor device 1232 has detected a gas, it is possible to easily specify the position of a gas leak. Furthermore, since the plurality of gas sensor devices 1232 are disposed in the vicinity of an inner wall of the second workpiece 1W2 by means of the hollow pedestal 1233, a gas leak can be detected in an early stage.

### Embodiment A3

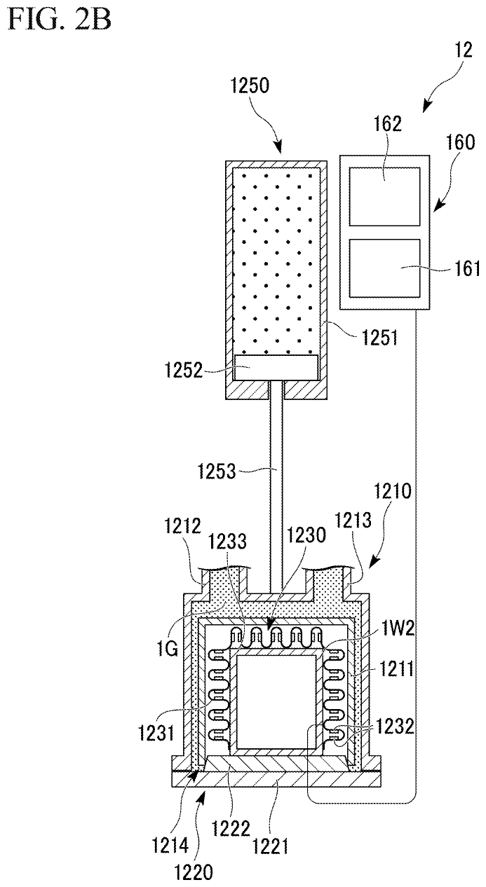

Embodiment A3 of the present invention will be described. Both of FIGS. 3A and 3B are plan sectional views of a gas leak detection device according to Embodiment A3. As shown in FIG. 3A, a gas leak detection device 13 according to the present embodiment is provided with a chamber 1310, a gas sensor array 1330, and a drive device 1350.

The chamber 1310 has, for example, a columnar shape and has the same intake port and the same exhaust port as those in Embodiment A2. A pipe provided with a valve is connected to each of the intake port and the exhaust port. A third workpiece 1W3, which is a detection target in the present embodiment, is provided with a substantially columnar main body portion and a cap attachment portion provided on the main body portion, as with Embodiment A1. At the time of inspection of the third workpiece 1W3, the columnar third workpiece 1W3 is accommodated in the chamber 1310 and the gas sensor array 1330 and the drive device 1350 are inserted into the third workpiece 1W3.

As with the gas sensor array 1230 in Embodiment A2, the gas sensor array 1330 is provided with a base substrate 1331 and a plurality of gas sensor devices 1332 fixed to the base substrate 1331. The base substrate 1331 allows the tracer gas 1G to pass therethrough although the base substrate 1331 does not allow foreign substances such as dust and dirt to pass therethrough. The same control device as that in Embodiment A2 or the like is connected to the gas sensor devices 1332. The base substrate 1331 has creases along which the base substrate 1331 is deformed into a corrugated (bellows) shape as a whole. The base substrate 1331 is folded along the creases before the base substrate 1331 is inserted into the third workpiece 1W3.

The drive device 1350 is disposed on a further inner side of the base substrate 1331 of the gas sensor array 1330. The drive device 1350 is provided with a deformable support 1351 that is a gas sensor device support and a support control unit (not shown). The deformable support 1351 is formed of a deformable material such as cloth or rubber and is deformable based on a control signal of the support control unit. The deformable support 1351 is formed of a material that allows the tracer gas 1G to pass therethrough. In another embodiment, the deformable support 1351 may be formed of a material that does not allow the tracer gas 1G to pass therethrough. The way in which the deformable support 1351 is deformed by a control signal of the support control unit may be, for example, a way in which the deformable support 1351 itself deforms. Alternatively, an actuator for causing the deformable support 1351 to deform may be provided and the support control unit may operate the actuator such that the deformable support 1351 deforms.

The plurality of gas sensor devices 1332 in the gas sensor array 1330 are fixed to the deformable support 1351 by means of an adhesive or the like. Therefore, when the base substrate 1331 of the gas sensor array 1330 is folded, the deformable support 1351 is integrally stored inside the base substrate 1331. When the drive device 1350 is in a non-operating state, the deformable support 1351 is accommodated in the folded base substrate 1331 to form a compact shape as shown in FIG. 3A. During an operating state, the deformable support 1351 is opened to press and expand the base substrate 1331 under the control of the support control unit and moves the base substrate 1331 up to the vicinity of an inner surface of the third workpiece 1W3 as shown in FIG. 3B. In addition, the deformable support 1351 causes the base substrate 1331 to deform into a folded shape as shown in FIG. 3A under the control of the support control unit and the base substrate 1331 is folded while receiving a force in an inward direction.

Next, a procedure for performing gas leak detection with respect to the third workpiece 1W3 in the gas leak detection device 13 according to the present embodiment will be described. First, after the third workpiece 1W3 is accommodated in the chamber 1310, as shown in FIG. 3A, the gas sensor array 1330 and the drive device 1350 are inserted into the third workpiece 1W3. The third workpiece 1W3 may be accommodated in the chamber 1310 after the gas sensor array 1330 and the drive device 1350 are inserted into the third workpiece 1W3.

The gas sensor array 1330 is inserted via an appropriate hole portion provided in the third workpiece 1W3. The hole portion may have a configuration similar to that of the cap attachment portion 1WB in Embodiment A1 described above, for example. The gas sensor array 1330 is in a folded state. Therefore, even when the area of an opening of the hole portion is small, the gas sensor array 1330 and the drive device 1350 can be inserted into the third workpiece 1W3.

When the gas sensor array 1330 is inserted into the third workpiece 1W3, the deformable support 1351 of the drive device 1350 is caused to deform by means of the support control unit. As a result, as shown in FIG. 3B, the gas sensor array 1330 presses and expands the base substrate 1331 and the base substrate 1331 is brought close to a position in the vicinity of the third workpiece 1W3 over the entire inner surface of the third workpiece 1W3.

Then, the valves provided in the pipes connected to the intake port and the exhaust port of the chamber 1310 are opened such that the tracer gas 1G is introduced into the chamber 1310, more specifically, into a space between an inner side of the chamber 1310 and an outer side of the third workpiece 1W3. Next, the concentration of the tracer gas 1G inside the third workpiece 1W3 is measured in the same manner as in Embodiment A1 to perform gas leak detection with respect to the third workpiece 1W3.

When the gas leak detection is finished, the tracer gas 1G in the chamber 1310 is released to the outside. Thereafter, the deformable support 1351 in the drive device 1350 is caused to deform by means of the support control unit such that the base substrate 1331 is folded as shown in FIG. 3A due to the deformable support 1351 and the base substrate 1331 is extracted from the third workpiece 1W3. Then, the third workpiece 1W3 is extracted from the chamber 1310.

As described above, in the gas leak detection device 13 in the present embodiment, the gas sensor devices 1332 are disposed inside the third workpiece 1W3 such that the gas sensor devices 1332 measure the concentration of the tracer gas 1G. In addition, the tracer gas 1G is introduced and discharged into and from the chamber 1310. Therefore, as with Embodiment A1, it is possible to increase the detection sensitivity, increase the inspection speed, and improve the reproducibility.

In addition, in the gas leak detection device 13 in the present embodiment, the deformable support 1351 is caused to deform such that the plurality of gas sensor devices 1332 are each brought close to a position in the vicinity of the third workpiece 1W3. Therefore, a gas leak can be detected in an early stage. Furthermore, by specifying which gas sensor device 1332 has detected a gas, it is possible to easily specify the position of a gas leak.

In the gas leak detection device 13 in the present embodiment, the deformable support 1351 that deforms based on a support control unit control signal is used. However the invention is not limited to a case where such a support is used. For example, a support that is formed of an elastic material such as rubber and expands in a balloon shape when drive air is introduced thereinto may also be used.

### Embodiment A4

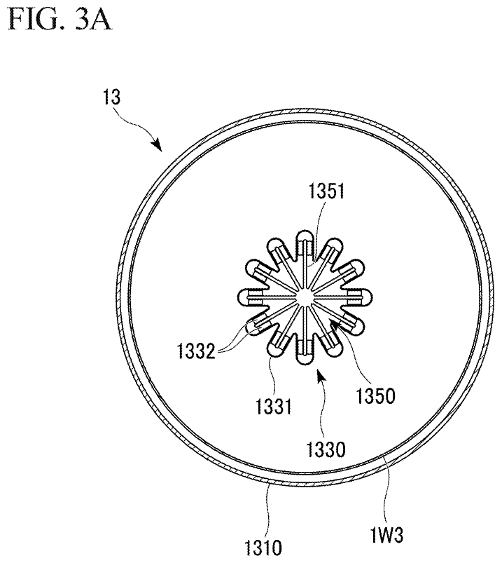

Embodiment A4 of the present invention will be described. Both of FIGS. 4A and 4B are side sectional views of a gas leak detection device according to Embodiment A4. FIG. 4C is a sectional view taken along the line C-C in FIG. 4B. As shown in FIG. 4A, a gas leak detection device 14 according to the present embodiment is provided with a chamber 1410, a gas sensor array 1430, and a drive device 1450.

The chamber 1410 is provided with, for example, an accommodation portion 1411 having an elongated spherical shape (elongated flat oval shape). The accommodation portion 1411 is divided into a lower accommodation portion 1411A and an upper accommodation portion 1411B. A plurality of intake ports 1412 are provided in the lower accommodation portion 1411A. A plurality of exhaust ports 1413 are provided in the upper accommodation portion 1411B.

A fourth workpiece 1W4, which is a detection target in the present embodiment, is provided with a workpiece main body portion 1W4A and a cap attachment portion 1W4B. The workpiece main body portion 1W4A has an elongated spherical shape and is slightly smaller than the accommodation portion 1411 having an elongated spherical shape. The cap attachment portion 1W4B is provided on the workpiece main body portion 1W4A. At the time of inspection of the fourth workpiece 1W4, the workpiece main body portion 1W4A of the fourth workpiece 1W4 is accommodated in the chamber 1410.

The accommodation portion 1411 is provided with a connection portion 1414. The accommodation portion 1411 is formed by the lower accommodation portion 1411A and the upper accommodation portion 1411B integrated with each other by means of the connection portion 1414.

A workpiece holding portion 1415 is provided at an upper end portion of the accommodation portion 1411. The internal shape of the workpiece holding portion 1415 is substantially the same as the external shape of the cap attachment portion 1W4B.

The gas sensor array 1430 is provided with a plurality of gas sensor devices 1431 that are the same as the gas sensor devices 1232 of the gas sensor array 1230 in Embodiment A2. The plurality of gas sensor devices 1431 are attached to a main rib 1454 of the drive device 1450 which will be described later. Intervals between the plurality of gas sensor devices 1431 are substantially the same as each other. The same control device as that in Embodiment A2 or the like is connected to the gas sensor devices 1431.

The drive device 1450 is provided with a center rod 1451. The center rod 1451 is a rod-shaped member. The center rod 1451 extends along a vertical direction of the accommodation portion 1411 of the chamber 1410 and is disposed at the central portion of the accommodation portion 1411. Sliding members 1452 are provided above and below an approximately central portion of the center rod 1451 in the vertical direction. One end of each supporting rib 1453 is rotatably connected to each sliding member 1452. The other end of each supporting rib 1453 is rotatably connected to the main rib 1454.

The main rib 1454 is a gas sensor device support. The plurality of gas sensor devices 1431 of the gas sensor array 1430 are attached to the main rib 1454. The main rib 1454 is formed of, for example, an elastic body such as metal or glass fiber. The main rib 1454 is disposed in the vicinity of an inner wall surface of the fourth workpiece 1W4 in a state of being pressed and expanded by the supporting ribs 1453.

When the sliding member 1452 moves in one direction along the center rod 1451, the supporting ribs 1453 connected to the sliding member 1452 press and expand the main rib 1454 such that the gas sensor array 1430 provided on the main rib 1454 is disposed in the vicinity of an inner wall of the fourth workpiece 1W4. When the sliding member 1452 moves in the opposite direction along the center rod 1451, the supporting ribs 1453 connected to the sliding member 1452 pull the main rib 1454 such that the main rib 1454 is folded. The sliding members 1452 are operated by means of motors built into the sliding members 1452. The sliding members 1452 may be manually operated as in the case of the opening and closing of an umbrella.

Next, a procedure for performing gas leak detection with respect to the fourth workpiece 1W4 in the gas leak detection device 14 according to the present embodiment will be described. First, the cap attachment portion 1W4B of the fourth workpiece 1W4 is held by means of the workpiece holding portion 1415 in a state where the upper accommodation portion 1411B is separated from the lower accommodation portion 1411A. Next, as shown in FIG. 4A, the lower accommodation portion 1411A and upper accommodation portion 1411B are connected to each other at the connection portion 1414 to form the accommodation portion 1411 and the workpiece main body portion 1W4A of the fourth workpiece 1W4 is accommodated in the accommodation portion 1411. At this time, the connection portion 1414 and a space between the workpiece holding portion 1415 and the cap attachment portion 1W4B of the fourth workpiece 1W4 are sealed by sealing members. In this manner, a space between an inner side of the accommodation portion 1411 and an outer side of the fourth workpiece 1W4 is made airtight.

Next, the drive device 1450 in a folded state and the gas sensor array 1430 attached to the drive device 1450 are inserted into the fourth workpiece 1W4 via the cap attachment portion 1W4B. The drive device 1450 and the gas sensor array 1430 may be inserted into the fourth workpiece 1W4 before accommodation into the accommodation portion 1411 such that the fourth workpiece 1W4 with the drive device 1450 and the gas sensor array 1430 inserted thereinto is accommodated in the accommodation portion 1411.

After the gas sensor array 1430 is inserted into the fourth workpiece 1W4, as shown in FIG. 4B, the motors provided in the sliding members 1452 of the drive device 1450 are driven such that the sliding members 1452 move in one direction along the center rod 1451 and the supporting ribs 1453 press and expand the main rib 1454. In this manner, the gas sensor array 1430 is disposed in the vicinity of the inner surface of the fourth workpiece 1W4.

Then, valves provided in pipes connected to the intake ports 1412 and the exhaust ports 1413 of the chamber 1410 are opened such that the tracer gas 1G is introduced into the chamber 1410, more specifically, into a space between an inner side of the chamber 1410 and an outer side of the workpiece main body portion 1W4A of the fourth workpiece 1W4. Next, the concentration of the tracer gas 1G inside the fourth workpiece 1W4 is measured in the same manner as in Embodiment A1 to perform gas leak detection with respect to the fourth workpiece 1W4.

When the gas leak detection is finished, the tracer gas 1G in the accommodation portion 1411 is released to the outside via the exhaust ports 1413. Thereafter, the sliding members 1452 of the drive device 1450 are moved in the opposite direction along the center rod 1451 such that the main rib 1454 is pulled in and folded by means of the supporting ribs 1453. Thereafter, the lower accommodation portion 1411A of the accommodation portion 1411 is removed from the upper accommodation portion 1411B and the fourth workpiece 1W4 is extracted from the chamber 1410.

As described above, in the gas leak detection device 14 in the present embodiment, the gas sensor devices 1431 are disposed inside the fourth workpiece 1W4 such that the gas sensor devices 1431 measure the concentration of the tracer gas 1G. In addition, the tracer gas 1G is introduced and discharged into and from the chamber 1410. Therefore, as with Embodiment A1, it is possible to increase the detection sensitivity, increase the inspection speed, and improve the reproducibility.

In addition, in the gas leak detection device 14 in the present embodiment, the accommodation portion 1411 is divided into the lower accommodation portion 1411A and the upper accommodation portion 1411B. Therefore, even in a case where the fourth workpiece 1W4 has a complicated shape such as a pillar-like shape or a box-like shape that is not linear, the fourth workpiece 1W4 can be accommodated in the accommodation portion 1411. In addition, the drive device 1450 for disposing the gas sensor array 1430 along the inner side of the fourth workpiece 1W4 is provided with the supporting ribs 1453, the main rib 1454, and the like and is unfolded in a way similar to the way in which an umbrella is unfolded. Therefore, the plurality of gas sensor devices 1431 can be easily disposed with respect to the fourth workpiece 1W4 having an elongated spherical shape and a gas leak can be detected in an early stage. Furthermore, by specifying which gas sensor device 1431 has detected a gas, it is possible to specify the position of a gas leak.

### Embodiment A5

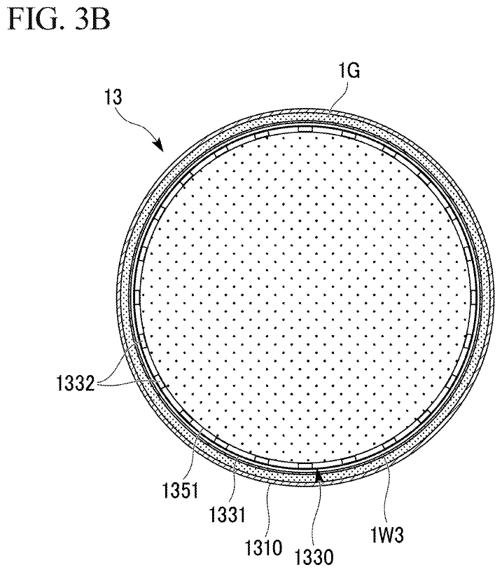

Embodiment A5 of the present invention will be described. Both of FIGS. 5A and 5B are side sectional views of a gas leak detection device according to Embodiment A5. As shown in FIG. 5A, a gas leak detection device 15 according to the present embodiment is provided with a chamber 1510, a gas sensor array 1530, and a drive device 1550.

The chamber 1510 is provided with, for example, a donut-shaped accommodation portion 1511 having the same shape as a trajectory obtained when a substantially C-shaped cross section is rotated around an X axis. The accommodation portion 1511 is divided into a lower accommodation portion 1511A and an upper accommodation portion 1511B. A plurality of intake ports 1512 are provided in the lower accommodation portion 1511A. A plurality of exhaust ports 1513 are provided in the upper accommodation portion 1511B.

A fifth workpiece 1W5, which is a detection target in the present embodiment is, for example, a tire attached to a vehicle. The tire serving as the fifth workpiece 1W5 is provided with an opening portion 1W5A. In the present embodiment, a space surrounded by the tire and the accommodation portion 1511 will be referred to the outside of the fifth workpiece 1W5, and a side to which the accommodation portion is not attached will be referred to as the inside of the fifth workpiece 1W5. The accommodation portion 1511 is provided with a connection portion 1514. The accommodation portion 1511 is formed by the lower accommodation portion 1511A and the upper accommodation portion 1511B connected to each other at the connection portion 1514.

A tire holding portion 1516 is provided on an inner side (X axis side) of the accommodation portion 1511. The tire holding portion 1516 is provided with a lower tire holding portion 1516A provided on the lower accommodation portion 1511A and an upper tire holding portion 1516B provided on the upper accommodation portion 1511B. Lower and upper sides of the opening portion 1W5A of the fifth workpiece 1W5 are fitted into the lower tire holding portion 1516A and the upper tire holding portion 1516B. The tire, which is the fifth workpiece 1W5, is formed of an elastic material, for example, rubber. Therefore, the tire holding portion 1516 and the fifth workpiece 1W5 are in close contact with each other.

The gas sensor array 1530 is provided with a plurality of gas sensor devices 1531 that are the same as the gas sensor devices 1232 of the gas sensor array 1230 in Embodiment A2. The gas sensor array 1530 is attached to a main rib 1557 of the drive device 1550 which will be described later. Intervals between the plurality of gas sensor devices 1531 are substantially the same as each other. The same control device as that in Embodiment A2 or the like is connected to the gas sensor devices 1531.

As shown in FIG. 5A, the drive device 1550 is provided with a first electromagnetic motor 1551, a first shaft 1552, a second electromagnetic motor 1553, and a second shaft 1554. The second shaft 1554 is provided with an opening link mechanism 1555. A plurality of supporting ribs 1556 are attached to the opening link mechanism 1555. Furthermore, the main rib 1557 is attached to tip ends of the supporting ribs 1556.

The plurality of gas sensor devices 1531 of the gas sensor array 1530 are attached to the main rib 1557. The main rib 1557 is formed of, for example, an elastic body such as metal or glass fiber. The main rib 1557 is disposed in the vicinity of an inner surface of the fifth workpiece 1W5 in a state where the opening link mechanism 1555 is open.

When the first electromagnetic motor 1551 and the second electromagnetic motor 1553 are operated, the opening link mechanism 1555 is opened and the gas sensor array 1530 is disposed in the vicinity of the inner surface of the fifth workpiece 1W5. The opening link mechanism 1555 may be opened manually. In addition, it is possible to move the main rib 1557 along the inner surface of the fifth workpiece 1W5 by operating the first electromagnetic motor 1551 when the main rib 1557 is disposed in the vicinity of the inner surface of the fifth workpiece 1W5 with the opening link mechanism 1555 opened. The drive device 1550 may move the opening link mechanism 1555 in any direction such as an upward direction and a downward direction inside the fifth workpiece 1W5.

Instead of at least one of the first electromagnetic motor 1551 and the second electromagnetic motor 1553, an air type actuator, a hydraulic pressure, an electromagnetic solenoid, piezoelectricity, static electricity, magnetostriction, a shape-memory alloy, bimetal, a conductive polymer, or the like may be used. In addition, an actuator such as the first electromagnetic motor 1551 may be installed at a position distant from the fifth workpiece 1W5 and the opening link mechanism 1555 may be driven by one or more wires or the like.

Next, a procedure for performing gas leak detection with respect to the fifth workpiece 1W5 in the gas leak detection device 15 according to the present embodiment will be described. First, the opening portion 1W5A of the fifth workpiece 1W5 is fitted into the lower tire holding portion 1516A of the lower accommodation portion 1511A. Next, the opening portion 1W5A on an upper side of the fifth workpiece 1W5 is fitted into the upper tire holding portion 1516B of the upper accommodation portion 1511B. Next, the lower accommodation portion 1511A and the upper accommodation portion 1511B are connected to each other such that the accommodation portion 1511 with the fifth workpiece 1W5 accommodated therein is formed as shown in FIG. 5A. At this time, the connection portion 1514 between the lower accommodation portion 1511A and the upper accommodation portion 1511B is sealed by a sealing member. In addition, a space between the opening portion 1W5A of the fifth workpiece 1W5 and the tire holding portion 1516 of the accommodation portion 1511 is sealed due to the elasticity of the opening portion 1W5A. In this manner, a space between the accommodation portion 1511 and the fifth workpiece 1W5 is made airtight.

Next, the first electromagnetic motor 1551 and the second electromagnetic motor 1553 of the drive device 1550 are operated such that the opening link mechanism 1555 is opened as shown in FIG. 5B and the gas sensor array 1530 attached to the main rib 1557 is disposed in the vicinity of the fifth workpiece 1W5. A procedure as follows may also be adopted. That is, the opening link mechanism 1555 is opened before the lower accommodation portion 1511A and the upper accommodation portion 1511B are connected to each other such that the accommodation portion 1511 is formed. Thereafter, the lower accommodation portion 1511A and the upper accommodation portion 1511B are connected to each other such that the accommodation portion 1511 is formed.

Then, valves provided in pipes connected to the intake ports 1512 and the exhaust ports 1513 of the chamber 1510 are opened. Accordingly, the tracer gas 1G is introduced into the chamber 1510, more specifically, a space between the chamber 1510 and the fifth workpiece 1W5. Next, the concentration of the tracer gas 1G inside the fifth workpiece 1W5 is measured in the same manner as in Embodiment A1 to perform gas leak detection with respect to the fifth workpiece 1W5.

When the gas leak detection is finished, the tracer gas 1G in the accommodation portion 1511 is released to the outside via the exhaust ports 1513. Thereafter, the first electromagnetic motor 1551 and the second electromagnetic motor 1553 are driven such that the main rib 1557 is pulled. Thereafter, the upper accommodation portion 1511B is removed from the lower accommodation portion 1511A of the accommodation portion 1511 and the fifth workpiece 1W5 is removed from the tire holding portion 1516 such that the fifth workpiece 1W5 is extracted from the chamber 1510.

As described above, in the gas leak detection device 15 in the present embodiment, the gas sensor devices 1531 are disposed along the inner surface of the fifth workpiece 1W5, which is a tire, such that the gas sensor devices 1531 measure the concentration of the tracer gas 1G. In addition, the tracer gas 1G is introduced and discharged into and from the chamber 1510. Therefore, as with Embodiment A1, it is possible to increase the detection sensitivity, increase the inspection speed, and improve the reproducibility.

In addition, as with the drive device 1450 in Embodiment A4, the drive device 1550 for disposing the gas sensor array 1530 along the inner surface of the fifth workpiece 1W5 is unfolded in a way similar to the way in which an umbrella is unfolded. Therefore, the gas sensor array 1530 can be easily disposed with respect to the inner surface of the fifth workpiece 1W5, which is a tire, and a gas leak can be detected in an early stage. Furthermore, by specifying which gas sensor device 1531 has detected a gas, it is possible to easily specify the position of a gas leak.

### Embodiment A6

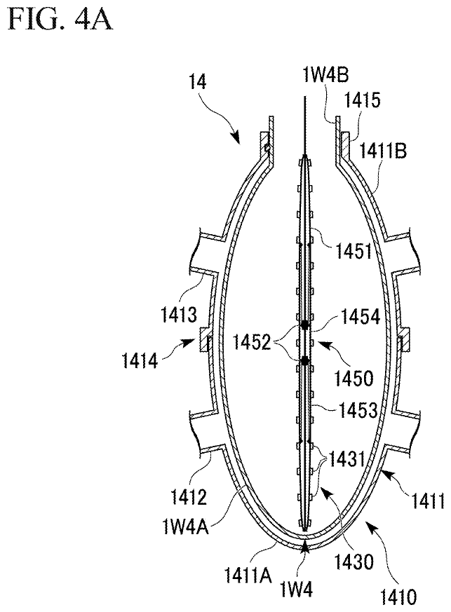

Embodiment A6 of the present invention will be described. Both of FIGS. 6A and 6B are side sectional views of a gas leak detection device according to Embodiment A6. As shown in FIG. 6A, a gas leak detection device 16 according to the present embodiment is provided with a chamber 1610, the lid member 120, the gas sensor device 130, the circulation device 140, the drive device 150, and the control device 160. Among them, the lid member 120, the gas sensor device 130, the circulation device 140, the drive device 150, and the control device 160 have the same configurations as those in Embodiment A1 described above.

The configuration of the chamber 1610 of the gas leak detection device 16 in the present embodiment is different from that in Embodiment A1. As shown in FIG. 6A, the chamber 1610 is provided with an accommodation portion 1611, a holding portion 1612, and a closing member 1613. In addition, as with the workpiece 1W in Embodiment A1, a sixth workpiece 1W6, which is a detection target in the present embodiment, is provided with a substantially columnar workpiece main body portion 1W6A, and a cap attachment portion 1W6B provided at an upper end of the workpiece main body portion 1W6A. The sixth workpiece 1W6 is formed by using, for example, aluminum or an aluminum alloy as a main material. The sixth workpiece 1W6 may be formed of another material.

The accommodation portion 1611 may be formed of, for example, metal such as stainless steel (SUS), a laminated material, an organic-inorganic hybrid material, or resin. The accommodation portion 1611 has, for example, a corrugated shape (bellows shape). The rigidity of the accommodation portion 1611 is lower than that of the sixth workpiece 1W6. Therefore, the accommodation portion 1611 is easily deformed. The accommodation portion 1611 includes an open upper surface. The shape of the accommodation portion 1611 is an approximately columnar shape. The size of the accommodation portion 1611 before deformation is slightly larger than that of the sixth workpiece 1W6.

The holding portion 1612 has a ring-like shape, is disposed above the accommodation portion 1611, and holds the accommodation portion 1611. The diameter of the holding portion 1612 is larger than the diameter of the workpiece main body portion 1W6A of the sixth workpiece 1W6. The rigidity of the holding portion 1612 is higher than that of the sixth workpiece 1W6.

The closing member 1613 is disposed inside the holding portion 1612. The closing member 1613 is provided with an intake port 1614 and an exhaust port 1615. The structures and functions of the intake port 1614 and the exhaust port 1615 are the same as those of the intake ports 112 and the exhaust ports 113 in Embodiment A1.

An upper opening 1613A is formed in the central position of the closing member 1613 in plan view. The cap attachment portion 1W6B is fitted into the upper opening 1613A. A sealing member is provided between the closing member 1613 and the holding portion 1612. In addition, a sealing member is provided between the closing member 1613 and the cap attachment portion 1WB. The sealing members are, for example, O-rings. Therefore, a space between the inside and the outside of the accommodation portion 1611 is made airtight by means of the closing member 1613.

Next, a procedure for performing gas leak detection with respect to the sixth workpiece 1W6 in the gas leak detection device 16 according to the present embodiment will be described. First, as shown in FIG. 6A, the sixth workpiece 1W6 is inserted into the chamber 1610 via the holding portion 1612 from which the closing member 1613 has been removed. Next, the inside of the holding portion 1612 is closed by means of the closing member 1613. In this manner, the inside of the chamber 1610 and a space outside the sixth workpiece 1W6 are made airtight. Here, both of the workpiece main body portion 1W6A and the accommodation portion 1611 have approximately columnar shapes. Therefore, the volume of a space between the workpiece main body portion 1W6A and the accommodation portion 1611 can be made small.

When the inside of the holding portion 1612 is closed, the cap attachment portion 1WB of the sixth workpiece 1W6 is sealed up by means of the lid member 120. The cap attachment portion 1WB is sealed up by means the second lid portion 122 of the lid member 120. Therefore, the circulation device 140 is accommodated in the workpiece main body portion 1W6A and the gas sensor device 130 is disposed outside the workpiece main body portion 1WA.

Next, valves provided in pipes connected to the intake ports 1614 of the chamber 1610 and valves provided in pipes connected to the exhaust ports 1615 are opened. When the valves are opened, the tracer gas 1G is introduced into the space between the workpiece main body portion 1W6A and the accommodation portion 1611 and air or the tracer gas 1G of a low concentration in the chamber 110 is discharged.

In this manner, the inside of the chamber 1610 and the outside of the sixth workpiece 1W6 are filled with the tracer gas 1G as shown in FIG. 6B. Here, the rigidity of the accommodation portion 1611 of the chamber 1610 is lower than that of the sixth workpiece 1W6. Therefore, the accommodation portion 1611 swells when being filled with the tracer gas 1G. In a state of being filled with the tracer gas 1G, a gas leak in a direction to the inside of the sixth workpiece 1W6 from the chamber 1610 occurs and the tracer gas 1G flows into the sixth workpiece 1W6 when there is a hole or the like in the sixth workpiece 1W6.

Next, the concentration of the tracer gas 1G inside the sixth workpiece 1W6 is measured in the same manner as in Embodiment A1 to perform gas leak detection with respect to the sixth workpiece 1W6.

When the gas leak detection is finished, the tracer gas 1G in the space between the workpiece main body portion 1W6A and the accommodation portion 1611 is discharged to the outside of the chamber 1610 via the exhaust port 1615. When the tracer gas 1G is discharged, the swollen accommodation portion 1611 returns to the original state. Then, the sixth workpiece 1W6 is extracted from the accommodation portion 1611.

As described above, in the gas leak detection device 16 in the present embodiment, the gas sensor device 130 is disposed inside the sixth workpiece 1W6 such that the gas sensor device 130 measures the concentration of the tracer gas 1G. In addition, the tracer gas 1G is introduced and discharged into and from the chamber 1610. Therefore, as with Embodiment A1, it is possible to increase the detection sensitivity, increase the inspection speed, and improve the reproducibility.

In addition, in the gas leak detection device 16 in the present embodiment, the rigidity of the accommodation portion 1611 of the chamber 1610 is designed to be lower than that of the sixth workpiece 1W6. Therefore, the volume of a space between the sixth workpiece 1W6 and the accommodation portion 1611 can be made small by means of deformation of the accommodation portion 1611 of the chamber 1610. Therefore, a gas remaining between the sixth workpiece 1W6 and the accommodation portion 1611 can be discharged in a short time with the sixth workpiece 1W6 almost not deformed.

### Embodiment A7

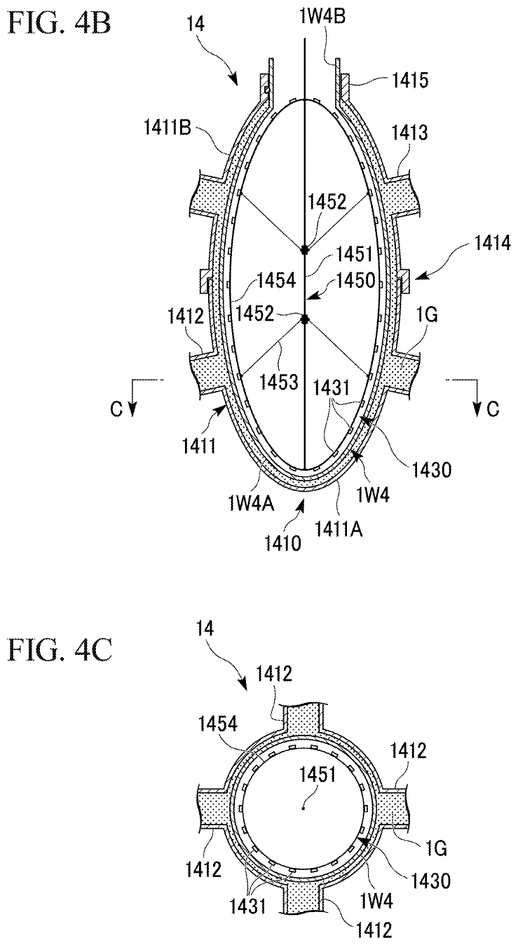

Embodiment A7 of the present invention will be described. Both of FIGS. 7A and 7B are side sectional views of a gas leak detection device according to Embodiment A7. As shown in FIG. 7A, a gas leak detection device 17 according to the present embodiment is provided with the chamber 110, a lid member 1720, a gas sensor unit 1730, the drive device 150, and the control device 160.

The gas leak detection device 17 in the present embodiment is different from that in Embodiment A1 in a point that no circulation device is provided and the configurations of the lid member 1720 and the gas sensor unit 1730 are different from those in Embodiment A1. The other configurations are the same as those in Embodiment A1. A seventh workpiece 1W7, which is a detection target in the present embodiment, is the same as the workpiece 1W in Embodiment A1 and is provided with a workpiece main body portion 1W7A and a cap attachment portion 1W7B.

The lid member 1720 is provided with a first lid portion 1721 and a second lid portion 1722. The first lid portion 1721 and second lid portion 1722 are stacked on each other. That is, the lid member 1720 has a two-layer structure including the first lid portion 1721 and second lid portion 1722. The first lid portion 1721 is disposed below the second lid portion 1722. The shapes of the first lid portion 1721 and the second lid portion 1722 in plan view are substantially the same as an opening in the cap attachment portion 1W7B of the seventh workpiece 1W7 and are disk-like shapes.

Both of the first lid portion 1721 and the second lid portion 1722 can be disposed inside the cap attachment portion 1W7B of the seventh workpiece 1W7.

When sealing members provided on outer surfaces of the first lid portion 1721 and the second lid portion 1722 abut onto an inner surface of the cap attachment portion 1W7B, the cap attachment portion 1W7B is sealed up and the inside of the seventh workpiece 1W7 becomes a sealed space.

The gas sensor unit 1730 is provided with a first gas sensor device 1731 and a second gas sensor device 1732. The first gas sensor device 1731 is fixed to a lower surface of the first lid portion 1721. The second gas sensor device 1732 is fixed to a lower surface of the second lid portion 1722.

The first gas sensor device 1731 is provided with a first gas sensor 1731A. The first gas sensor 1731A is a heat conduction type gas sensor which is a gas sensor device for high-concentration detection. The first gas sensor 1731A is a sensor suitable for detection performed at a time when the concentration of the tracer gas 1G is high. The heat conduction type gas sensor does not exhibit a high detection accuracy at a low concentration but has a high durability. The first gas sensor 1731A is connected to the control device 160 via an electrode (not shown) and a cable (not shown).

The second gas sensor device 1732 is provided with a second gas sensor 1732A. The second gas sensor 1732A is a contact combustion type gas sensor which is a gas sensor device for low-concentration detection. The second gas sensor 1732A is a sensor suitable for detection performed at a time when the concentration of the tracer gas 1G is low. The contact combustion type gas sensor is excellent in detection accuracy at a low concentration but is relatively unsuitable for detecting the tracer gas 1G in a high-concentration atmosphere. Therefore, the contact combustion type gas sensor has problems that a correct concentration cannot be measured and there is a risk of failure in a high-concentration atmosphere. The second gas sensor 1732A is connected to the control device 160 via an electrode (not shown) and a cable (not shown). Note that, as the second gas sensor device, a semiconductor type gas sensor may be used instead of the contact combustion type gas sensor.

The gas sensor unit 1730 is provided with a first filter 1733 and a second filter 1734. The first filter 1733 is attached to the lower surface of the first lid portion 1721 and is provided to cover the first gas sensor device 1731. The second filter 1734 is provided between the first lid portion 1721 and the second lid portion 1722. The second gas sensor device 1732 is disposed in a space surrounded by the first lid portion 1721, the second lid portion 1722, and the second filter 1734. The materials and functions of the first filter 1733 and the second filter 1734 are the same as those of the filter 132 in Embodiment A1.

The drive device 150 is an actuator provided with the air cylinder 151, the piston 152, and the cylinder rod 153. The control device 160 is provided with the control circuit 161 and the input and output interface 162 and performs various kinds of control with respect to the gas sensor unit 1730 and the drive device 150. The configurations of those described above are the same as those in Embodiment A1 described above.

Next, a procedure for performing gas leak detection with respect to the seventh workpiece 1W7 in the gas leak detection device 17 according to the present embodiment will be described. First, as shown in FIG. 7A, the seventh workpiece 1W7 is inserted into the chamber 110 via the upper opening 115A of the chamber 110 with the upper opening 115A opened and the upper opening 115A is closed by means of the closing member 115. In this manner, the inside of the chamber 110 and a space outside the seventh workpiece 1W7 are made airtight.

When the upper opening 115A is closed, the cap attachment portion 1WB of the seventh workpiece 1W7 is sealed up by means of the first lid portion 1721 of the lid member 1720 by using the lid member 1720. Therefore, the first gas sensor device 1731 and the first filter 1733 are exposed inside the workpiece main body portion 1W7A and the second gas sensor device 1732 and the second filter 1734 are disposed outside the workpiece main body portion 1W7A.

Next, valves provided on pipes connected to the intake ports 112 of the chamber 110 and valves provided on pipes connected to the exhaust ports 113 are opened. When the valves are opened, the tracer gas 1G is introduced into the space between the workpiece main body portion 1W7A and the accommodation portion 111 and air or the tracer gas 1G of a low concentration in the chamber 110 is discharged. In this manner, the inside of the chamber 110 and the outside of the seventh workpiece 1W7 are filled with the tracer gas 1G.

Next, the concentration of the tracer gas 1G inside the workpiece main body portion 1W7A is measured by means of the first gas sensor device 1731.

The first gas sensor device 1731 is a sensor suitable for detection performed at a time when the concentration of the tracer gas 1G is high. Therefore, when the magnitude of a gas leak into the seventh workpiece 1W7 is large and the concentration of the tracer gas 1G in the seventh workpiece 1W7 is high, the first gas sensor device 1731 detects a gas leak (so-called large leak). Meanwhile, when the concentration of the tracer gas 1G in the seventh workpiece 1W7 is low, the first gas sensor device 1731 may not be able to detect a gas leak.

Therefore, with respect to the seventh workpiece 1W7 from which no gas leak has been detected by the first gas sensor device 1731, a gas leak detection is performed by the second gas sensor device 1732, which exhibits a high detection accuracy even in a low-concentration atmosphere, after the gas leak detection performed by the first gas sensor device 1731 is finished. Therefore, as shown in FIG. 7B, the lid member 1720 is lowered toward the inside of the workpiece main body portion 1W7A by means of the drive device 150 and a lid portion closing the opening in the cap attachment portion 1WB is switched from the first lid portion 1721 to the second lid portion 1722. At this time, both of the first gas sensor device 1731 and the second gas sensor device 1732 are exposed inside the workpiece main body portion 1W7A of the seventh workpiece 1W7 together with the first filter 1733 and the second filter 1734.

In this state, the concentration of the tracer gas 1G inside the workpiece main body portion 1W7A is measured by means of the second gas sensor device 1732.

The second gas sensor device 1732 is a sensor suitable for detection performed at a time when the concentration of the tracer gas 1G is low. Therefore, when the magnitude of a gas leak into the seventh workpiece 1W7 is not large and the concentration of the tracer gas 1G in the seventh workpiece 1W7 is low even though there is a gas leak, the gas leak is detected by the second gas sensor device 1732 although the gas leak is not detected by the first gas sensor device 1731. In this manner, gas leak detection with respect to the seventh workpiece 1W7 is performed.

When the gas leak detection is finished, the tracer gas 1G in the space between the workpiece main body portion 1WA and the accommodation portion 111 is discharged to the outside of the chamber 110 via the exhaust ports 113. Then, the seventh workpiece 1W7 is extracted from the accommodation portion 111.

As described above, in the case of the gas leak detection device 17 in the present embodiment, inspection is consecutively performed by means of two types of gas sensors different in adaptation concentration. Since two types of gas leak inspection can be performed with a simple structure by which only the positions of the gas sensors are moved, it is possible to shorten a time taken for inspection and reduce the size of an inspection device.

In addition, in Embodiment A7, the circulation device 140 (refer to FIG. 1) as in Embodiment A1 is not provided. However, the invention is not limited to such a configuration. The circulation device 140 may be provided and the circulation device 140 may be able to be driven by means of the drive device 150. A specific example of a case where the circulation device 140 is provided will be described. As a lid member, a first lid portion, a second lid portion, and a third lid portion are stacked to form three layers. The circulation device 140 is provided on the first lid portion at the lowermost layer. The first gas sensor device 1731 which is suitable for detection of the tracer gas 1G for a high concentration is provided on the second lid portion which is at a layer above the first lid portion. The second gas sensor device 1732 which is suitable for detection of the tracer gas 1G for a low concentration is provided on the third lid portion which is at a layer above the second lid portion. Note that, at the time of a switch between a first stage and a second stage of leak inspection, to which of a plurality of gas sensors an atmospheric gas in the seventh workpiece 1W7 is introduced may be switched by means of an electromagnetic valve or the like instead of changing a gas sensor device to be exposed inside the seventh workpiece 1W7 by means of the drive device 150.

Hereinabove, the embodiments of the present invention have been described in detail with reference to the drawings. However, the specific configuration is not limited to those embodiments and also includes a change or the like in design without departing from the gist of the present invention.

For example, in the case of the gas leak detection devices of Embodiment A1, Embodiment A2, and the like, the gas sensor device 130 is attached to the lower surface of the lid member 120. However, the invention is not limited to such a configuration. For example, the gas sensor device 130 may be provided in a probe. In this case, the probe may be provided with a suction pump, a flow meter, a control device, and the like, and the pressure inside the workpiece 1W may be adjusted to be a negative pressure lower than the atmospheric pressure.

In addition, in the case of the gas leak detection device of each embodiment and the like, an actuator provided with the air cylinder 151 or the air cylinder 1251 is used as the drive device 150 or the drive device 1250. However, the invention is not limited to such a configuration and another actuator may also be used. For example, a hydraulic pressure, an electromagnetic (motor, solenoid), piezoelectricity, static electricity, magnetostriction, a shape-memory alloy, bimetal, a conductive polymer, and an actuator such as a zip chain may also be used.

In addition, in the above-described embodiments, the pressure in the chamber 110 and the like is not adjusted. However the invention is not limited to such a case. For example, the pressure in the chamber (pressure inside chamber and pressure outside workpiece 1W) may be adjusted to be higher than the pressure inside the workpiece 1W. Accordingly, the tracer gas 1G in the chamber becomes likely to flow into the workpiece 1W and thus it is possible to contribute to reduction of a time taken for inspection and an increase in sensitivity of a gas sensor or the like. In this case, it is preferable that a difference between the pressure in the chamber and the pressure in the workpiece 1W falls within a range in which the workpiece 1W is not deformed.

In addition, in each of the above-described embodiments and the modification examples, the gas leak detection device includes a plurality of gas sensors. However the number of gas sensors may be one. In addition, the other configuration examples described in the above embodiments and the modification examples may be appropriately applied to other embodiments and modification examples.

### Embodiment B1

Hereinafter, the description will be made to a workpiece inspection device that performs various kinds of inspection in a state where a workpiece is disposed in a chamber (inspection chamber) filled with an inspection gas. Japanese Unexamined Patent Application, First Publication No. 2012-047651 discloses, as a workpiece inspection device, a gas leak inspection device (leak detection device) that inspects a workpiece disposed in the chamber for a gas leak of a tracer gas (inspection gas) in a chamber into a workpiece.

However, in the case of the above-described workpiece inspection device, no examination has been performed about an outflow of the inspection gas at the time of insertion and removal of the workpiece with respect to the inspection chamber. Therefore, in the case of the workpiece inspection device, it is necessary to fill the inspection chamber with the inspection gas after the workpiece is inserted into the inspection chamber. As a result, there is a problem that it takes a long time to inspect the workpiece.

Meanwhile, trying to perform workpiece inspection at a high speed results in a problem that the concentration of the inspection gas in the inspection chamber becomes low and thus it becomes difficult to perform the workpiece inspection with a high sensitivity.

In addition, there is also a problem that the cost of workpiece inspection becomes high when the inspection gas flows to the outside of the inspection chamber each time the workpiece is inserted into and removed from the inspection chamber.

An example of an object of an embodiment described below is to provide a workpiece inspection device with which it is possible to achieve an increase in workpiece inspection speed, an increase in workpiece inspection sensitivity, and a decrease in workpiece inspection cost.

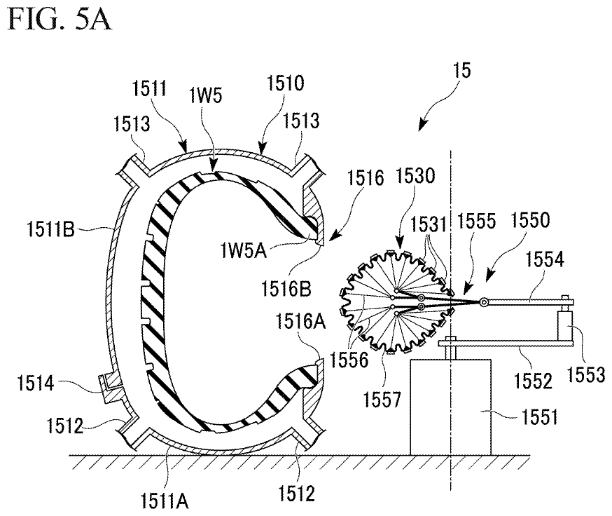

Hereinafter, Embodiment B1 of the present invention will be described with reference to FIGS. 8 to 16.

As shown in FIG. 8, a workpiece inspection device 21 according to the present embodiment is a gas leak inspection device that inspects a hollow workpiece 21000 for a gas leak.

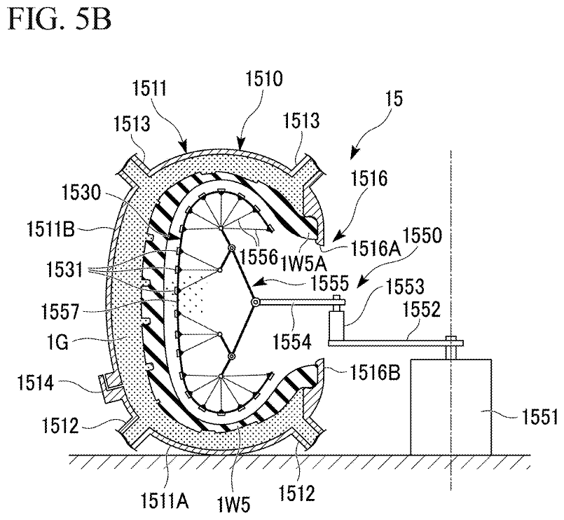

The workpiece 21000, which is an inspection target, may have any shape and size. The workpiece 21000 in the present embodiment includes an opening portion 21001 that connects a space inside the workpiece 21000 and the outside of the workpiece 21000 to each other. The workpiece 21000 may be, for example, a cylindrical can such as a drum can. As shown in FIGS. 8 and 9, the workpiece 21000 in the present embodiment has a quadrangular pillar-like appearance like an 18-liter square can. The opening portion 21001 of the workpiece 21000 is positioned at an end portion of the workpiece 21000 in an axial direction. The workpiece inspection device 21 may be the gas leak detection device 11.

As shown in FIG. 8, the workpiece inspection device 21 is provided with an inspection chamber 22, an inspection unit 23, and a gas leak suppression structure 24.

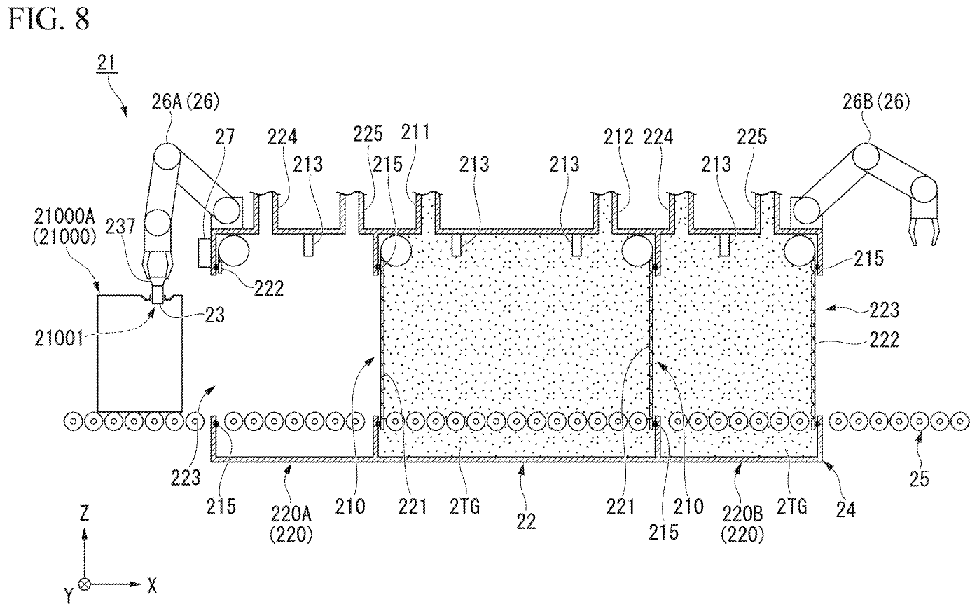

The inspection chamber 22 includes entrances 210 for insertion and removal of the workpiece 21000. The number of entrances 210 of the inspection chamber 22 may be one or more. However, in the present embodiment, the number of entrances 210 is two. The two entrances 210 may face different directions. However, the entrances 210 face the same direction (X-axis direction (hereinafter, may be referred to as “one direction”)) in the present embodiment. The two entrances 210 are arranged in the one direction. The inspection chamber 22 may have any size. However, in the present embodiment, the inspection chamber 22 is large enough to accommodate a plurality of (two in drawing) the workpieces 21000 arranged in the one direction (for example, refer to FIG. 14).

The inspection chamber 22 is configured to be filled with an inspection gas 2TG different from atmospheric air (air). Specifically, the inspection chamber 22 includes an intake port 211 for introducing the inspection gas 2TG into the inspection chamber 22. A supply source (not shown) of the inspection gas 2TG is connected to the intake port 211 of the inspection chamber 22.

In addition, the inspection chamber 22 also includes an exhaust port 212 for discharging a gas such as the inspection gas 2TG from the inside of the inspection chamber 22. The exhaust port 212 of the inspection chamber 22 may be opened to the outside (atmosphere) of the inspection chamber 22 when the inspection gas 2TG is to be discharged from the inspection chamber 22, for example. The exhaust port 212 may be connected to, for example, a recovery device for the inspection gas 2TG. In this case, the inspection gas 2TG in the inspection chamber 22 can be recovered and used repeatedly, that is, the amount of the inspection gas 2TG used in workpiece inspection can be reduced.

The intake port 211 and the exhaust port 212 may be provided at any position in the inspection chamber 22. However, in the present embodiment, the intake port 211 and the exhaust port 212 are provided in a top portion (wall portion of inspection chamber 22 that is positioned on Z-axis positive direction side in FIG. 8) of the inspection chamber 22. In addition, in the present embodiment, the intake port 211 and the exhaust port 212 are arranged at an interval in the one direction (X-axis direction) in which the two entrances 210 are arranged.

In the inspection chamber 22 in the present embodiment, probes 213 for measuring the concentration of the inspection gas 2TG in the inspection chamber 22 are provided. The probes 213 in the present embodiment are configured to measure the pressure (air pressure) in the inspection chamber 22 as well. In addition, the probes 213 may be configured to measure the temperature of the inside of the inspection chamber 22.

In the present embodiment, a plurality of the probes 213 are arranged at regular intervals.

Data about the concentration of the inspection gas 2TG, the pressure in the inspection chamber 22, and the like which are measured by the probes 213 in the inspection chamber 22 is transmitted to a controller 27, which will be described later, by means of wired communication or wireless communication.

The gas leak suppression structure 24 suppresses a leak of the inspection gas 2TG in the inspection chamber 22 that occurs when the workpiece 21000 is inserted into and removed from the inspection chamber 22. The gas leak suppression structure 24 in the present embodiment is provided with preparation chambers 220, first doors 221, and second doors 222.

The preparation chambers 220 are provided to be connected to the entrances 210 of the inspection chamber 22. That is, the preparation chambers 220 are connected to the inspection chamber 22 through the entrances 210 of the inspection chamber 22. The preparation chambers 220 include openings 223 that lead to the outside of the workpiece inspection device 21. The openings 223 of the preparation chambers 220 may face a direction different from a direction that the entrances 210 of the inspection chamber 22 face, for example. However, the openings 223 face the same direction (one direction) as the entrances 210 in the present embodiment. The openings 223 of the preparation chambers 220 and the entrances 210 of the inspection chamber 22 are arranged in the one direction.

The preparation chambers 220 are configured to be filled with the inspection gas 2TG, as with the inspection chamber 22. That is, the preparation chambers 220 include intake ports 224 that are the same as that of the inspection chamber 22. In addition, the preparation chambers 220 also include exhaust ports 225 that are the same as that of the inspection chamber 22.

The same probes 213 as those in the inspection chamber 22 are provided in the preparation chambers 220 in the present embodiment. The number of probes 213 provided in each preparation chamber 220 may be any number and is one in the present embodiment.

The above-described preparation chambers 220 are provided to be respectively connected to the two entrances 210 of the inspection chamber 22. That is, the workpiece inspection device 21 in the present embodiment is provided with two preparation chambers 220 as described above. The openings 223 of the two preparation chambers 220 are arranged in the one direction along with the two entrances 210 of the inspection chamber 22. In the following description, the two preparation chambers 220 may be referred to as a first preparation chamber 220A and a second preparation chamber 220B, respectively.

The first doors 221 are respectively provided for the entrances 210 of the inspection chamber 22 such that the entrances 210 of the inspection chamber 22 can be opened and closed.

The first doors 221 are provided such that the inspection gas 2TG in the inspection chamber 22 does not leak out of the inspection chamber 22 (to preparation chambers 220 in present embodiment) via the entrances 210 in a state where the entrances 210 of the inspection chamber 22 are closed. In the present embodiment, sealing materials 215 that fill gaps between the entrances 210 and portions of the first doors 221 close to the entrances 210 are provided in regions near the entrances 210 of the inspection chamber 22. Accordingly, the inspection gas 2TG in the inspection chamber 22 can be prevented or restrained from leaking to the outside of the inspection chamber 22 via the entrances 210 in a state where the entrances 210 of the inspection chamber 22 are closed by the first doors 221.

The second doors 222 are respectively provided for the openings 223 of the preparation chambers 220 such that the openings 223 of the preparation chambers 220 can be opened and closed.

The second doors 222 are provided such that the inspection gas 2TG in the preparation chambers 220 does not leak out of the preparation chambers 220 via the openings 223 in a state where the openings 223 of the preparation chambers 220 are closed. The structures of the second doors 222 are the same as those of the first doors 221.

The first doors 221 and the second doors 222 described above may be, for example, sliding doors or hinged doors. In the present embodiment, the first doors 221 and the second doors 222 are shutters that open the entrances 210 of the inspection chamber 22 or the openings 223 of the preparation chambers 220 when being wound.

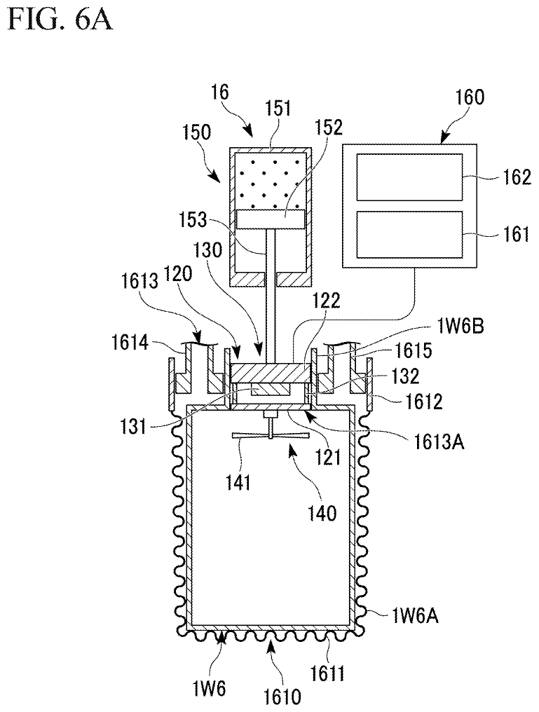

The inspection unit 23 inspects the workpiece 21000 at least in the inspection chamber 22. As shown in FIGS. 8 and 10, the inspection unit 23 in the present embodiment is provided with a gas sensor 230 that detects the inspection gas 2TG leaking into the workpiece 21000 from the inside of the inspection chamber 22. Specifically, the gas sensor 230 measures the concentration of the inspection gas 2TG. The number of gas sensors 230 may be any number and is one in the drawing.

In the present embodiment, the gas sensor 230 needs to be disposed inside the workpiece 21000 in order to detect the inspection gas 2TG that enters the workpiece 21000 from the inspection chamber 22. Therefore, the inspection unit 23 in the present embodiment is provided with a wireless module 231 and transmits data about the concentration of the inspection gas 2TG measured by the gas sensor 230 to the controller 27, which will be described later, by means of wireless communication.

The inspection unit 23 in the present embodiment is provided with a control circuit unit 232 and a power supply unit 233. The control circuit unit 232 controls the operation of the gas sensor 230 or the wireless module 231. The power supply unit 233 supplies power to the gas sensor 230, the control circuit unit 232, or the wireless module 231.

In the inspection unit 23 shown in the drawing, the wireless module 231, the control circuit unit 232, and the power supply unit 233 are disposed in a housing 234 and the gas sensor 230 is disposed on an outer surface of the housing 234. However, the invention is not limited to such a configuration. In the inspection unit 23, at least the gas sensor 230, the wireless module 231, the control circuit unit 232, and the power supply unit 233 may be integrated with each other.

As shown in FIGS. 8 and 10, the inspection unit 23 in the present embodiment is integrally fixed to a closing portion 237 that airtightly closes the opening portion 21001 of the workpiece 21000. The inspection unit 23 is configured such that the gas sensor 230 is disposed inside the workpiece when the opening portion 21001 of the workpiece 21000 is closed by the closing portion 237.

As shown in FIG. 8, the workpiece inspection device 21 in the present embodiment is further provided with a workpiece transportation mechanism 25 with which the workpiece 21000 is inserted into and removed from the inspection chamber 22 or the preparation chambers 220. In the present embodiment, after the workpiece transportation mechanism 25 transports the workpiece 21000 into the first preparation chamber 220A, the workpiece transportation mechanism 25 transports the workpiece 21000 into the inspection chamber 22 and the second preparation chamber 220B in this order and transports the workpiece 21000 to the outside of the second preparation chamber 220B.

The workpiece transportation mechanism 25 may be a roller conveyor as shown in the drawing and may be, for example, a belt conveyor formed in a meshed belt-shape.

The workpiece inspection device 21 in the present embodiment is further provided with robot arms 26 for attaching and removing the inspection unit 23 to and from the workpiece 21000. The robot arms 26 are respectively disposed on a front side of the first preparation chamber 220A and a rear side of the second preparation chamber 220B in a direction (X-axis positive direction) in which the workpiece 21000 is transported by the workpiece transportation mechanism 25. A first robot arm 26A attaches the inspection unit 23 to the workpiece 21000 before transportation into the first preparation chamber 220A. A second robot arm 26B removes the inspection unit 23 from the workpiece 21000 after transportation out of the second preparation chamber 220B.

The workpiece inspection device 21 in the present embodiment is further provided with the controller 27. The controller 27 includes a wireless module and a control circuit unit (both are not shown).

The wireless module of the controller 27 receives data about the concentration of the inspection gas 2TG transmitted from the wireless module 231 of the inspection unit 23. The wireless module of the controller 27 may receive data about the concentration of the inspection gas 2TG, the pressure in the inspection chamber 22 or the preparation chambers 220, and the like which are measured by the probes 213 in the inspection chamber 22 or the preparation chambers 220.

The control circuit unit of the controller 27 controls supply and discharge of the inspection gas 2TG and the like with respect to the inspection chamber 22 or the preparation chambers 220, and an opening and closing operation of the first doors 221 and the second doors 222. In addition, the control circuit of the controller 27 controls the operations of the robot arms 26 described above.

The control circuit unit of the controller 27 includes determination means (not shown) for determining whether or not there is a gas leak into the workpiece 21000 based on the concentration of the inspection gas 2TG measured by the gas sensor 230. The determination means (determination unit) determines that “the workpiece 21000 is a non-defective product with no gas leak (there is no defect such as hole in workpiece 21000)” in a case where the concentration of the inspection gas 2TG measured by the gas sensor 230 is lower than a predetermined threshold value. In addition, the determination means determines that “the workpiece 21000 is a defective product with a gas leak (there is defect such as hole in workpiece 21000)” in a case where the concentration of the inspection gas 2TG measured by the gas sensor 230 is equal to or higher than the predetermined threshold value.

The controller 27 may include an input and output interface (not shown) such as a liquid crystal with a touch panel.

The inspection gas 2TG (tracer gas) used in the workpiece inspection device 21 in the present embodiment configured as described above is not particularly limited. The inspection gas 2TG may contain, for example, a flammable gas such as hydrogen and may include an inert gas such as helium.

The inspection gas 2TG containing hydrogen may be a mixed gas of 5% hydrogen and 95% nitrogen and may be a mixed gas of 3.9% hydrogen and 96.1% air. In a case where the inspection gas 2TG containing a flammable gas such as hydrogen is used, contact combustion type gas sensors may be used as the gas sensor 230 of the inspection unit 23 and the probes 213 provided in the inspection chamber 22 or the preparation chambers 220.

The inspection gas 2TG containing an inert gas may be, for example, a 100% helium gas or a 100% carbon dioxide gas. In a case where the inspection gas 2TG containing an inert gas is used, heat conduction type gas sensors may be used as the gas sensor 230 of the inspection unit 23 and the probes 213 provided in the inspection chamber 22 or the preparation chambers 220.

Instead of the contact combustion type gas sensors or the heat conduction type gas sensors as described above, semiconductor type gas sensors, electrochemical type gas sensors, non-dispersive infrared (NDIR) absorption type gas sensors, or the like may also be used as the gas sensor 230 of the inspection unit 23 and the probes 213 provided in the inspection chamber 22 or the preparation chambers 220.

Next, an example of a workpiece inspection method in which the workpiece inspection device 21 in the present embodiment is used will be described. hi the following description, the inspection gas 2TG is a mixed gas of 5% hydrogen and 95% nitrogen.

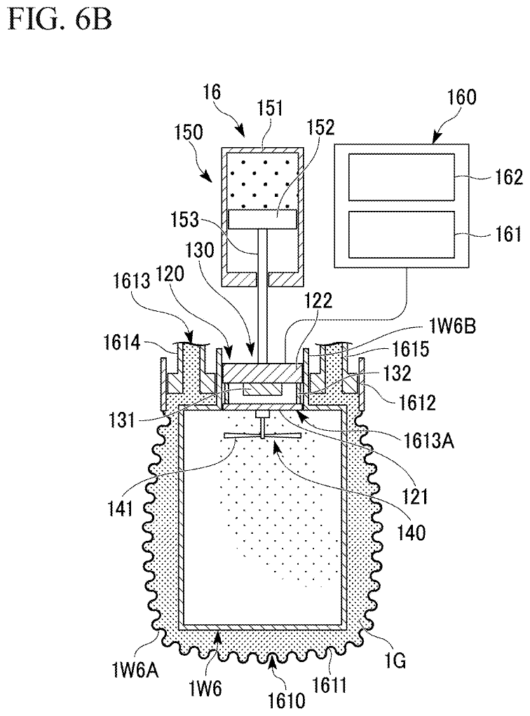

FIGS. 11 to 16 show a state where three workpieces 21000 (first workpiece 21000A, second workpiece 21000B, and third workpiece 21000C) are consecutively inspected. Outside the first preparation chamber 220A, the inspection unit 23 is attached to each workpiece 21000 by the first robot arm 26A. Then, after each workpiece is transported to the first preparation chamber 220A, the inspection chamber 22, and the second preparation chamber 220B by means of the workpiece transportation mechanism 25, each workpiece is transported to the outside of the second preparation chamber 220B and the inspection unit 23 is removed by the second robot arm 26B. The doors 221 and 222 are provided for the openings 223 of the preparation chambers 220 and the entrances 210 of the inspection chamber 22. The doors 221 and 222 are closed usually and are controlled to be opened only when the workpiece 21000 passes therethrough.

FIG. 11 shows a state where the first workpiece 21000A enters the first preparation chamber 220A at the time of the start of inspection. In this state, the first preparation chamber 220A is not filled with the inspection gas 2TG, but the inspection chamber 22 and the second preparation chamber 220B are filled with the inspection gas 2TG in preparation for the inspection.

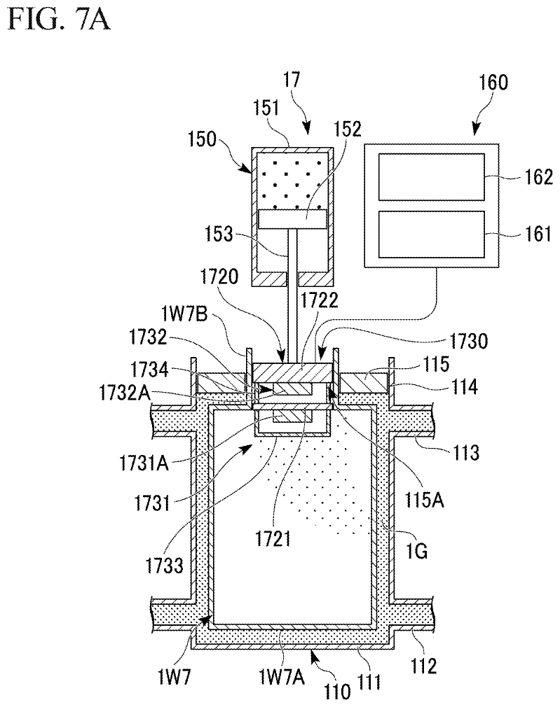

Next, as shown in FIG. 12, the first preparation chamber 220A is filled with the inspection gas 2TG. At this time, the inspection gas 2TG is introduced via the intake port 224 and a gas in the first preparation chamber 220A is discarded via the exhaust port 225 such that the hydrogen concentration and the pressure in the first preparation chamber 220A are increased. Accordingly, external air can be restrained or prevented from entering the first preparation chamber 220A through the opening 223 of the first preparation chamber 220A.

When the hydrogen concentration and the pressure in the first preparation chamber 220A reach specified values (for example, hydrogen concentration of 4.5% and pressure of 1.1 atm), the first workpiece 21000A is transported to the inspection chamber 22. At this time, when the hydrogen concentration or the pressure in the inspection chamber 22 is set to be higher than that in the first preparation chamber 220A (for example, hydrogen concentration of 4.8% or pressure of 1.2 atm), a decrease in hydrogen concentration in the inspection chamber 22 can be suppressed or prevented. When the first workpiece 21000A enters the inspection chamber 22, the hydrogen concentration in the first workpiece 21000A is measured by the gas sensor 230 of the inspection unit 23 and the controller 27 determines whether the first workpiece 21000A is a defective product or a non-defective product based on the measured hydrogen concentration.

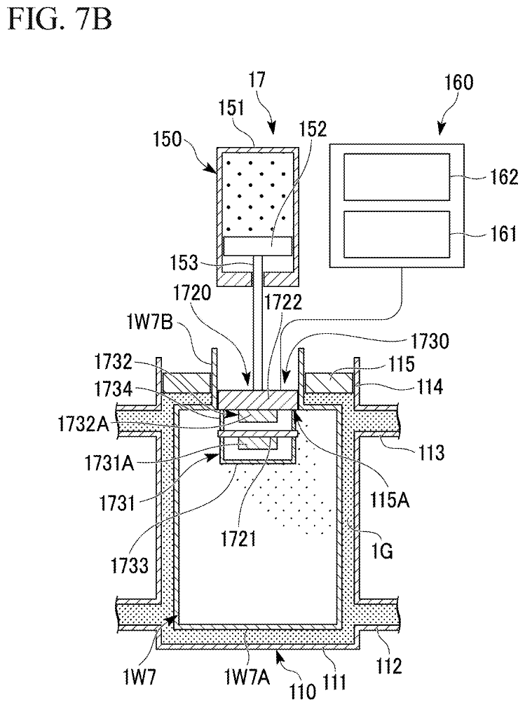

After the first workpiece 21000A enters the inspection chamber 22, the inspection gas 2TG, with which the first preparation chamber 220A is filled, is discharged (recovered or discarded) via the exhaust port 225. This is because of preparation for transportation of the second workpiece 21000B to the first preparation chamber 220A. Thereafter, the second door 222 of the first preparation chamber 220A is opened and the second workpiece 21000B is transported to the first preparation chamber 220A (FIG. 13). After the second workpiece 21000B enters the first preparation chamber 220A, the first preparation chamber 220A is filled with the inspection gas 2TG again and the second workpiece 21000B is transported to the inspection chamber 22 (FIG. 14). At this time, a decrease in hydrogen concentration in the inspection chamber 22 is suppressed as described above.

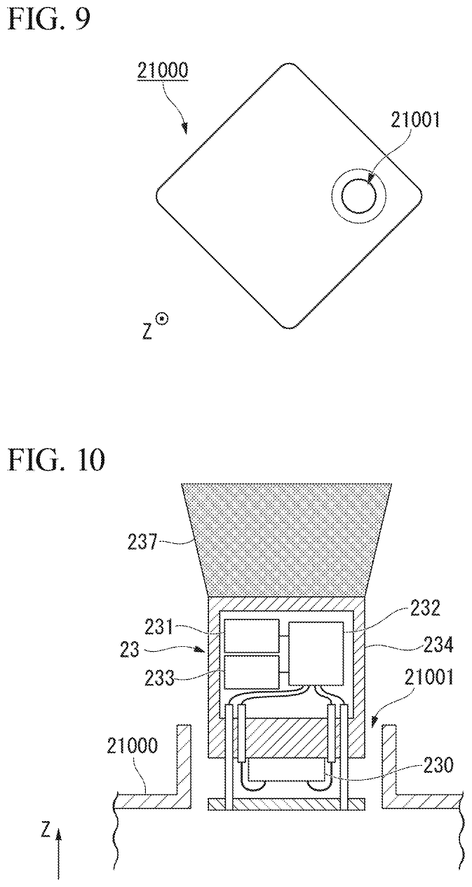

While inspection of the second workpiece 21000B is started in the inspection chamber 22 in this manner, the first workpiece 21000A, of which inspection is finished, is transported from the inspection chamber 22 to the second preparation chamber 220B. As shown in FIG. 15, the second preparation chamber 220B is also filled with the inspection gas 2TG. Therefore, it is possible to transport the first workpiece 21000A to the second preparation chamber 220B while preventing a decrease in hydrogen concentration in the inspection chamber 22.

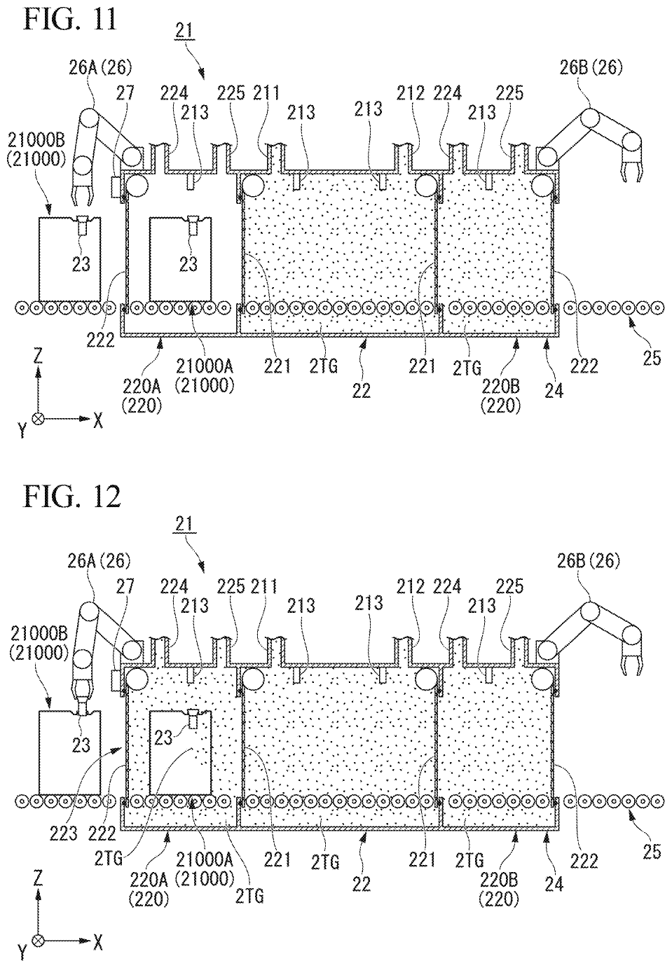

After the first workpiece 21000A is transported to the second preparation chamber 220B and the first door 221 on the second preparation chamber 220B side is closed, the inspection gas 2TG, with which the second preparation chamber 220B is filled, is discharged via the exhaust port 225. This is because of preparation for transportation of the first workpiece 21000A to the outside of the second preparation chamber 220B. Thereafter, the first workpiece 21000A is transferred to the outside of the second preparation chamber 220B (FIG. 16).

A step of transporting the second workpiece 21000B positioned in the inspection chamber 22 to the second preparation chamber 220B and transporting the second workpiece 21000B to the outside and a step of inspecting the third workpiece 21000C are performed in the same manner as the case of the first workpiece 21000A.

As described above, with the workpiece inspection method in the present embodiment, gas leak inspection with respect to the plurality of workpieces 21000 can be consecutively performed. The workpiece inspection method is finished when the last workpiece 21000 is transported to the outside from the second preparation chamber 220B.

In the case of the above-described workpiece inspection method, for example, the first workpiece 21000A undergoes the maximum hydrogen concentration and pressure (for example, hydrogen concentration of 4.8% and pressure of 1.2 atm) during a period between when the inspection gas 2TG is supplied into the first preparation chamber 220A (state shown in FIG. 12) and when the second workpiece 21000B is transported to the inspection chamber 22 (state shown in FIG. 14). Therefore, it is preferable that whether or not the first workpiece 21000A is acceptable is determined before the second workpiece 21000B is transported to the inspection chamber 22. However, in a case where the hydrogen concentration in the inspection chamber 22 is uniformized late, measurement of the hydrogen concentration in the first workpiece 21000A may be continued until the first workpiece 21000A is transported to the second preparation chamber 220B from the inspection chamber 22 and the inspection gas 2TG is extracted from the second preparation chamber 220B.

In addition, in the case of the above-described workpiece inspection method, for example, in order to promote uniformization of the hydrogen concentration in the workpiece 21000, a stirring unit such as a fan may be provided in the inspection unit 23 to stir a gas in the workpiece 21000 or a transportation distance in the inspection chamber 22 may be increased such that the workpiece 21000 stays in the inspection chamber 22 for a long time.

As described above, according to the workpiece inspection device 21 in the present embodiment, it is possible to restrain the inspection gas 2TG in the inspection chamber 22 from leaking due to insertion and removal of the workpiece 21000 with respect to the inspection chamber 22, by means of the gas leak suppression structure 24. Therefore, it is possible to suppress a decrease in concentration of the inspection gas 2TG in the inspection chamber 22 and to expose the workpiece 21000 inserted into the inspection chamber 22 to the inspection gas 2TG of a high concentration in a short time. Therefore, it is possible to achieve an increase in workpiece inspection (gas leak inspection) speed and an increase in sensitivity. In addition, since the inspection gas 2TG in the inspection chamber 22 is restrained from leaking by the gas leak suppression structure 24, it is also possible to achieve a decrease in workpiece inspection cost.

Particularly, in the workpiece inspection device 21 in the present embodiment, the gas leak suppression structure 24 is provided with the preparation chambers 220 provided to be connected to the entrances 210 of the inspection chamber 22, the first doors 221 that open and close the entrances 210 of the inspection chamber 22, and the second doors 222 that open and close the openings 223 of the preparation chambers 220. Accordingly, a leak of the inspection gas 2TG in the inspection chamber 22 can be reliably reduced.

Furthermore, according to the workpiece inspection device 21 in the present embodiment, the preparation chambers 220 are provided to be connected to the two entrances 210 of the inspection chamber 22, respectively. Accordingly, the workpiece 21000 can be transported in the one direction such that the workpiece 21000 passes through the inspection chamber 22. That is, it is possible to inspect a large number of the workpieces 21000 at a high speed.

In addition, since the inspection chamber 22 is disposed between the two preparation chambers 220, the concentration of the inspection gas 2TG and the pressure in the inspection chamber 22 are stabilized. Therefore, workpiece inspection with a high reproducibility can be realized.

The workpiece inspection device 21 in Embodiment B1 may be provided with, for example, one inspection chamber 22 and one preparation chamber 220. In this case, the preparation chamber 220 may have the same role as a load lock chamber used in a semiconductor manufacturing apparatus or the like. With such a configuration, it is possible to reduce the size and cost of the workpiece inspection device 21 in comparison with a case where there two preparation chambers 220 are provided.

### Embodiment B2

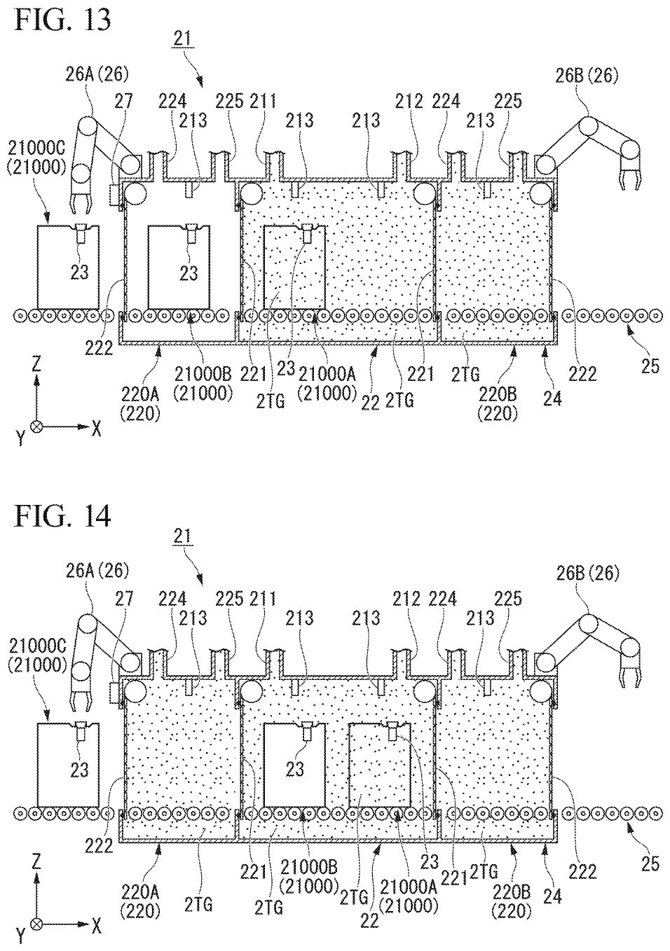

Next, Embodiment B2 of the present invention will be described with reference to FIGS. 17 to 20. In the present embodiment, differences from Embodiment B1 will be mainly described. In the present embodiment, the same components as those in Embodiment B1 are denoted by the same reference numerals and the description thereof will be omitted.

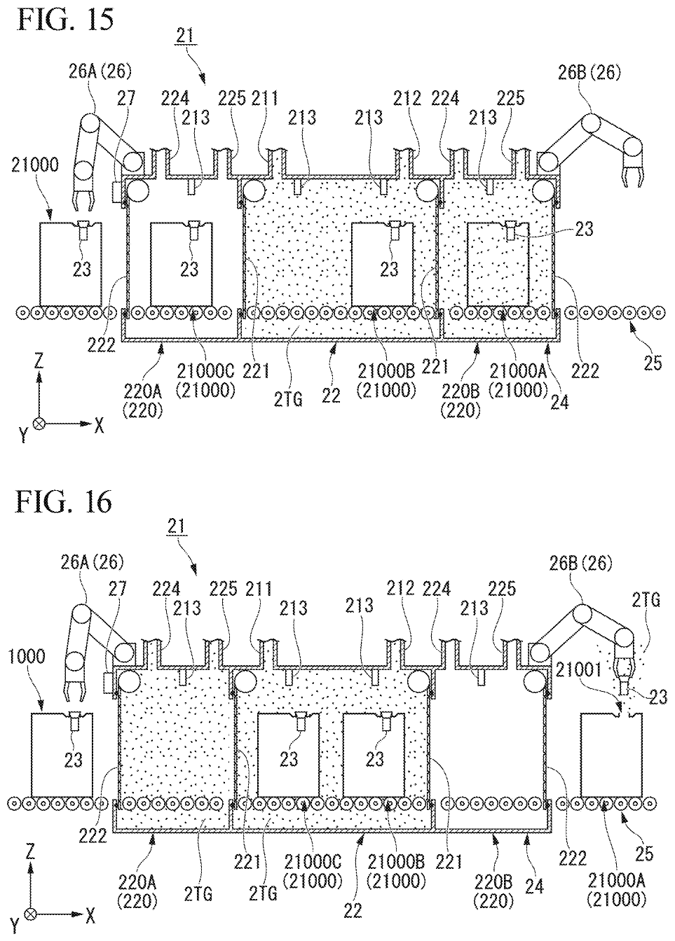

As shown in FIGS. 17 and 18, a workpiece inspection device 2101 in the present embodiment is a gas leak inspection device that inspects the hollow workpiece 21000 for a gas leak, as with Embodiment B1. The workpiece inspection device 2101 is provided with the inspection chamber 22, the inspection unit 23, and a gas leak suppression structure 2104. The configurations of the workpiece 21000, the inspection chamber 22, and the inspection unit 23 are the same as those in Embodiment B1.

The gas leak suppression structure 2104 in the present embodiment is provided with the preparation chambers 220, first doors 2121, and second doors 2122, as with Embodiment B1. The configurations of the preparation chambers 220 are the same as those in Embodiment B1.

In the present embodiment, the shapes and sizes of the entrances 210 of the inspection chamber 22 including edges of the first doors 2121 or the shapes and sizes of the openings 223 of the preparation chambers 220 including edges of the second doors 2122 change in accordance with the shape and the size of the workpiece 21000 passing through the entrances 210 of the inspection chamber 22 or the openings 223 of the preparation chambers 220 in response to the operations of the doors 2121 and 2122. Hereinafter, this point will be specifically described.

Each of the first doors 2121 and the second doors 2122 in the present embodiment is provided with a pair of sliding doors 2126. That is, the size of the entrance 210 of the inspection chamber 22 or the opening 223 of the preparation chamber 220 changes in accordance with whether a pair of sliding doors 2126 is open or closed. A direction in which the pair of the sliding doors 2126 moves is a direction (Y-axis direction) orthogonal to the one direction (X-axis direction) which the entrances 210 of the inspection chamber 22 and the openings 223 of the preparation chambers 220 face.

The sliding doors 2126 are moved by an actuator 2127 (for example, zip chain actuator and drive mechanism that is same as that of automatic sliding door) and movement thereof is controlled by the controller 27. The operation of a pair of sliding doors 2126 is controlled such that the workpiece 21000 is interposed between the pair of sliding doors 2126 when the workpiece 21000 passes through the entrance 210 of the inspection chamber 22 or the opening 223 of the preparation chamber 220. That is, the operation of the pair of sliding doors 2126 (operations of first door 2121 and second door 2122) is controlled such that the shape and size of the entrance 210 of the inspection chamber 22 or the opening 223 of the preparation chamber 220 change in accordance with the shape and size of the workpiece 21000 passing through the entrance 210 of the inspection chamber 22 or the opening 223 of the preparation chamber 220.

A pair of sliding doors 2126A for the first door 2121 may be disposed in the inspection chamber 22 or the preparation chamber 220. in the present embodiment, a pair of sliding doors 2126A (hereinafter, referred to as first sliding doors 2126A) is disposed to enter or exit sliding door accommodation portions 2118 formed at edges of the entrance 210 of the inspection chamber 22.

Gaps between inner surfaces of the sliding door accommodation portions 2118 and the first sliding doors 2126A are filled with sealing materials 2115. The sealing materials 2115 may be, for example, O-rings, mohair seals, magnetic fluids, or the like. Accordingly, the inspection gas 2TG in the inspection chamber 22 can be restrained from leaking out toward the preparation chambers 220 via the gaps between the inner surfaces of the sliding door accommodation portions 2118 and the first sliding doors 2126A.

In the present embodiment, a pair of sliding doors 2126 for the second door 2122 (hereinafter, referred to as second sliding doors 2126B) is configured in the same manner as that in the case of the first sliding doors 2126A.

Each of the doors 2121 and 2122 in the present embodiment is further provided with a pair of roller portions 2129 which is provided for each pair of sliding doors 2126. Each of a pair of roller portions 2129 is formed in a columnar shape. A pair of roller portions 2129 is provided on facing portions of a pair of sliding doors 2126.

The roller portions 2129 are provided on the sliding doors 2126. According to this configuration, even when the workpiece 21000 is interposed between a pair of sliding doors 2126 when the workpiece 21000 passes through the entrance 210 of the inspection chamber 22 or the opening 223 of the preparation chamber 220, each roller portion 2129 rotates on an outer surface of the workpiece 21000. Therefore, the workpiece 21000 can be smoothly transported.

The roller portions 2129 are formed of an elastic material such as rubber, sponge, or resin. The resin may be, for example, polypropylene, MC nylon, or high molecular polyethylene. In a case where there is a gap between the roller portion 2129 and the sliding door 2126, a sealing material such as a mohair seal or a magnetic fluid that fills the gap may be provided. Accordingly, the inspection gas 2TG in the inspection chamber 22 or the preparation chambers 220 can be restrained from leaking out of the inspection chamber 22 or the preparation chambers 220 in a state where the entrances 210 of the inspection chamber 22 or the openings 223 of the preparation chamber 220 are closed by means of the doors 2121 or 2122 and when the workpiece 21000 passes through the entrances 210 of the inspection chamber 22.

Furthermore, the gas leak suppression structure 2104 in the present embodiment is with sealing portions 2140. The sealing portions 2140 include first sealing portions 2140A provided at edges of the entrances 210 of the inspection chamber 22, and second sealing portions 2140B provided at edges of the openings 223 of the preparation chambers 220. The sealing portions 2140 are formed of, for example, rubber, a mohair seal, and a magnetic fluid. The sealing portions 2140 fill gaps in the vicinity of the workpiece 21000 when the workpiece 21000 passes through the entrances 210 or the openings 223. The sealing portions 2140 in the present embodiment are provided at portions of the edges of the entrances 210 of the inspection chamber 22 and the edges of the openings 223 of the preparation chambers 220 such that the workpiece 21000 is interposed therebetween in a Z-axis direction.

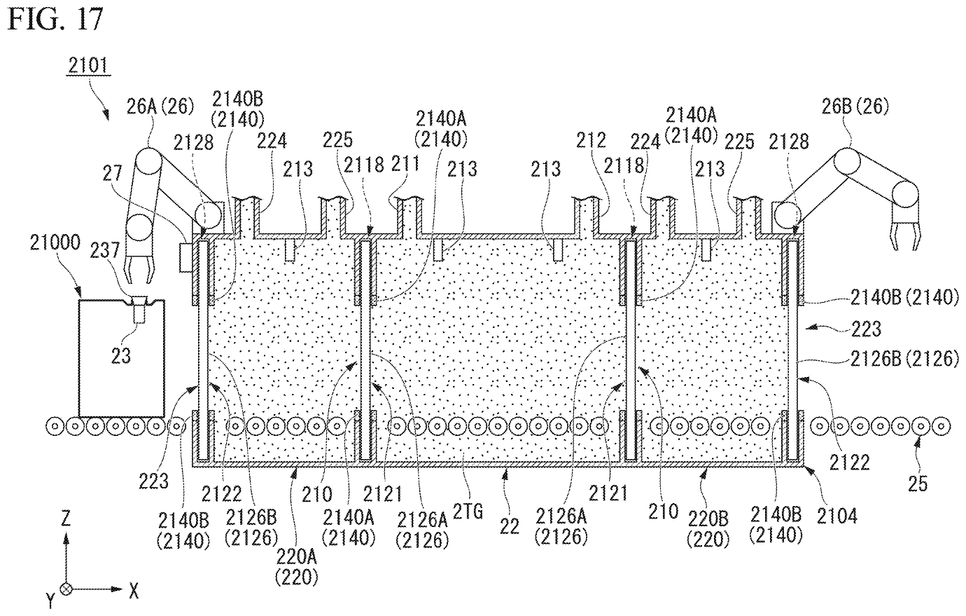

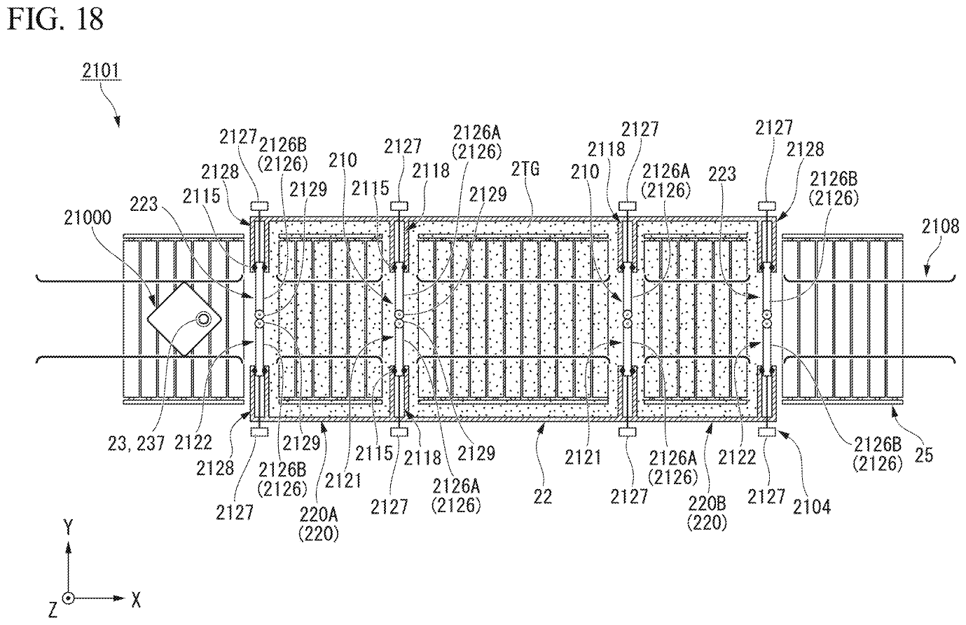

In the case of the workpiece inspection device 2101 in the present embodiment configured as described above, when the workpiece 21000 passes through the entrance 210 of the inspection chamber 22 or the opening 223 of the preparation chamber 220, the workpiece 21000 is interposed between a pair of sliding doors 2126 in the Y-axis direction and is interposed between the sealing portions 2140 in the Z-axis direction (for example, refer to portions (b) to (d) in FIG. 19 and FIG. 20). Accordingly, the inspection gas 2TG in the inspection chamber 22 can be restrained or prevented from leaking out toward the preparation chamber 220 or the inspection gas 2TG in the preparation chamber 220 can be restrained or prevented from leaking out of the preparation chamber 220 when the workpiece 21000 passes through the entrance 210 of the inspection chamber 22 or the opening 223 of the preparation chamber 220.

As shown in FIG. 18, the workpiece inspection device 2101 in the present embodiment is further provided with guides 2108 that position the workpiece 21000 transported by the workpiece transportation mechanism 25 in a direction orthogonal the direction (X-axis direction) in which the workpiece 21000 is transported.

The guides 2108 are disposed such that the workpiece 21000 is interposed therebetween in a direction (Y-axis direction) in which a pair of sliding doors 2126 moves. The guides 2108 position the workpiece 21000 such that the center of the workpiece 21000 in the Y-axis direction coincides with an abutting position between a pair of sliding doors 2126 (between roller portions 2129) in a state where the pair of sliding doors 2126 is closed.

The guides 2108 may be provided at least in front of each of the doors 2121, 2122 in the X-axis positive direction. The guides 2108 in the present embodiment are provided over the entire inspection chamber 22, over the entire preparation chambers 220, and on the outside of each of the preparation chambers 220 in the X-axis direction.

The guides 2108 may be, for example, belt-shaped guardrails of which the width in the Z-axis direction is small, roller conveyors of which the width in the Z-axis direction is small, or the like.

In a case where the workpiece inspection device 2101 is provided with the above-described guides 2108, distances by which a pair of sliding doors 2126 moves when the workpiece 21000 passes through the entrance 210 of the inspection chamber 22 or the opening 223 of the preparation chamber 220 can be made equal to each other. Therefore, it is possible to simply control the operations of the doors 2121 and 2122.

In the case of the workpiece inspection device 2101 in the present embodiment, it is possible to perform workpiece inspection (gas leak inspection with respect to workpiece 21000) in the same manner as in Embodiment B1.

An operation that is performed when the workpiece 21000 is transported into the first preparation chamber 220A by means of the workpiece transportation mechanism 25 via the opening 223 of the first preparation chamber 220A will be described. In the workpiece inspection device 2101 in the present embodiment, as shown in HG. 19, the operation of the first door 2121 (pair of first sliding doors 2126A) is controlled such that the workpiece 21000 is maintained in a state of being interposed between the pair of first sliding doors 2126A in the Y-axis direction when being transported to the inside.

Specifically, first, the workpiece 21000 is transported by means of the workpiece transportation mechanism 25 such that the workpiece 21000 is brought into contact with a pair of roller portions 129 as shown in a portion (a) in FIG. 19. Next, as shown in portions (b) and (c) in FIG. 19, the workpiece 21000 is further transported by means of the workpiece transportation mechanism 25 such that an interval between the pair of roller portions 2129 increases with the pair of first sliding doors 2126A moving away from each other as a dimension of the workpiece 21000 in the opening 223 of the first preparation chamber 220A increases in the Y-axis direction. During this control, each roller portion 2129 is maintained in a state of being in contact with an outer surface of the workpiece 21000.

Thereafter, as shown in portions (c) and (d) in FIG. 19, the workpiece 21000 is further transported by means of the workpiece transportation mechanism 25 such that the interval between the pair of roller portions 2129 decreases with the pair of first sliding doors 2126A moving toward each other as the dimension of the workpiece 21000 in the opening 223 of the first preparation chamber 220A decreases in the Y-axis direction. Lastly, as shown in a portion (f) in FIG. 19, immediately after the workpiece 21000 passes through the opening 223 of the first preparation chamber 220A, the pair of roller portions 2129 is brought into contact with each other.

In addition, when the workpiece 21000 passes through the opening 223 of the first preparation chamber 220A, as shown in FIG. 20, the workpiece 21000 is interposed between the sealing portions 2140 provided at edges of the opening 223 of the first preparation chamber 220A in the Z-axis direction.

The same applies to a case where the workpiece 21000 is transported from the first preparation chamber 220A to the inspection chamber 22, a case where the workpiece 21000 is transported from the inspection chamber 22 to the second preparation chamber 220B, and a case where the workpiece 21000 is transported from the second preparation chamber 220B to the outside of the second preparation chamber 220B.

As described above, according to the workpiece inspection device 2101 in the present embodiment, the same effects as those of Embodiment B1 can be obtained.

In addition, according to the workpiece inspection device 2101 in the present embodiment, the shapes and sizes of the entrances 210 of the inspection chamber 22 or the openings 223 of the preparation chambers 220 including the doors 2121 or 2122 change in accordance with the shape and the size of the workpiece 21000 passing through the entrances 210 of the inspection chamber 22 or the openings 223 of the preparation chambers 220. Specifically, when the workpiece 21000 passes through the entrance 210 of the inspection chamber 22 or the opening 223 of the preparation chamber 220, a pair of sliding doors 2126 moves in accordance with the shape or size of the workpiece 21000 and the workpiece 21000 is interposed between the pair of sliding doors 2126. In addition, gaps between the workpiece 21000 and edges of the entrance 210 of the inspection chamber 22 or edges of the opening 223 of the preparation chamber 220 are filled with the sealing portions 2140. Accordingly, the inspection gas 2TG can be more reliably restrained or prevented from leaking out from the inside of the inspection chamber 22 toward the preparation chamber 220 or leaking out from the inside of the preparation chamber 220 to the outside of the preparation chamber 220 in comparison with the case of Embodiment B1. That is, the amount of a leak of the inspection gas 2TG in the inspection chamber 22 can be reliably reduced.

Therefore, a time taken to adjust the concentration (hydrogen concentration) of the inspection gas 2TG in the first preparation chamber 220A or the second preparation chamber 220B can be shortened and thus it is possible to achieve a further increase in workpiece inspection speed.

In addition, in comparison with Embodiment B1, a change in concentration (hydrogen concentration) of the inspection gas 2TG in the inspection chamber 22 or the preparation chamber 220 can also be reduced and thus it is possible to achieve an increase in workpiece inspection speed and to realize workpiece inspection with a higher reproducibility.

The gas leak suppression structure 2104 in Embodiment B2 may be provided with at least the first door 2121 and may be provided with, for example, no preparation chamber 220 and no second door 2122. In this configuration, the number of entrances 210 of the inspection chamber 22 may be, for example, one or two. When the number of entrances 210 of the inspection chamber 22 is one, the workpiece 21000 may be transported into and out of the inspection chamber 22 through the same entrance 10 and the same first door 2121 of the inspection chamber 22. With the preparation chambers 220, the second doors 2122, and the like being omitted, a decrease in size and cost of the workpiece inspection device 2101 can be achieved. In addition, a distance by which the workpiece 21000 is moved can be shortened and thus an increase in workpiece inspection speed can also be achieved.

### Embodiment B3

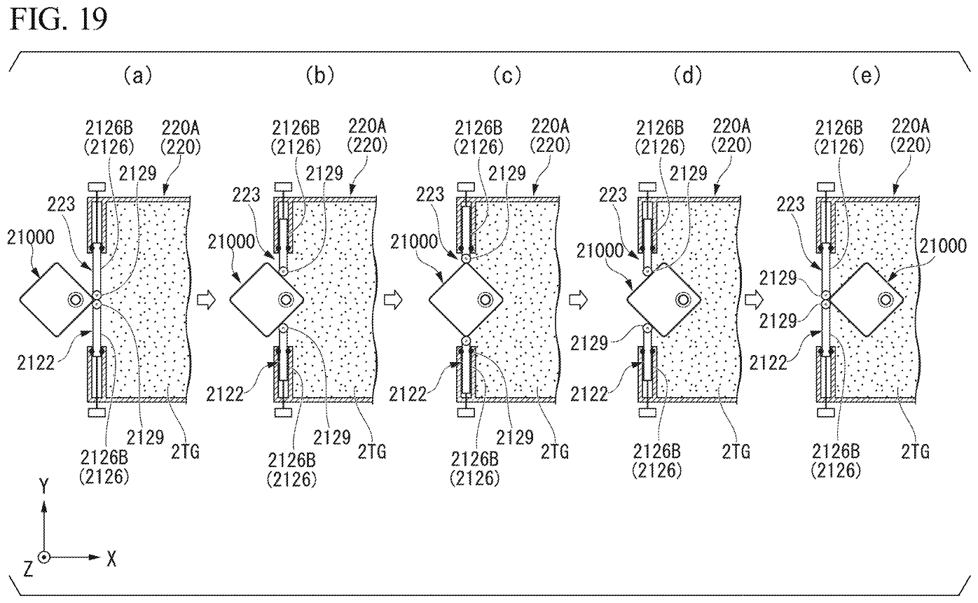

Next, Embodiment B3 of the present invention will be described with reference to FIG. 21. In the present embodiment, differences from Embodiment B2 will be mainly described. In the present embodiment, the same components as those in Embodiment B2 are denoted by the same reference numerals and the description thereof will be omitted.

As shown in a portion (a) in FIG. 21, a workpiece inspection device 2201 in the present embodiment is a gas leak inspection device that inspects a hollow workpiece 21010 for a gas leak, as with Embodiment B2. The workpiece inspection device 2201 is provided with the inspection chamber 22, the inspection unit 23, and a gas leak suppression structure 2204. Although not shown, the inspection chamber 22 in the present embodiment is configured in the same manner as that in Embodiment B2 except for a point that only one entrance 210 is provided. In addition, the configuration of the inside of the inspection chamber 22 and the configuration of the inspection unit 23 may be the same as those in the first embodiment and Embodiment B2.

In addition, although not shown, the workpiece inspection device 2201 in the present embodiment B2 is provided with the workpiece transportation mechanism 25, the robot arms 26, the controller 27, the guides 2108 (refer to FIGS. 17 and 18), and the like which are the same as those in Embodiment B2.

The gas leak suppression structure 2204 in the present embodiment is provided with no preparation chamber 220 and no second door 2122 as in Embodiment B2 but is provided with the same door 2221 as the first door 2121 in Embodiment B2. That is, the door 2221 in the present embodiment is provided with a pair of sliding doors 2226 and a pair of roller portions 2229 as with Embodiment B2.

A portion (a) in FIG. 21 shows actuators 2227, sliding door accommodation portions 2218, and sealing materials 2215. The actuators 2227 move the sliding doors 2226 in the Y-axis direction, respectively. The sliding door accommodation portions 2218 accommodate the pair of sliding doors 2226. The sliding door accommodation portions 2218 are the same as the sliding door accommodation portions 2118 in Embodiment B2. The sealing materials 2215 fill gaps between inner surfaces of the sliding door accommodation portions 2218 and the sliding doors 2226 accommodated in the sliding door accommodation portions 2218.

In the present embodiment, a workpiece accommodation recess 2241 is formed on each of circumferential surfaces of the pair of roller portions 2229. The workpiece accommodation recess 2241 accommodates a portion of the workpiece 21010. An inner surface of the workpiece accommodation recess 2241 is formed in a shape conforming to a portion of an outer surface of the workpiece 21010. Accordingly, the outer surface of the workpiece 21010 can be brought into contact with the inner surface of the workpiece accommodation recess 2241 without a gap therebetween. The workpiece 21010 in the present embodiment is a cylindrical can such as a drum can. Therefore, the cross-sectional shape of the inner surface of the workpiece accommodation recess 2241 is an arc shape corresponding to an outer circumferential surface of the workpiece 21010.

The roller portions 2229 may be formed of an elastic material such as rubber, sponge, or resin, as with the roller portions 2129 in Embodiment B2. In the present embodiment, sealing materials 2242 are formed on surfaces of the roller portions 2229. The sealing materials 2242 may be mohair seals and may be elastic bodies made of rubber or a resin material, or felt fibers. The sealing materials 2242 may be formed at least on the inner surfaces of the workpiece accommodation recesses 2241 of the roller portions 2229. In the present embodiment, the sealing materials 2242 are also formed on circumferential surfaces of the roller portions 2229.

In a case where the roller portions 2229 include the sealing materials 2242, the outer circumferential surface of the workpiece 21010 can be brought into contact with the inner surfaces of the workpiece accommodation recesses 2241 without gaps therebetween even when there is an uneven portion (like rolling hoops of drum can) on the outer circumferential surface of the workpiece 21010. That is, the inspection gas 2TG in the inspection chamber 22 can be restrained or prevented from leaking out of the inspection chamber 22 via gaps between the workpiece 21010 and the roller portions 2229. In addition, since the sealing materials 2242 are also formed on the circumferential surfaces of the roller portions 2229, the circumferential surfaces of the pair of roller portions 2229 can be brought into contact with each other without a gap therebetween. Therefore, the inspection gas 2TG in the inspection chamber 22 can be restrained or prevented from leaking out of the inspection chamber 22 via a gap between the pair of roller portions 2229.

The roller portions 2229 rotate when being driven by the actuators. The pair of roller portions 2229 rotate in opposite directions to transport the workpiece 21010 into and out of the inspection chamber 22 with the workpiece 21010 interposed therebetween. The roller portions 2229 may be configured to follow movement the workpiece 21010 made by means of the workpiece transportation mechanism 25.

In the case of the workpiece inspection device 2201 in the present embodiment, it is possible to perform workpiece inspection (gas leak inspection with respect to workpiece 21010) in the same manner as in Embodiment B1 by transporting the workpiece 21010 into the inspection chamber 22.

When the workpiece 21010 is to be transported into the inspection chamber 22 in the workpiece inspection device 2201 in the present embodiment, first, as shown in portions (a) and (b) in FIG. 21, the workpiece 21010 is transported by means of the workpiece transportation mechanism 25 until the outer circumferential surface of the workpiece 21010 comes into contact with the workpiece accommodation recesses 2241 of the pair of roller portions 2229. At this time, the circumferential surfaces of the pair of roller portions 2229 are in contact with each other.

Next, as shown in portions (c) and (d) in FIG. 21, the pair of roller portions 2229 is rotated in opposite directions with the workpiece 21010 maintained in a state of being in contact with the inner surfaces of the workpiece accommodation recesses 2241. Accordingly, the workpiece 21010 is transported by the roller portions 2229. At this time, the pair of sliding doors 2226 is moved toward each other or away from each other such that the workpiece 21010 is not interposed between the pair of roller portions 2229 with an excessive force or no gap is formed between the workpiece 21010 and the roller portions 2229. After the workpiece 21010 reaches the inside of the inspection chamber 22, the workpiece 21010 is moved by means of the workpiece transportation mechanism 25 such that the workpiece 21010 is separated from the roller portions 2229 as shown in a portion (e) in FIG. 21.

After gas leak inspection with respect to the workpiece 21010 in the inspection chamber 22 is finished, the workpiece 21010 may be transported to the outside of the inspection chamber 22 in an order opposite to that described above, that is, with the pair of roller portions 2229 rotated in directions opposite to those described above. Since directions in which the pair of roller portions 2229 rotates when the workpiece 21010 is transported into the inspection chamber 22 and directions in which the pair of roller portions 2229 rotates when the workpiece 21010 is transported out of the inspection chamber 22 are opposite to each other, the inspection gas 2TG in the inspection chamber 22 can be prevented from leaking out to the outside of the inspection chamber 22 while being accumulated on the workpiece accommodation recesses 2241.

According to the workpiece inspection device 2201 in the present embodiment, the same effects as those of Embodiment B2 can be obtained.

The door 2221 in Embodiment B3 may be applied to, for example, the second doors 222 and 2122 provided for the openings 223 of the preparation chambers 220 in Embodiment B1 and Embodiment B2.

### Embodiment B4

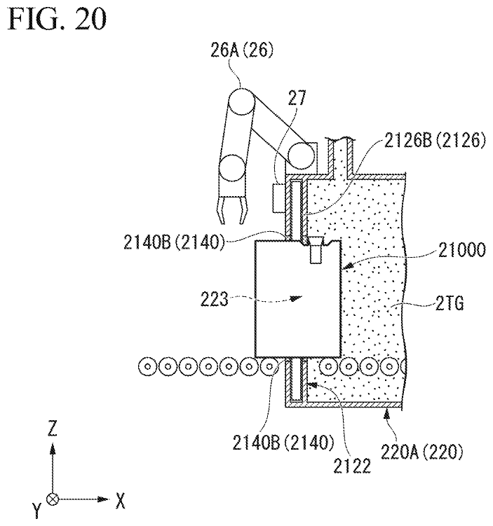

Next, Embodiment B4 of the present invention will be described with reference to FIGS. 22 to 24. In the present embodiment, the same components as those in Embodiments B1 to B3 are denoted by the same reference numerals and the description thereof will be omitted.

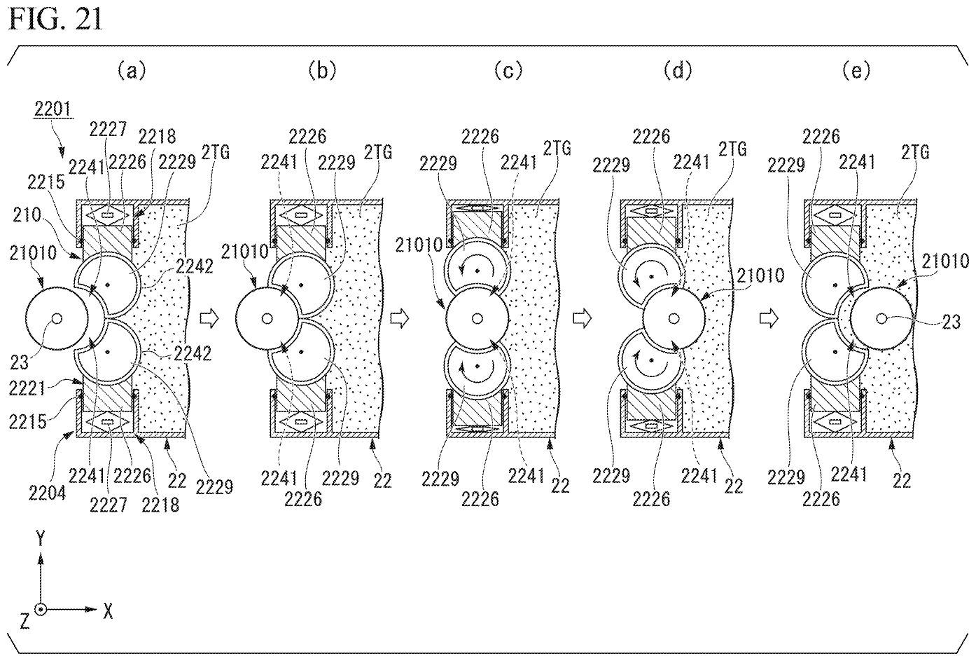

As shown in FIGS. 22 and 23, a workpiece inspection device 2401 in the present embodiment is a gas leak inspection device that inspects the hollow workpiece 21010 for a gas leak, as with Embodiments B1 to B3. The workpiece inspection device 2401 is provided with the inspection chamber 22, the inspection unit 23, and a gas leak suppression structure 2404.

The inspection chamber 22 in the present embodiment includes one entrance 210 through which the workpiece 21010 is inserted and removed. The inspection chamber 22 includes the intake port 211 and the exhaust port 212. In the inspection chamber 22, the probe 213 is provided. The configuration of the inspection unit 23 is the same as that in Embodiment B1.

The gas leak suppression structure 2404 in the present embodiment is provided with an airtight accommodation portion 2450. The airtight accommodation portion 2450 includes an accommodation space 2451 in which the workpiece 21010 is accommodated airtightly with respect to the outside. The number of accommodation spaces 2451 may be two or more and is one in the present embodiment. An inner surface of the accommodation space 2451 is formed in a shape conforming to the entire outer surface of the workpiece 21010. Accordingly, the outer surface of the workpiece 21010 can be brought into contact with the inner surface of the accommodation space 2451 without a gap therebetween. The workpiece 21010 is accommodated in the accommodation space 2451 of the airtight accommodation portion 2450 and is formed in any shape. In an example shown in FIG. 22, the workpiece 21010 has a shape like a cylindrical can such as a drum can.

The airtight accommodation portion 2450 is provided with a plurality of divided bodies 2452 by means of which the inner surface of the accommodation space 2451 is divided into a plurality of regions. At least one of the plurality of divided bodies 2452 includes a workpiece accommodation recess 2453 for accommodating a portion of the workpiece 21010. In the present embodiment, every divided body 2452 is provided with the workpiece accommodation recess 2453. The plurality of workpiece accommodation recesses 2453 constitute the accommodation space 2451 of the airtight accommodation portion 2450 in a state where the plurality of divided bodies 2452 are combined with each other.

A sealing material 2454 is formed on a surface of each divided body 2452. The sealing materials 2454 are the same as the sealing materials 2242 in Embodiment B3. The sealing materials 2454 may be formed on at least inner surfaces of the workpiece accommodation recesses 2453. In the present embodiment, the sealing materials 2454 are also formed on surfaces of the divided bodies 2452 that face each other.

Although the number of divided bodies 2452 may be any number, in the present embodiment, there are two divided bodies 2452, which are a first divided body 2452A and a second divided body 2452B. The two divided bodies 2452 are arranged in a direction (X-axis direction) that the entrance 210 of the inspection chamber 22 faces. The two divided bodies 2452 are relatively moved toward each other and away from each other by means of a divided body moving mechanism 2455 (for example, a zip actuator or like).

The airtight accommodation portion 2450 is provided with a workpiece moving mechanism 2456 that moves the workpiece 21010 between the two divided bodies 2452 in a direction in which the two divided bodies 2452 are arranged. The workpiece moving mechanism 2456 may be provided in the first divided body 2452A as in the drawing and may be provided in the second divided body 2452B. The workpiece moving mechanism 2456 is configured by using, for example, a zip actuator or the like.

Since the airtight accommodation portion 2450 is provided with the workpiece moving mechanism 2456, the workpiece 21010 can be accommodated in the airtight accommodation portion 2450 or extracted from the airtight accommodation portion 2450 in a stable state.

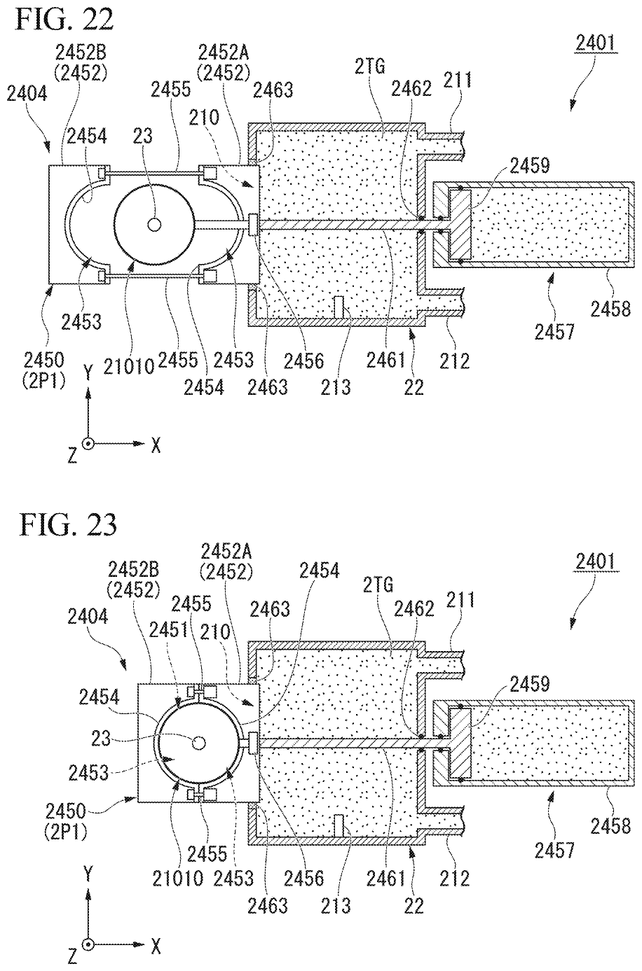

The airtight accommodation portion 2450 is configured to pass through the entrance 210 of the inspection chamber 22 such that the entrance 210 of the inspection chamber 22 is closed. In the present embodiment, the airtight accommodation portion 2450 is movable between a first position 2P1 (refer to FIGS. 22 and 23) and a second position 2P2 (refer to FIG. 24). In a state where the airtight accommodation portion 2450 is disposed at the first position 2P1, the first divided body 2452A closes the entrance 210 and the second divided body 2452B is disposed outside the inspection chamber 22. In a state where the airtight accommodation portion 2450 is disposed at the second position 2P2, the second divided body 2452B closes the entrance 210 and the first divided body 2452A is disposed in the inspection chamber 22. That is, the airtight accommodation portion 2450 closes the entrance 210 of the inspection chamber 22 at all times.

The airtight accommodation portion 2450 described above is moved by means of an accommodation portion moving mechanism 2457. The accommodation portion moving mechanism 2457 may have any specific configuration. The accommodation portion moving mechanism 2457 in the present embodiment is provided with an air cylinder 2458 and a shaft 2461 connected to a piston 2459 of the air cylinder 2458.

The shaft 2461 is connected to the first divided body 2452A of the airtight accommodation portion 2450 and penetrates a wall portion of the inspection chamber 22. A part of the wall portion of the inspection chamber 22 which the shaft 2461 penetrates is sealed by a sealing material 2462 such as an O-ring.

Furthermore, the gas leak suppression structure 2404 in the present embodiment is provided with sealing portions 2463 that are provided at edges of the entrance 210 of the inspection chamber 22 and fill gaps between the entrance 210 of the inspection chamber 22 and the airtight accommodation portion 2450. The sealing portions 2463 may be formed of, for example, rubber, a mohair seal, and a magnetic fluid.

The workpiece inspection device 2401 in the present embodiment is provided with the same controller 27 (refer to FIG. 8 and like) as that in Embodiment B1 in addition to the above-described configuration. The controller 27 has the same functions as those in Embodiment B1 and controls the operations of the divided body moving mechanism 2455, the workpiece moving mechanism 2456, and the accommodation portion moving mechanism 2457.

In the case of the workpiece inspection device 2401 in the present embodiment, it is possible to perform workpiece inspection (gas leak inspection with respect to workpiece 21010) in the same manner as in Embodiment B1 by transporting the workpiece 21010 into the inspection chamber 22.

When the workpiece 21010 is to be transported into the inspection chamber 22 in the present embodiment, first, as shown in FIG. 22, the workpiece 21010 is disposed between the two divided bodies 2452 positioned at an interval in a state where the airtight accommodation portion 2450 is disposed at the first position 2P1.

Next, as shown in FIG. 23, the workpiece 21010 is moved by means of the workpiece moving mechanism 2456. In addition, the two divided bodies 2452 are moved toward each other by means of the divided body moving mechanism 2455. Accordingly, the workpiece 21010 is accommodated in the accommodation space 2451 of the airtight accommodation portion 2450.

Thereafter, as shown in FIG. 24, the airtight accommodation portion 2450 is moved from the first position 2P1 to the second position 2P2 by means of the accommodation portion moving mechanism 2457. Lastly, the two divided bodies 2452 are moved away from each other by means of the divided body moving mechanism 2455 or the accommodation portion moving mechanism 2457. In addition, the workpiece 21010 is moved by means of the workpiece moving mechanism 2456 such that the workpiece 21010 is removed from the workpiece accommodation recess 2453 of the first divided body 2452A. In a manner described above, the workpiece 21010 is transported into the inspection chamber 22 and is exposed to the atmosphere of the inspection gas 2TG in the inspection chamber 22.

After gas leak inspection with respect to the workpiece 21010 in the inspection chamber 22 is finished, the above-described steps may be performed in a reverse order such that the workpiece 21010 is transported to the outside of the inspection chamber 22.

According to the workpiece inspection device 2401 in the present embodiment, the same effects as those of Embodiment B1 can be obtained.

In addition, according to the workpiece inspection device 2401 in the present embodiment, when the workpiece 21010 is transported into and out of the inspection chamber 22, the entrance 210 of the inspection chamber 22 is closed by the airtight accommodation portion 2450 at all times. In addition, the gaps between the entrance 210 of the inspection chamber 22 and the airtight accommodation portion 2450 are filled with the sealing portions 2463. Therefore, the inspection gas 2TG in the inspection chamber 22 can be more reliably restrained or prevented from leaking out of the inspection chamber 22. That is, the amount of a leak of the inspection gas 2TG in the inspection chamber 22 can be reliably reduced.

In addition, according to the workpiece inspection device 2401 in the present embodiment, since the preparation chambers 220 and the doors 221 and 222 can be omitted, it is possible to achieve a further decrease in size or cost of the workpiece inspection device 2401 in comparison with Embodiment B1. Furthermore, since it is not necessary to adjust the concentration of the inspection gas 2TG in the preparation chambers 220, it is possible to achieve a further increase in workpiece inspection speed in comparison with Embodiment B1.

In addition, in comparison with Embodiment B1, a change in concentration (hydrogen concentration) of the inspection gas 2TG in the inspection chamber 22 can also be reduced and thus it is possible to achieve an increase in workpiece inspection speed and to realize workpiece inspection with a higher reproducibility.

### Embodiment B5

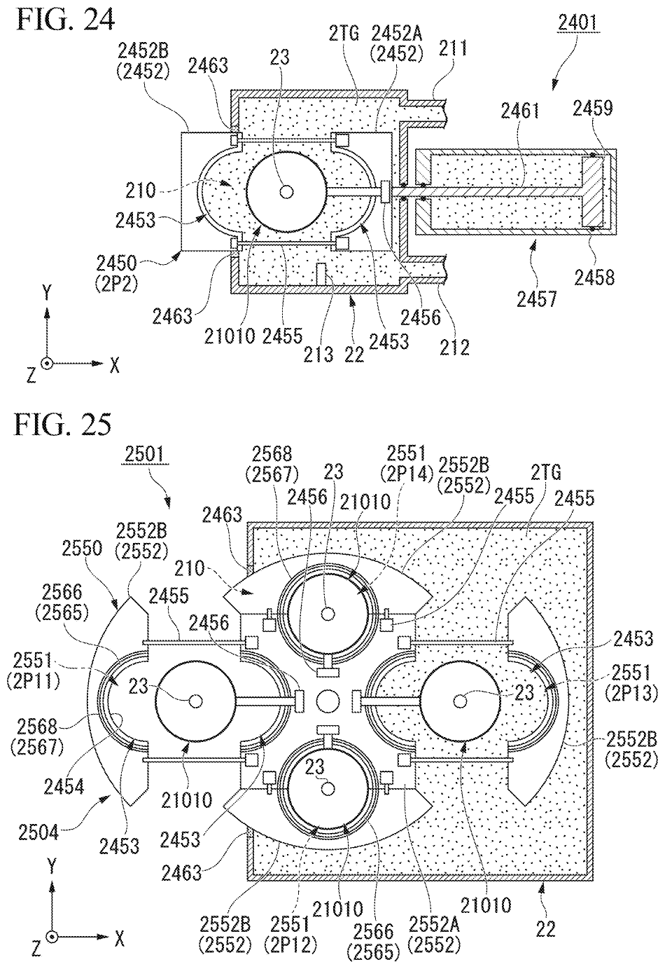

Next, Embodiment B5 of the present invention will be described with reference to FIG. 25. In the present embodiment, differences from Embodiment B4 will be mainly described. In the present embodiment, the same components as those in Embodiments B1 to B4 are denoted by the same reference numerals and the description thereof will be omitted.

As shown in FIG. 25, a workpiece inspection device 2501 in the present embodiment is a gas leak inspection device that inspects the hollow workpiece 21010 for a gas leak, as with Embodiments B1 to B4 and is provided with the inspection chamber 22, the inspection unit 23, and a gas leak suppression structure 2504. The configurations of the inspection chamber 22 and the inspection unit 23 may be the same as those in Embodiment B4 and the like.

As with Embodiment B4, the gas leak suppression structure 2504 in the present embodiment includes accommodation spaces 2551 into each of which the workpiece 21010 is accommodated airtightly with respect to the outside. The gas leak suppression structure 2504 is provided with an airtight accommodation portion 2550 that passes through the entrance 210 of the inspection chamber 22 such that the entrance 210 of the inspection chamber 22 is closed. As with Embodiment B4, the airtight accommodation portion 2550 is provided with a plurality of divided bodies 2552 that can be relatively moved such that an inner surface of each accommodation space 2551 is divided into a plurality of regions. However, the airtight accommodation portion 2550 in the present embodiment includes a plurality of the accommodation spaces 2551. Hereinafter, this point will be specifically described.

The divided bodies 2552 in the present embodiment include a first divided body 2552A and second divided bodies 2552B. The first divided body 2552A in the present embodiment has a configuration in which a plurality of (four in drawing) divided bodies, each of which has the same configuration as the first divided body 2452A in Embodiment B4, are combined with each other. The first divided body 2552A in the present embodiment is provided to rotate around an axis (axis extending in Z-axis direction in FIG. 25) orthogonal to a direction that the entrance 210 of the inspection chamber 22 faces. Each of a plurality of the second divided bodies 2552B corresponds to the second divided body 2452B in Embodiment B4.

The airtight accommodation portion 2550 configured as described above is configured such that at least one accommodation space 2551 is positioned inside the inspection chamber 22. In the present embodiment, three accommodation spaces 2551 are disposed in the inspection chamber 22 with one accommodation space 2551 positioned outside the inspection chamber 22. In the present embodiment, a time when the accommodation space 2551 is positioned outside the inspection chamber 22 will be referred to as a first position 2P11 and the other positions will be referred to as a second position 2P12, a third position 2P13, and a fourth position 2P14 in a counterclockwise order from the first position 2P11.

The workpiece inspection device 2501 in the present embodiment performs inspection for a defect (large hole or like) in the workpiece 21010, in which light is used, and inspection for a defect (void in workpiece wall portion or like) in the workpiece 21010, in which an ultrasonic wave is used, in addition to gas leak inspection in which the gas sensor 230 is used. Therefore, the workpiece inspection device 2501 is further provided with an optical inspection unit 2565 and an ultrasonic inspection unit 2567.

The optical inspection unit 2565 is provided with a light emitting element 2566 provided on the inner surface of the accommodation space 2551 of the airtight accommodation portion 2550 and a light receiving element (not shown) provided in the inspection unit 23 disposed in the workpiece 21010.

The light emitting element 2566 irradiates the entire outer surface of the workpiece 21010 accommodated in the accommodation space 2551 with light (ultraviolet light, visible light, infrared light, or like), and is, for example, an LED array or an organic EL. The light receiving element measures the amount of light emitted from the light emitting element 2566 and transmitted through a wall portion of the workpiece 21010. The light receiving element is, for example, a photodiode, a photomultiplier tube, or the like. The positions of the light emitting element and the light receiving element may be reversed.

The ultrasonic inspection unit 2567 is provided with a vibration element 2568 provided on the inner surface of the accommodation space 2551 of the airtight accommodation portion 2550 and an infrared sensor (not shown) provided in the inspection unit 23 disposed in the workpiece 21010.

The vibration element 2568 causes ultrasonic vibration of the workpiece 21010 accommodated in the accommodation space 2551. The vibration element 2568 may be, for example, an inorganic piezoelectric element formed of lead zirconate titanate (PZT), an organic piezoelectric film, or the like. The infrared sensor measures the amount of infrared light caused by heat that is generated mainly at a defective portion of the workpiece 21010 due to the ultrasonic vibration. The infrared sensor may be configured by using, for example, a thermopile (thermocouple) or a bolometer.

The workpiece inspection device 2501 in the present embodiment is provided with the same controller 27 (refer to FIG. 8 and like) as that in Embodiment B1 in addition to the above-described configuration. The controller 27 has the same functions as those in Embodiment B1 and determines whether or not there is a defect in the workpiece 21010 based on the amount of light measured by the light receiving elements of the optical inspection units 2565 and the amount of infrared light measured by the infrared sensors of the ultrasonic inspection units 2567.

In the case of the workpiece inspection device 2501 in the present embodiment, it is possible to perform workpiece inspection (gas leak inspection with respect to workpiece 21010) in the same manner as in Embodiment B1 by transporting the workpiece 21010 into the inspection chamber 22. In addition, in the case of the workpiece inspection device 2501 in the present embodiment, it is also possible to perform workpiece inspection in which light or an ultrasonic wave is used by accommodating the workpiece 21010 into the accommodation space 2551 of the airtight accommodation portion 2550.

Hereinafter, an example of a workpiece inspection method in which the workpiece inspection device 2501 in the present embodiment is used will be described.

When workpiece inspection is to be performed in the present embodiment, first, in the same manner as that in the case of Embodiment B4, the workpiece 21010 is accommodated in the accommodation space 2551 of the airtight accommodation portion 2550 at the first position 2P11 which is at the outside of the inspection chamber 22.

Next, the airtight accommodation portion 2550 is rotated counterclockwise by means of a rotating mechanism (not shown) such that the accommodation space 2551 with the workpiece 21010 accommodated therein is moved to the second position 2P12. At the second position 2P12, the optical inspection unit 2565 inspects whether or not there is a defect (for example, large hole) in the workpiece 21010 and the controller 27 (determination means, determination unit) determines whether or not the workpiece 21010 is acceptable based on the amount of light measured by the light receiving element of the optical inspection unit 2565.

Thereafter, the accommodation space 2551 with the workpiece 21010 accommodated therein is rotated such that the accommodation space 2551 is moved to the third position 2P13. At the third position 2P13, gas leak inspection with respect to the workpiece 21010 is performed by means of the inspection gas 2TG in the inspection chamber 22. The way in which gas leak inspection is performed is the same as that in the case of Embodiment B4.

Note that, in a case where it is determined that the workpiece 21010 is not acceptable in the workpiece inspection performed by means of the optical inspection unit 2565 (light receiving element) described above, the above-described workpiece inspection at the third position 2P13 may be omitted.

After the gas leak inspection, the workpiece 21010 is accommodated in the accommodation space 2551 of the airtight accommodation portion 2550 again and the accommodation space 2551 is rotated such that the accommodation space 2551 is moved to the fourth position 2P14. At the fourth position 2P14, the ultrasonic inspection unit 2567 inspects whether or not there is a defect (for example, void in wall portion of workpiece 21010 or like) in the workpiece 21010 and the controller 27 (determination means) determines whether or not the workpiece 21010 is acceptable based on the amount of infrared light measured by the infrared sensor of the ultrasonic inspection unit 2567.

Note that, in a case where it is determined that the workpiece 21010 is not acceptable in the workpiece inspection performed by means of the optical inspection unit 2565 (light receiving element) or the inspection unit 23 (gas sensor) described above, the above-described workpiece inspection at the fourth position 2P14 may be omitted.

Lastly, after the accommodation space 2551 with the workpiece 21010 accommodated therein is rotated such that the accommodation space 2551 is moved to the first position 2P11, the workpiece 21010 is extracted from the accommodation space 2551 in the same manner as that in Embodiment B4 and inspection of the workpiece 21010 is finished.

According to the workpiece inspection device 2501 in the present embodiment, the same effects as those of Embodiment B4 can be obtained.

In addition, according to the workpiece inspection device 2501 in the present embodiment, each time the airtight accommodation portion 2550 is rotated by 90 degrees, another accommodation space 2551 positioned at the fourth position 2P14 moves to the first position 2P11. Therefore, each time the airtight accommodation portion 2550 is rotated by 90 degrees, a new workpiece 21010 can be accommodated at the first position 2P11. That is, in the workpiece inspection device 2501 in the present embodiment, a plurality of the workpieces 21010 can be consecutively inspected, and thus it is possible to achieve a further increase in workpiece inspection speed.

In addition, according to the workpiece inspection device 2501 in the present embodiment, workpiece inspection performed by means of the optical inspection unit 2565 can be performed before gas leak inspection with respect to the workpiece 21010 is performed by means of the gas sensor 230. In addition, in a case where it is determined that the workpiece 21010 is not acceptable in the workpiece inspection performed by means of the optical inspection unit 2565, workpiece inspection performed by means of the gas sensor can be omitted. For this reason, it is possible to suppress a decrease in gas sensor sensitivity that is caused when the gas sensor is exposed to the atmosphere of the high-concentration inspection gas 2TG. Since the gas sensor is protected, the same gas sensor can be used repeatedly and thus it becomes possible to perform workpiece inspection efficiently. This is particularly effective when the gas sensor is a semiconductor gas sensor having a low resistance to the high-concentration inspection gas 2TG.

In addition, in the case of the workpiece inspection device 2501 in the present embodiment, in addition to the workpiece inspection performed by means of the gas sensor, the workpiece inspection performed by means of the optical inspection unit 2565 and the ultrasonic inspection unit 2567 can also be performed. Therefore, the number of devices for inspecting the workpiece 21010 can be decreased in comparison with a case where the workpiece inspection performed by means of the optical inspection unit 2565 and the ultrasonic inspection unit 2567 is performed in another device and it is also possible to decrease the number of operators needed to operate such a device.

The optical inspection unit 2565 and the ultrasonic inspection unit 2567 in Embodiment B5 may be applied to, for example, the workpiece inspection device 2401 in Embodiment B4.

### Embodiment B6

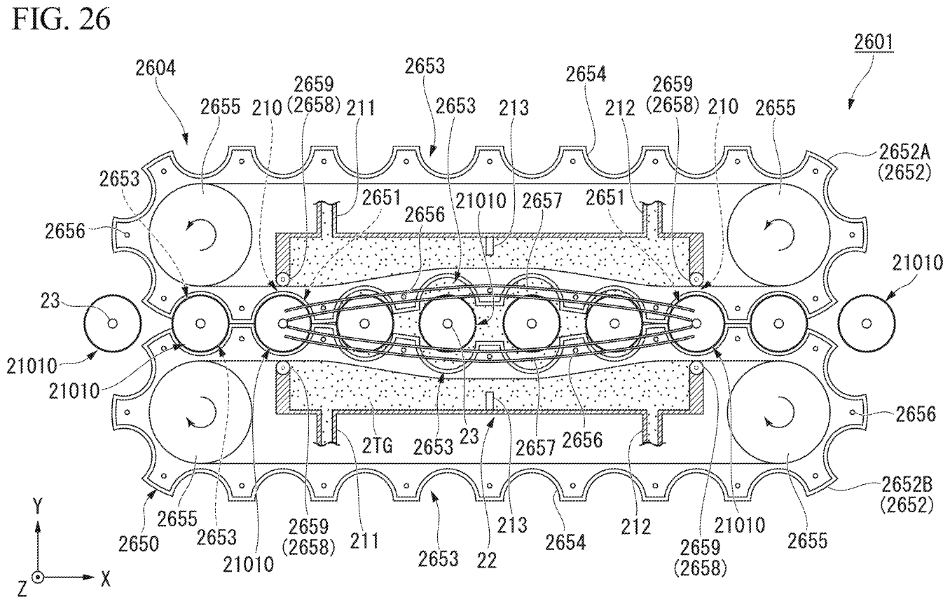

Next, Embodiment B6 of the present invention will be described with reference to FIG. 26. In the present embodiment, differences from Embodiments B4 and B5 will be mainly described. In the present embodiment, the same components as those in Embodiments B1 to B5 are denoted by the same reference numerals and the description thereof will be omitted.

As shown in FIG. 26, a workpiece inspection device 2601 in the present embodiment is a gas leak inspection device that inspects the hollow workpiece 21010 for a gas leak, as with Embodiments B4 to B5. The workpiece inspection device 2601 is provided with the inspection chamber 22, the inspection unit 23, and a gas leak suppression structure 2604.

The inspection chamber 22 in the present embodiment includes two entrances 210 for insertion and removal of the workpiece 21010. The two entrances 210 may face different directions. However, the entrances 210 face the same direction (X-axis direction (hereinafter, may be referred to as “one direction”)) in the present embodiment. The inspection chamber 22 may have any size. However, in the present embodiment, the inspection chamber 22 is large enough to accommodate a plurality of (four or five in drawing) the workpieces 21010 arranged in the one direction.

The gas leak suppression structure 2604 in the present embodiment includes accommodation spaces 2651 into each of which the workpiece 21010 is accommodated airtightly with respect to the outside. The gas leak suppression structure 2604 is provided with an airtight accommodation portion 2650 that passes through the entrances 210 of the inspection chamber 22 such that the entrances 210 of the inspection chamber 22 are closed. As with Embodiments B4 and B5, the airtight accommodation portion 2650 is provided with a plurality of divided bodies 2652 by means of which each of inner surfaces of the accommodation spaces 2651 is divided into a plurality of regions. In addition, the airtight accommodation portion 2650 includes a plurality of the accommodation spaces 2651.

The plurality of divided bodies 2652 of the airtight accommodation portion 2650 in the present embodiment are two belt-shaped divided bodies 2652A and 2652B each of which is formed in a belt shape passing through the two entrances 210. The two belt-shaped divided bodies 2652A and 2652B are brought close to each other at the two entrances 210 such that the workpiece 21010 is accommodated in the accommodation space 2651. In addition, the two belt-shaped divided bodies 2652A and 2652B are separated from each other inside the inspection chamber 22 such that the workpiece 21010 is opened. The number of belt-shaped divided bodies may be three or more.

Hereinafter, the configurations of the two belt-shaped divided bodies 2652A and 2652B will be specifically described.

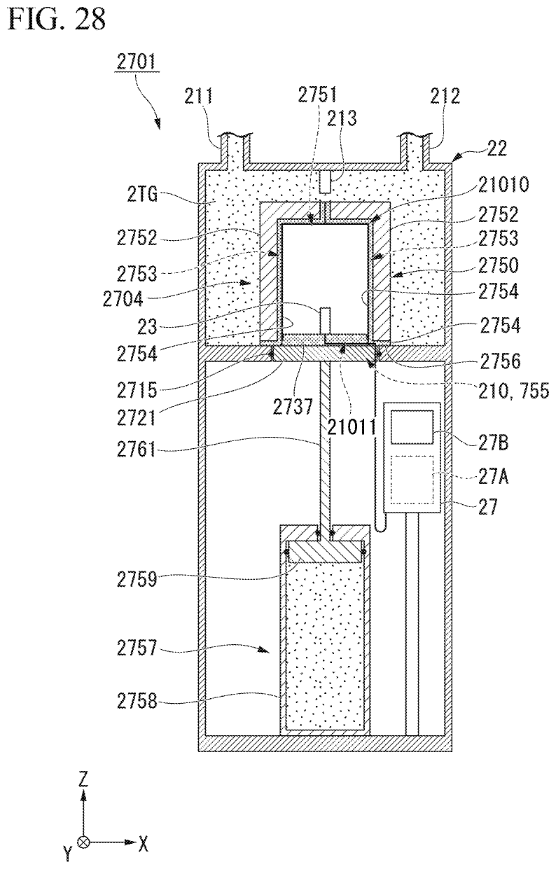

Each of the two belt-shaped divided bodies 2652A and 2652B moves in the X-axis positive direction so as to enter the inspection chamber 22 via one of the entrances 210 of the inspection chamber 22 and to exit the inspection chamber 22 via the other entrance 210. In FIG. 28, the two belt-shaped divided bodies 2652A and 2652B move from a left side to a right side.

Specifically, the belt-shaped divided bodies 2652A and 2652B are endless belts. The belt-shaped divided bodies 2652A and 2652B are wound around a plurality of rollers 2655 disposed outside the inspection chamber 22 and move in accordance with rotation of the rollers 2655. At least one of the plurality of rollers 2655 is a driving roller that drivingly rotates. The other of the rollers 2655 may be driven rollers that rotate following rotation of the driving roller.

The two belt-shaped divided bodies 2652A and 2652B overlap each other in the Y-axis direction when being interposed between edge portions of the entrances 210 at the entrances 210 of the inspection chamber 22. After the two belt-shaped divided bodies 2652A and 2652B enter the inspection chamber 22 via the entrance 210 on the left side, the belt-shaped divided bodies 2652A and 2652B are separated from each other in the Y-axis direction as the belt-shaped divided bodies 2652A and 2652B proceed toward the positive X-axis direction. An interval between the two belt-shaped divided bodies 2652A and 2652B is largest at an intermediate portion in the inspection chamber 22 in the X-axis direction. Thereafter, the two belt-shaped divided bodies 2652A and 2652B are brought closer to each other as the belt-shaped divided bodies 2652A and 2652B proceed toward the entrance 210 on the right side of the inspection chamber 22.

The above-described movement of the two belt-shaped divided bodies 2652A and 2652B can be realized since a plurality of pins 2656 provided on each of the belt-shaped divided bodies 2652A and 2652B are caught on curved guide rails 2657 provided in the inspection chamber 22.

A plurality of workpiece accommodation recesses 2653 are formed on outer surfaces of the two belt-shaped divided bodies 2652A and 2652B that face each other at the entrances 210 of the inspection chamber 22 and inside the inspection chamber 22. The plurality of workpiece accommodation recesses 2653 each accommodate a portion of the workpiece 21010. The plurality of workpiece accommodation recesses 2653 are arranged at intervals in a longitudinal direction of each of the belt-shaped divided bodies 2652A and 2652B.

When the two belt-shaped divided bodies 2652A and 2652B overlap each other at the entrances 210 of the inspection chamber 22, the workpiece accommodation recesses 2653 of the two belt-shaped divided bodies 2652A and 2652B constitute the accommodation spaces 2651 of the airtight accommodation portion 2650 in which the workpiece 21010 is accommodated. As with Embodiments B3 to B5, sealing materials 2654 are formed on surfaces of the belt-shaped divided bodies 2652A and 2652B.

Furthermore, the gas leak suppression structure 2604 in the present embodiment is provided with sealing portions 2658 provided at the edges of the entrances 210 of the inspection chamber 22. The sealing portions 2658 fill gaps between the entrances 210 of the inspection chamber 22 and the two belt-shaped divided bodies 2652A and 2652B (airtight accommodation portion 2650). The sealing portions 2658 may be formed of, for example, rubber, a mohair seal, and a magnetic fluid.

The sealing portions 2658 in the present embodiment are provided with roller portions 2659 that rotate in a state of being in contact with the belt-shaped divided bodies 2652A and 2652B when the belt-shaped divided bodies 2652A and 2652B pass through the entrances 210. The roller portion 2659 is formed in columnar shapes and is provided for each of the edges of the entrances 210 such that the roller portion 2659 can rotate around an axis (axis extending in Z-axis direction in FIG. 26) orthogonal to the one direction. In addition, the sealing portions 2658 in the present embodiment may be provided with sealing materials (not shown) such as mohair seals or magnetic fluids that fill gaps between the edges of the entrances 210 of the inspection chamber 22 and the roller portions 2659.

Since the gas leak suppression structure 2604 is provided with the sealing portions 2658, the inspection gas 2TG can be more reliably restrained or prevented from leaking out from the inside of the inspection chamber 22 toward the outside of the inspection chamber 22. In addition, since the sealing portions 2658 include the roller portions 2659, the two belt-shaped divided bodies 2652A and 2652B can smoothly pass through the entrances 10 of the inspection chamber 2.

The workpiece inspection device 2601 in the present embodiment is provided with the workpiece transportation mechanism 25, the robot arms 26, and the controller 27 (refer to FIG. 8 and like), which are the same as those in Embodiment B1, in addition to the above-described configuration.

In the case of the workpiece inspection device 2601 in the present embodiment, it is possible to perform workpiece inspection (gas leak inspection with respect to workpiece 21010) in the same manner as in Embodiment B1 by transporting the workpiece 21010 into the inspection chamber 22.

When gas leak inspection with respect to the workpiece 21010 is to be performed in the present embodiment, first, the workpiece 21010 is transported toward one entrance 210 of the inspection chamber 22 by means of the workpiece transportation mechanism 25. Next, the workpiece 21010 is interposed between the two belt-shaped divided bodies 2652A and 2652B such that the workpiece 21010 is accommodated in the accommodation space 2651 of the airtight accommodation portion 2650 before the workpiece 21010 reaches the one entrance 210 of the inspection chamber 22 from the outside of the inspection chamber 22. In this state, the workpiece 21010 is transported into the inspection chamber 22 through the one entrance 210 of the inspection chamber 22, by means of the two belt-shaped divided bodies 2652A and 2652B or the workpiece transportation mechanism 25. Thereafter, the two belt-shaped divided bodies 2652A and 2652B are separated from each other in the inspection chamber 22 such that the workpiece 21010 is opened and is exposed to the atmosphere of the inspection gas 2TG in the inspection chamber 22. In this state, gas leak inspection with respect to the workpiece 21010 can be performed.

Thereafter, the workpiece 21010 is interposed between the two belt-shaped divided bodies 2652A and 2652B again such that the workpiece 21010 is accommodated in the accommodation space 2651 of the airtight accommodation portion 2650 before the workpiece 21010 reaches the other entrance 210 of the inspection chamber 22. In this state, the workpiece 21010 is transported to the outside of the inspection chamber 22 through the other entrance 210 of the inspection chamber 2, by means of the two belt-shaped divided bodies 2652A and 2652B or the workpiece transportation mechanism 25. Lastly, the two belt-shaped divided bodies 2652A and 2652B are separated from each other outside the inspection chamber 22 such that the workpiece 21010 is opened and the gas leak inspection with respect to the workpiece 21010 is finished.

According to the workpiece inspection device 2601 in the present embodiment, the same effects as those of Embodiment B4 can be obtained.

In addition, according to the workpiece inspection device 2601 in the present embodiment, the airtight accommodation portion 2650 is composed of the two belt-shaped divided bodies 2652A and 2652B each of which is formed in a belt shape. Therefore, a plurality of the workpieces 21010 can be consecutively inspected. Therefore, it is possible to achieve a further increase in workpiece inspection speed.

### Embodiment B7

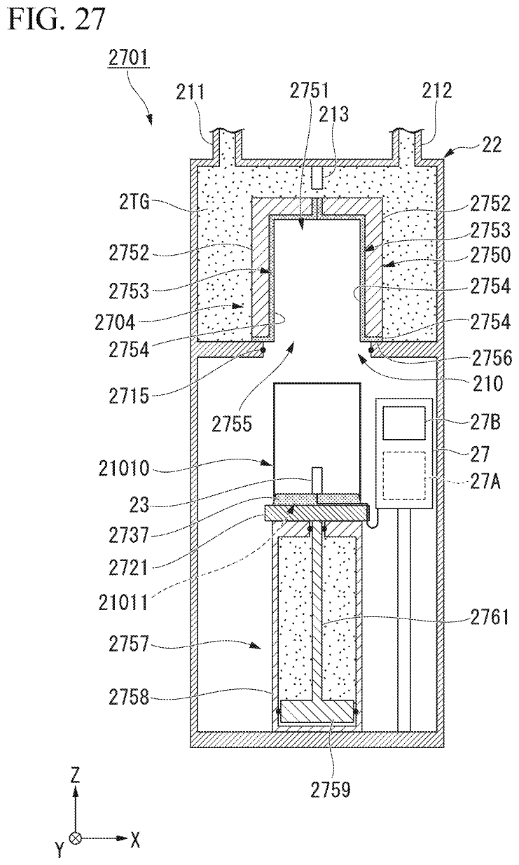

Next, Embodiment B7 of the present invention will be described with reference to FIGS. 27 to 29. In the present embodiment, the same components as those in Embodiments B1 to B6 are denoted by the same reference numerals and the description thereof will be omitted.

As shown in FIGS. 27 and 28, a workpiece inspection device 2701 in the present embodiment is a gas leak inspection device that inspects the hollow workpiece 21010 for a gas leak, as with Embodiments B1 to B6. The workpiece inspection device 2701 is provided with the inspection chamber 22, the inspection unit 23, and a gas leak suppression structure 2704.

The inspection chamber 22 in the present embodiment includes one entrance 210 for insertion and removal of the workpiece 21010. In the present embodiment, the entrance 210 is formed at a lower end of the inspection chamber 22.

The gas leak suppression structure 2704 in the present embodiment is provided with an accommodation portion 2750 and a lid portion 2721. The accommodation portion 2750 is disposed in the inspection chamber 22. The accommodation portion 2750 includes an accommodation space 2751 in which the workpiece 21010 is accommodated through the entrance 210 of the inspection chamber 22. That is, the accommodation portion 2750 includes an opening 2755 that communicates with the entrance 210 of the inspection chamber 22. The accommodation portion 2750 is disposed in the inspection chamber 2 such that an opening end 2756 thereof comes into contact with a region on an inner surface of the inspection chamber 22, the region being in the vicinity of the entrance 210. At the opening end 2756 of the accommodation portion 2750, sealing materials 2754 such as mohair seals are provided. Accordingly, the accommodation space 2751 is made airtight with respect to the inspection chamber 22. In addition, the inspection chamber 22 is made airtight with respect to the outside of the inspection chamber 22 by the accommodation portion 2750.

The accommodation space 2751 is a space having a size corresponding to the workpiece 21010. That is, an inner surface of the accommodation space 2751 is formed in a shape corresponding to an outer surface of the workpiece 21010. Accordingly, the outer surface of the workpiece 21010 can be brought into contact with the inner surface of the accommodation space 2751 without a gap therebetween.

The workpiece 21010 accommodated in the accommodation space 2751 may have any shape as long as at least the workpiece 21010 includes an opening portion 21011.

The accommodation portion 2750 is provided with a plurality of divided bodies 2752 by means of which the inner surface of the accommodation space 2751 is divided into a plurality of regions. The plurality of divided bodies 2752 are combined with each other such that the accommodation space 2751 of the accommodation portion 2750 is formed. In this state, as described above, the accommodation space 2751 is made airtight with respect to the inspection chamber 22.

Each divided body 2752 includes a workpiece accommodation recess 2753 which accommodates a portion of the workpiece 21010. The workpiece accommodation recesses 2753 of the plurality of divided bodies 2752 may be different from each other in shape or size. However, the workpiece accommodation recesses 2753 are the same as each other in shape or size in the present embodiment. The plurality of workpiece accommodation recesses 2753 constitute the accommodation space 2751 of the accommodation portion 2750 in a state where the plurality of divided bodies 2752 are combined with each other.

In the present embodiment, the sealing material 2754 is formed on a surface of each divided body 2752. The sealing materials 2754 are formed on regions on the surfaces of the divided bodies 2752 that serve as the opening end 2756 of the accommodation portion 2750, inner surfaces of the workpiece accommodation recesses 2753, and surfaces of the divided bodies 2752 that face each other. Accordingly, in a state where the plurality of divided bodies 2752 are combined with each other, the accommodation space 2751 can be made airtight with respect to the inspection chamber 22 reliably. That is, the inspection gas 2TG in the inspection chamber 22 can be reliably restrained or prevented from leaking out of the inspection chamber 22 via the entrance 210.

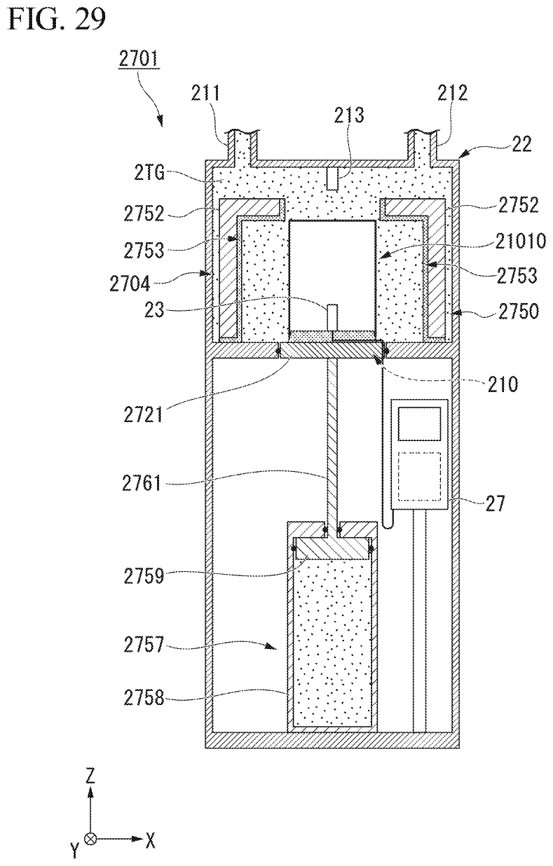

The number of divided bodies 2752 may be any number and is two in the present embodiment. The two divided bodies 2752 are arranged in a direction (X-axis direction) orthogonal to a direction (Z-axis direction) in which the workpiece 21010 is inserted into and removed from the accommodation space 2751. The two divided bodies 2752 can be moved toward and away from each other by means of a divided body moving mechanism (not shown) composed of various actuators (refer to FIGS. 28 and 29).

The lid portion 2721 opens and closes the entrance 210 of the inspection chamber 22 from the outside of the inspection chamber 22.

In the present embodiment, a sealing material 2715 is provided at an edge of the entrance 210 of the inspection chamber 22. The sealing material 2715 fills a gap between the edge of the entrance 210 and a portion of the lid portion 2721 that faces the edge of the entrance 210. Accordingly, in a state where the entrance 210 of the inspection chamber 22 is closed by the lid portion 2721, the inspection gas 2TG in the inspection chamber 22 can be prevented or restrained from leaking out of the inspection chamber 22 via the entrance 210 even when the two divided bodies 2752 are separated from each other in the inspection chamber 22.

In the present embodiment, the lid portion 2721 is moved by means of a lid portion moving mechanism 2757 such that the entrance 210 is opened or closed. The lid portion moving mechanism 2757 may have any specific configuration. The lid portion moving mechanism 2757 in the present embodiment is provided with an air cylinder 2758 and a shaft 2761 connected to a piston 2759 of the air cylinder 2758. The shaft 2761 is connected to the lid portion 2721.

In the present embodiment, it is possible to insert and remove the workpiece 21010 into and from the accommodation space 2751 of the accommodation portion 2750 by disposing the workpiece 21010 on the lid portion 2721 and moving the workpiece 21010 along with the lid portion 2721 by means of the lid portion moving mechanism 2757. That is, the lid portion moving mechanism 2757 in the present embodiment also functions as a workpiece transportation mechanism.

Furthermore, in the present embodiment, the workpiece 21010 is disposed on the lid portion 2721 when the opening portion 21011 of the workpiece 21010 is closed by a closing portion 2737 provided on the lid portion 2721. Accordingly, it is possible to inspect the entire workpiece 21010 for a gas leak.

Furthermore, the workpiece inspection device 2701 in the present embodiment is provided with the controller 27. The controller 27 is provided with a control circuit unit 27A and an input and output interface 27B. The controller 27 has the same functions as those in Embodiment B1 and has a function of controlling the operations of the divided body moving mechanism and the lid portion moving mechanism 2757.

In the case of the workpiece inspection device 2701 in the present embodiment, it is possible to perform workpiece inspection (gas leak inspection with respect to workpiece 21010) in the same manner as in Embodiment B1 by transporting the workpiece 21010 into the inspection chamber 22.

First, as shown in FIG. 27, with the workpiece 21010 disposed on the lid portion 2721, the workpiece 21010 is transported toward the entrance 210 of the inspection chamber 22 by means of the lid portion moving mechanism 2757. Accordingly, as shown in FIG. 28, the workpiece 21010 is accommodated in the accommodation space 2751 of the accommodation portion 2750 disposed in the inspection chamber 22 and the entrance 210 of the inspection chamber 22 is closed by the lid portion 2721 at the same time. Thereafter, as shown in FIG. 29, the two divided bodies 2752 are moved away from each other by means of the divided body moving mechanism (not shown). Accordingly, the workpiece 21010 is transported into the inspection chamber 22 and is exposed to the atmosphere of the inspection gas 2TG in the inspection chamber 22. Accordingly, gas leak inspection with respect to the workpiece 21010 can be performed.

After gas leak inspection with respect to the workpiece 21010 in the inspection chamber 22 is finished, the above-described steps may be performed in a reverse order such that the workpiece 21010 is transported to the outside of the inspection chamber 22.

According to the workpiece inspection device 2701 in the present embodiment, the same effects as those of Embodiment B1 can be obtained.

In addition, according to the workpiece inspection device 2701 in the present embodiment, when the workpiece 21010 is transported into and out of the inspection chamber 22, the inspection chamber 22 is made airtight with respect to the outside of the inspection chamber 22 by means of the accommodation portion 2750. In addition, in a state where the gas leak inspection with respect to the workpiece 21010 is performed in the inspection chamber 22 (state where accommodation portion 2750 is divided into two divided bodies 2752), the entrance 210 of the inspection chamber 22 is closed by the lid portion 2721. Therefore, the inspection gas 2TG in the inspection chamber 22 can be more reliably restrained or prevented from leaking out of the inspection chamber 22. That is, the amount of a leak of the inspection gas 2TG in the inspection chamber 22 can be reliably reduced.

In addition, according to the workpiece inspection device 2701 in the present embodiment, the preparation chambers 220 can be omitted in comparison with Embodiment B1. Therefore, it is possible to achieve a further decrease in size or cost of the workpiece inspection device 2701. Furthermore, since it is not necessary to adjust the concentration of the inspection gas 2TG in the preparation chambers 220, it is possible to achieve a further increase in workpiece inspection speed.

In addition, in comparison with Embodiment B1, a change in concentration (hydrogen concentration) of the inspection gas 2TG in the inspection chamber 22 can also be reduced. Therefore, it is possible to achieve an increase in workpiece inspection speed and to realize workpiece inspection with a higher reproducibility.

In Embodiment B7, a plurality of the accommodation portions 2750 may be provided in the inspection chamber 22. In this case, the inspection chamber 22 may include a plurality of the entrances 210 corresponding to the number of accommodation portions 2750. In addition, the gas leak suppression structure 2704 may be provided with a plurality of the lid portions 2721 corresponding to the number of accommodation portions 2750. With such a configuration, it is possible to achieve a further increase in workpiece inspection speed.

### Embodiment B8

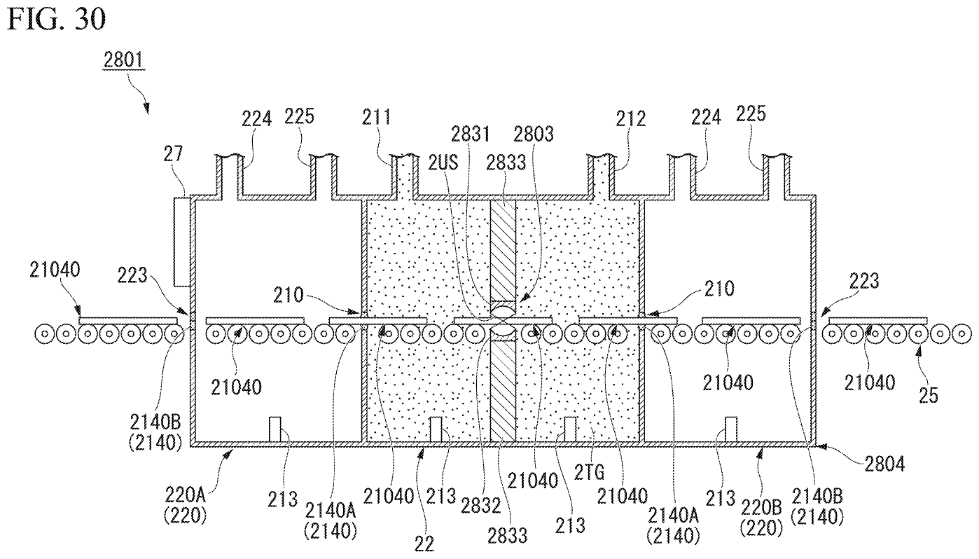

Next, Embodiment B8 of the present invention will be described with reference to FIG. 30. In the present embodiment, differences from Embodiments B1 and B2 will be mainly described. In the present embodiment, the same components as those in Embodiments B1 to B7 are denoted by the same reference numerals and the description thereof will be omitted.

As shown in FIG. 30, a workpiece inspection device 2801 according to the present embodiment is an ultrasonic inspection device that inspects the inside of a workpiece for a defect.

Any workpiece may become an inspection target. A workpiece 21040 in the present embodiment is a plate-shaped body obtained by stacking a plurality of carbon fiber reinforced plastics (CFRP) formed in a sheet-like shape onto each other and bonding the carbon fiber reinforced plastics by means of bonding layers. Examples of a defect in the workpiece 21040 to be inspected by the workpiece inspection device 2801 in the present embodiment include a void (separation between CFRPs) present in a bonding layer between the CFRPs that are adjacent to each other in a stacking direction and a foreign substance.

As with Embodiments B1 and B2, the workpiece inspection device 2801 in the present embodiment is provided with the inspection chamber 22, an inspection unit 2803, and a gas leak suppression structure 2804. The configuration of the inspection chamber 22 may be the same as that in Embodiment B1. In addition, the workpiece inspection device 2801 in the present embodiment is provided with the same workpiece transportation mechanism 25 as that in Embodiment B1.

The gas leak suppression structure 2804 is provided with the same preparation chambers 220 (first preparation chamber 220A and second preparation chamber 220B) as those in Embodiment B1. Furthermore, the gas leak suppression structure 2804 in the present embodiment is provided with the same sealing portions 2140 (first sealing portions 2140A and second sealing portions 2140B) as those in Embodiment B2. The gas leak suppression structure 2804 in the present embodiment may be provided with the doors 221, 222, 2121, and 2122 as in Embodiments B1 and B2, for example. In the present embodiment, the gas leak suppression structure 2804 is not provided with such doors. This is because the workpiece 21040 is thin and a gas can be restrained from leaking out from the inspection chamber 22 or the preparation chambers 220 with only the sealing portions 2140.

The inspection unit 2803 in the present embodiment is provided with an ultrasonic oscillation unit 2831 and an ultrasonic reception unit 2832. The ultrasonic oscillation unit 2831 irradiates the workpiece 21040 with an ultrasonic wave 2US in the inspection chamber 22. The ultrasonic oscillation unit 2831 may be composed of one or a plurality of ultrasonic oscillation elements. The ultrasonic reception unit 2832 measures the ultrasonic wave 2US transmitted through the workpiece 21040 in the inspection chamber 22. The ultrasonic reception unit 2832 may be composed of one or a plurality of ultrasonic reception elements. The ultrasonic oscillation unit 2831 or the ultrasonic reception unit 2832 may be substituted with a transmission and reception unit and the ultrasonic wave 2US reflected by the workpiece 21040 may be measured by the transmission and reception unit.

In the present embodiment, the ultrasonic oscillation unit 2831 and the ultrasonic reception unit 2832 are provided in the inspection chamber 22. The ultrasonic oscillation unit 2831 and the ultrasonic reception unit 2832 are disposed such that a transportation path of the workpiece 21040, which is transported by means of the workpiece transportation mechanism 25, is interposed therebetween. In addition, each of the ultrasonic oscillation unit 2831 and the ultrasonic reception unit 2832 is held at a predetermined position in the inspection chamber 22 by means of a holding member 2833 provided on an inner surface of the inspection chamber 22.

Data of the ultrasonic wave 2US measured by the ultrasonic reception unit 2832 is transmitted to the same controller 27 as that in Embodiment B1 by means of wire communication or wireless communication. In the present embodiment, the controller 27 (determination means, determination unit) determines whether there is a defect inside the workpiece 21040 based on the data of the ultrasonic wave 2US measured by the ultrasonic reception unit 2832.

The inspection gas 2TG used in the workpiece inspection device 2801 in the present embodiment may be a high-density gas having a higher density than air and a specific gravity larger than 1, so that ultrasonic inspection as described can be performed with a high sensitivity. In addition, the high-density gas may be nonflammable and have a low toxicity in consideration of safety and easy handling. Examples of such a high-density gas include argon, xenon, and krypton. In addition, the high-density gas may be, for example, a Freon gas such as perfluoropropane, Freon 12, Freon 14, Freon-22, Freon R-134a, and Freon R-502, or carbon dioxide.

As the probes 213 provided in the inspection chamber 22 or the preparation chambers 220, gas sensors (for example, heat conduction type gas sensor, semiconductor type gas sensor, electrochemical type gas sensor, non-dispersive infrared absorption type gas sensor) that can measure the concentration of the above-described high-density gas may be used.

When workpiece inspection (ultrasonic inspection) is to be performed by means of the workpiece inspection device 2801 in the present embodiment, the inspection chamber 22 is filled with the inspection gas 2TG through the intake port 211 of the inspection chamber 22 in advance. Each preparation chamber 220 may be filled with the same air as the outside without being filled with the inspection gas 2TG. The pressure of a gas in the inspection chamber 22 may be set to be higher than the pressure of a gas in each preparation chamber 220. In addition, the pressure of the gas in each preparation chamber 220 may be set to be higher than the pressure in the atmosphere outside the preparation chamber 220. Accordingly, a decrease in concentration of the inspection gas 2TG in the inspection chamber 22 can be reduced.

In addition, in a case where the inspection gas 2TG in the inspection chamber 22 leaks out to the preparation chambers 220 (in case where inspection gas 2TG is detected by probes 213 in preparation chambers 220), the inspection gas 2TG in the preparation chambers 220 may be recovered by means of a recovery device (not shown) through the exhaust ports 225 of the preparation chambers 220. In addition, clean air containing no inspection gas 2TG may be introduced into the preparation chambers 220 through the intake ports 224 of the preparation chambers 220. The inspection gas 2TG may be recovered by the recovery device until, for example, the concentration of the inspection gas 2TG measured by the probes 213 in the preparation chambers 220 in a state where air in the preparation chambers 220 is stirred by a fan or the like becomes equal to or lower than a specified value. The recovery of the inspection gas 2TG in the preparation chambers 220 is particularly effective in a case when a Freon gas is used as the inspection gas 2TG.

When the workpiece inspection (ultrasonic inspection) is to be performed, in a state as described above, the workpiece 21040 is transported into the first preparation chamber 220A through the opening 223 of the first preparation chamber 220A by means of the workpiece transportation mechanism 25 and the workpiece 21040 is transported into the inspection chamber 22 through the entrance 210 of the inspection chamber 22 from the inside of the first preparation chamber 220A. When the workpiece 21040 passes through the opening 223 of the first preparation chamber 220A or the entrance 210 of the inspection chamber 22, a gap between the workpiece 21040 and the opening 223 of the first preparation chamber 220A or the entrance 210 of the inspection chamber 22 is filled with the sealing portions 2140. Therefore, the inspection gas 2TG can be restrained or prevented from leaking out from the inside of the inspection chamber 22 toward the first preparation chamber 220A or leaking out from the inside of the first preparation chamber 220A to the outside of the first preparation chamber 220A.

Thereafter, the workpiece 21040 is further transported by means of the workpiece transportation mechanism 25 such that the workpiece 21040 passes through the inspection unit 2803 in the inspection chamber 22. Accordingly, ultrasonic inspection with respect to the workpiece 21040 is performed. Lastly, the workpiece 21040 is transported into the second preparation chamber 220B through the entrance 210 of the inspection chamber 22 from the inside of the inspection chamber 22 by means of the workpiece transportation mechanism 25 and is transported to the outside of the second preparation chamber 220B through the opening 223 of the second preparation chamber 220B such that the ultrasonic inspection with respect to the workpiece 21040 is finished. Even when the workpiece 21040 is transported to the outside of the second preparation chamber 220B from the inspection chamber 22, the inspection gas 2TG can be restrained or prevented from leaking out from the inside of the inspection chamber 22 toward the second preparation chamber 220B or leaking out from the inside of the second preparation chamber 220B to the outside of the second preparation chamber 220B by means of the sealing portions 2140.

In the case of the workpiece inspection device 2801 in the present embodiment, the ultrasonic inspection with respect to a plurality of the workpieces 21040 can be consecutively performed in the same manner as in Embodiments B1 and B2.

As with Embodiments B1 and B2, according to the workpiece inspection device 2801 in the present embodiment, it is possible to restrain the inspection gas 2TG in the inspection chamber 22 from leaking due to insertion or removal of the workpiece 21040 with respect to the inspection chamber 22, by means of the gas leak suppression structure 2804. Therefore, it is possible to suppress a decrease in concentration of the inspection gas 2TG in the inspection chamber 22 and to expose the workpiece 21040 inserted into in the inspection chamber 22 to the inspection gas 2TG of a high concentration in a short time. That is, it is possible to perform ultrasonic inspection with respect to the workpiece 21040 in a short time under an environment where the concentration of the inspection gas 2TG is high. Therefore, it is possible to achieve an increase in workpiece inspection (ultrasonic inspection) speed.

In addition, since the ultrasonic inspection with respect to the workpiece 21040 is performed under an environment where the concentration of the inspection gas 2TG is high, it is also possible to achieve an increase in workpiece inspection (ultrasonic inspection) sensitivity. Specifically, a minute defect inside the workpiece 21040 can be easily detected in comparison with the related art.

In addition, since a leak of the inspection gas TG in the inspection chamber 2 is suppressed by means of the gas leak suppression structure 2804, it is also possible to achieve a decrease in cost of workpiece inspection.

In addition, according to the workpiece inspection device 2801 in the present embodiment, ultrasonic inspection with respect to the workpiece 21040 can be performed in a state where the workpiece 21040 is in the inspection chamber 22. Therefore, the risk of damage to the workpiece 21040 can also be reduced. For example, in a case where the workpiece 21040 is a bag-shaped container filled with contents such as liquid and solid, the risk of the container being broken and the contents leaking can be reduced.

### Embodiment B9

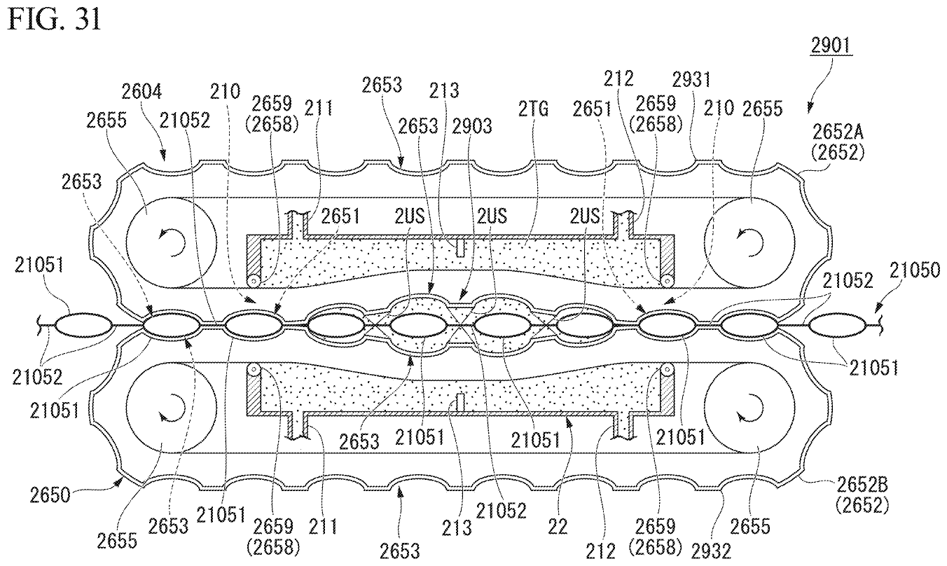

Next, Embodiment B9 of the present invention will be described with reference to FIG. 31. In the present embodiment, differences from Embodiments B6 and B8 will be mainly described. In the present embodiment, the same components as those in Embodiments B1 to B8 are denoted by the same reference numerals and the description thereof will be omitted.

As shown in FIG. 31, a workpiece inspection device 2901 in the present embodiment is an ultrasonic inspection device that inspects the inside of a workpiece for a defect, as with Embodiment B8.

Any workpiece may become an inspection target. A workpiece 21050 in the present embodiment is composed of a plurality of bag-shaped containers 21051 and a plurality of connection portions 21052. The plurality of bag-shaped containers 21051 are filled with contents such as liquid and solid. Each of the plurality of connection portions 21052 connects the bag-shaped containers 21051 that are adjacent to each other. The plurality of bag-shaped containers 21051 and the connection portions 21052 are configured by, for example, stacking two films. Examples of a defect in the workpiece 21050 to be inspected by the workpiece inspection device 2901 in the present embodiment include a void present in the connection portions 21052 and a foreign substance.

As with Embodiment B6, the workpiece inspection device 2901 in the present embodiment is provided with the inspection chamber 22, an inspection unit 2903, and the gas leak suppression structure 2604. The configurations of the inspection chamber 22 and the gas leak suppression structure 2604 are the same as those in Embodiment B6.

However, the bag-like containers 21051 of the above-described workpiece 21050 are accommodated in the workpiece accommodation recesses 2653 of each of the belt-shaped divided bodies 2652A and 2652B constituting the gas leak suppression structure 2604 in the present embodiment. That is, the bag-shaped containers 21051 are accommodated in spaces formed by the workpiece accommodation recesses 2653 of the two belt-shaped divided bodies 2652A and 2652B. Meanwhile, each connection portion 21052 of the workpiece 21050 is disposed on a region on outer surfaces of the belt-shaped divided bodies 2652A and 2652B that is positioned between the workpiece accommodation recesses 2653 adjacent to each other in a longitudinal direction of the belt-shaped divided bodies 2652A and 2652B. That is, the connection portions 21052 are accommodated in spaces between the outer surfaces of the two belt-shaped divided bodies 2652A and 2652B. Therefore, in the present embodiment, the accommodation space 2651 of the airtight accommodation portion 2650 is the entire space between the two belt-shaped divided bodies 2652A and 2652B, the workpiece 21050 being interposed between the belt-shaped divided bodies 2652A and 2652B. The accommodation space 2651 accommodates the workpiece 21050.

The inspection unit 2903 in the present embodiment is provided with an ultrasonic oscillation unit 2931 and an ultrasonic reception unit 2932 having the same functions as those in Embodiment B8.

In the present embodiment, the ultrasonic oscillation unit 2931 is formed over the entire outer surface of one belt-shaped divided body 2652A. The ultrasonic oscillation unit 2931 is a phased array in which a large number of ultrasonic oscillation elements are arranged. Meanwhile, the ultrasonic reception unit 2932 is formed over the entire outer surface of the other belt-shaped divided body 2652B. The ultrasonic reception unit 2932 is a phased array in which a large number of ultrasonic reception elements are arranged.

In the case of the inspection unit 2903 in the present embodiment, in a state where the two belt-shaped divided bodies 2652A and 2652B are separated from each other in the inspection chamber 22, the ultrasonic oscillation unit 2931 irradiates the workpiece 21050 with the ultrasonic wave 2US and the ultrasonic reception unit 2932 measures the ultrasonic wave 2US transmitted through the workpiece 21050.

In the drawing, each of the connection portions 21052 of the workpiece 21050 is irradiated with the ultrasonic wave 2US such that the inside of each connection portion 21052 is inspected for a defect. However, the invention is not limited to such a case. For example, the bag-shaped containers 21051 of the workpiece 21050 may be irradiated with the ultrasonic wave 2US such that the inside of each bag-shaped container 21051 is inspected for a defect (for example, air bubbles in contents). Further, the ultrasonic oscillation unit may also serve as the ultrasonic reception unit such that the ultrasonic wave 2US reflected by the workpiece 21050 is measured by the ultrasonic oscillation unit.

The workpiece inspection device 2901 in the present embodiment may be provided with, for example, the same workpiece transportation mechanism 25 as that in Embodiment B6. However, the workpiece 21050 in the present embodiment is configured by connecting the plurality of bag-shaped containers 21051 by means of the connection portions 21052. Therefore, it is possible for the two belt-shaped divided bodies 2652A and 2652B to transport the workpiece 21050 outside the inspection chamber 22 and inside the inspection chamber 22 only by moving with the bag-shaped containers 21051 or the connection portions 21052 of the workpiece 21050 interposed therebetween at the entrances 210 of the inspection chamber 22. That is, the workpiece inspection device 2901 in the present embodiment may not be provided with, for example, the same workpiece transportation mechanism 25 as that in Embodiment B6.

According to the workpiece inspection device 2901 in the present embodiment, the same effects as those of Embodiments B6 and B8 can be obtained.

As described above, the embodiments of the present invention have been described in detail. However, the present invention is not limited to the above embodiments, and various changes can be made without departing from the spirit of the present invention.

What is claimed is:

1. A workpiece inspection device comprising:
an inspection chamber that is filled with an inspection gas different from atmospheric air and accommodates a workpiece;
an inspection unit that inspects the workpiece accommodated in the inspection chamber; and
a gas leak suppression structure that suppresses a leak of the inspection gas in the inspection chamber that occurs when the workpiece is inserted into and removed from the inspection chamber.

2. The workpiece inspection device according to claim 1,
wherein the inspection chamber includes an entrance for insertion and removal of the workpiece.

3. The workpiece inspection device according to claim 2,
wherein the gas leak suppression structure is provided with
an airtight accommodation portion that includes an accommodation space, in which the workpiece is accommodated airtightly with respect to an outside, and passes through the entrance while closing the entrance, and
wherein the airtight accommodation portion is provided with a plurality of divided bodies that form different regions of an inner surface of the accommodation space respectively and are configured to move with respect to each other.

4. The workpiece inspection device according to claim 3,
wherein the plurality of divided bodies include
a first divided body that rotates around an axis orthogonal to a direction which the entrance faces, and
a plurality of second divided bodies that are arranged in a circumferential direction of the first divided body, and
wherein each of the plurality of second divided bodies is connected to an outer circumference of the first divided body, is configured to move with respect to the first divided body, and forms the accommodation space together with the first divided body.

5. The workpiece inspection device according to claim 3,
wherein the entrance includes two entrances,
wherein the plurality of divided bodies include a plurality of belt-shaped divided bodies each of which passes through the two entrances and has a belt-shape, and
wherein the plurality of belt-shaped divided bodies are brought close to each other at the two entrances such that the workpiece is accommodated in the accommodation space and are separated from each other inside the inspection chamber such that the workpiece is free from the belt-shaped divided bodies.

6. The workpiece inspection device according to claim 2,
wherein the gas leak suppression structure is provided with
an accommodation portion that is disposed in the inspection chamber and includes an accommodation space in which the workpiece is accommodated through the entrance, and
a lid portion that opens and closes the entrance from an outside of the inspection chamber,
wherein the accommodation portion is provided with a plurality of divided bodies that form different regions of an inner surface of the accommodation space respectively and are configured to move with respect to each other,
wherein the plurality of divided bodies form the accommodation space in a state of being combined with each other, and
wherein the plurality of divided bodies make the accommodation space airtight with respect to the inspection chamber in a state where the accommodation space is formed.

7. The workpiece inspection device according to claim 2,
wherein the gas leak suppression structure is provided with
a preparation chamber that is provided to be connected to the entrance and includes an opening that leads to an outside,
a first door that is configured to open and close the entrance, and
a second door that is configured to open and close the opening.

8. The workpiece inspection device according to claim 7,
wherein the entrance includes a plurality of entrances, and
wherein the preparation chamber is provided to be connected to each of the plurality of entrances.

9. The workpiece inspection device according to claim 2,
wherein the gas leak suppression structure is provided with a door that is configured to open and close the entrance, and
wherein a shape and a size of the entrance change in accordance with a shape and a size of the workpiece entering or exiting the inspection chamber in response to an operation of the door.

10. The workpiece inspection device according to claim 9,
wherein the door is provided with two sliding doors.

11. The workpiece inspection device according to claim 10,
wherein the two sliding doors include a first sliding door that includes a first portion and a second sliding door that includes a second portion facing the first portion, and
wherein the door is provided with
a first roller portion that has a columnar shape extending in a direction along an axis, is provided at the first portion, and rotates around the axis, and
a second roller portion that has a columnar shape extending in a direction along an axis, is provided at the second portion, and rotates around the axis.

12. The workpiece inspection device according to claim 2,
wherein the gas leak suppression structure is provided with
a sealing portion that is provided at an edge of the entrance and fills a gap between the entrance and the workpiece when the workpiece passes through the entrance.

13. The workpiece inspection device according to claim 1,
wherein the inspection unit is provided with a gas sensor that detects the inspection gas leaking into the workpiece from the inspection chamber.

14. The workpiece inspection device according to claim 1,
wherein the inspection unit is provided with an ultrasonic oscillation unit that irradiates the workpiece disposed in the inspection chamber with an ultrasonic wave and an ultrasonic reception unit that measures the ultrasonic wave reflected by or transmitted through the workpiece disposed in the inspection chamber.

15. A gas leak detection device comprising:
a chamber that accommodates a detection target object and in which a gas is introduced into a space between the detection target object and the chamber; and
a gas sensor device that is disposed inside the detection target object and detects the gas.

16. The gas leak detection device according to claim 15, further comprising:
a lid member that closes an opening of the detection target object,
wherein the gas sensor device is attached to the lid member.

17. The gas leak detection device according to claim 15,
wherein the gas sensor device moves inside the detection target object.

18. The gas leak detection device according to claim 15,
wherein the gas sensor devices include a plurality of gas sensor devices disposed inside the detection target object.

19. The gas leak detection device according to claim 18, further comprising:
a gas sensor device support that supports the plurality of gas sensor devices.

20. The gas leak detection device according to claim 19,
wherein the gas sensor device support is introduced into the detection target object in a folded state and is unfolded inside the detection target object.

21. The gas leak detection device according to claim 15, further comprising:
a circulation unit that circulates a gas in a space inside the detection target object.

22. The gas leak detection device according to claim 15,
wherein the chamber is deformable.

23. The gas leak detection device according to claim 15,
wherein the chamber is provided with an intake port through which the gas is introduced and an exhaust port through which the gas is discharged.

24. The gas leak detection device according to claim 15,
wherein the gas sensor device includes a gas sensor device for high-concentration detection and a gas sensor device for low-concentration detection, and
wherein the gas sensor device for low-concentration detection is configured to perform gas outflow inspection on the detection target object from which no gas outflow has been detected by the gas sensor device for high-concentration detection.

25. The gas leak detection device according to claim 24, further comprising:
a drive unit that drives at least one of the gas sensor device for high-concentration detection and the gas sensor device for low-concentration detection.

26. A leak inspection method of inspecting a gas leak detection device including: a chamber that accommodates a detection target object and in which a gas is introduced into a space between the detection target object and the chamber; and a gas sensor device that is disposed inside the detection target object and detects the gas, by using a workpiece inspection device including: an inspection chamber that is filled with an inspection gas different from atmospheric air and accommodates a workpiece; an inspection unit that inspects the workpiece accommodated in the inspection chamber; and a gas leak suppression structure that suppresses a leak of the inspection gas in the inspection chamber that occurs when the workpiece is inserted into and removed from the inspection chamber, the leak inspection method comprising:
disposing the gas leak detection device in the inspection chamber; and
inspecting the gas leak detection device disposed in the inspection chamber by using the inspection unit.
